(19) United States
(12) Patent Application Publication
(10) Pub. No.: US 2026/0264412 A1
(43) Pub. Date: Sep. 10, 2026

(54) MEDIUM PROCESSING APPARATUS, IMAGE FORMING APPARATUS, AND IMAGE FORMING SYSTEM

(71) Applicants: Tsubasa HASHIMOTO, Aichi (JP); Keisuke SUGIYAMA, Kanagawa (JP); Kei SASAKI, Miyagi (JP)

(72) Inventors: Tsubasa HASHIMOTO, Aichi (JP); Keisuke SUGIYAMA, Kanagawa (JP); Kei SASAKI, Miyagi (JP)

(73) Assignee: ETRIA CO., LTD., Yokohama-shi (JP)

(21) Appl. No.: 19/551,057

(22) Filed: Feb. 26, 2026

(30) Foreign Application Priority Data
Mar. 6, 2025 (JP) 2025-035760
Nov. 6, 2025 (JP) 2025-187776

(51) Int. Cl. B41J 2/175; G03G 15/10

(52) U.S. Cl. CPC B41J 2/17566; B41J 2/17596; G03G 15/10; B41J 2002/17579

(57) ABSTRACT

A medium processing apparatus includes a liquid applier, a medium processing device, a liquid storage, a liquid detector, and circuitry. The liquid applier applies liquid to a medium. The medium processing device processes a media bundle. The liquid storage stores the liquid to be supplied to the liquid applier. The liquid detector includes a pair of electrodes to detect the liquid in the liquid storage. The circuitry is to repeat application and non-application of a direct current voltage alternately at a regular interval to perform an intermittent application, to detect the liquid in the liquid storage. The circuitry is further to perform the application and the non-application of the direct current voltage for first and second periods in the intermittent application, and control a ratio of the first period to a sum of the first and second periods to be equal to or less than a given ratio.

### CROSS-REFERENCE TO RELATED APPLICATIONS

This patent application is based on and claims priority pursuant to 35 U.S.C. § 119(a) to Japanese Patent Application Nos. 2025-035760, filed on Mar. 6, 2025, and 2025-187776, filed on Nov. 6, 2025, in the Japan Patent Office, the entire disclosure of each of which is hereby incorporated by reference herein.

### BACKGROUND

### Technical Field

Embodiments of the present disclosure relate to a medium processing apparatus, an image forming apparatus, and an image forming system.

### Related Art

Various types of medium processing apparatuses are known that enhance the quality of processing by applying liquid on a sheet medium, and various types of image forming systems are known that include the medium processing apparatus described above and an image forming apparatus to be compatible with each other.

A medium processing apparatus in the art that performs processing using liquid discloses a configuration with a liquid level detector with multiple electrode pins that detects a remaining liquid amount of a liquid storage (main tank) to supply liquid by a user. The liquid level detector detects conduction (by liquid) between the electrode pins, and determines whether the liquid storage stores any liquid based on the detection voltage.

Since the medium processing apparatus has the configuration to apply direct current to the liquid level detector using the electrode pins, the circuit configuration becomes complicated, and such a medium processing apparatus has an issue in reducing the size of the substrate and reducing the cost. When a direct current voltage is applied, scale adheres to the electrode pins due to the influence of ionization of the electrolyte in the liquid caused by long-duration energization, and the voltage fluctuates (rises). Due to this voltage fluctuation, the detection voltage detected by the liquid level detector exceeds the threshold voltage that the detection voltage detected by the liquid level detector determines whether there is any liquid. Due to this action, the liquid level detector performs false-detection on the remaining amount of liquid in the liquid storage.

### SUMMARY

Embodiments of the present disclosure described herein provide a novel medium processing apparatus including a liquid applier, a medium processing device, a liquid storage, a liquid detector, and circuitry. The liquid applier applies liquid to a medium. The medium processing device processes a media bundle including the medium on which the liquid is applied by the liquid applier. The liquid storage stores the liquid to be supplied to the liquid applier. The liquid detector includes a pair of electrodes to detect the liquid in the liquid storage. The circuitry is to control the medium processing apparatus to process the media bundle, repeat application and non-application of a direct current voltage to the pair of electrodes of the liquid detector alternately at a regular interval to perform an intermittent application, to detect the liquid in the liquid storage by the liquid detector. The circuitry is further to perform the application of the direct current voltage to the liquid detector for a first period in the intermittent application, perform the non-application of the direct current voltage to the liquid detector for a second period in the intermittent application, and control a ratio of the first period to a sum of the first period and the second period to be equal to or less than a given ratio.

Further, embodiments of the present disclosure described herein provide an image forming apparatus including an image forming device to form an image on a medium, and the above-described medium processing apparatus to process the media bundle including the medium on which the image is formed by the image forming apparatus.

Further, embodiments of the present disclosure described herein provide an image forming system including an image forming apparatus to form an image on a medium, and the above-described medium processing apparatus to process the media bundle including the medium on which the image is formed by the image forming apparatus.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an overall configuration of an image forming system according to an embodiment of the present disclosure;

FIG. 2 is a diagram illustrating an internal configuration of a post-processing apparatus the present disclosure;

FIG. 3 is a schematic view of an edge binder viewed from an upstream side in a conveyance direction;

FIG. 4 is a schematic view of an edge binder viewed from the side on which a liquid applier is located in a main scanning direction;

FIGS. 5A and 5B are schematic diagrams each illustrating a configuration of a crimper of the edge binder of FIG. 3;

FIG. 6 is a diagram illustrating an edge binder according to a modification;

FIGS. 7A, 7B, and 7C are diagrams each illustrating a liquid application crimper of the edge binder of FIG. 6;

FIGS. 8A, 8B, and 8C are diagrams each illustrating a liquid applying operation and a crimp binding operation performed by the liquid application crimper of FIGS. 7A, 7B, and 7C;

FIG. 9 is a schematic view of a staple binder viewed from an upstream side in a conveyance direction;

FIG. 10 is a schematic view of a staple binder according to a modification, viewed from an upstream side in a conveyance direction;

FIGS. 11A and 11B are diagrams illustrating a location and configuration of a second liquid storage tank in a post-processing apparatus;

FIG. 12 including parts (A), (B) and (C) is a diagram illustrating a configuration of attachment and detachment of a second liquid storage tank in a post-processing apparatus;

FIG. 13 is a block diagram illustrating a hardware configuration of control blocks that control the post-processing apparatus according to the present disclosure;

FIG. 14 is a flowchart of a sheet binding operation performed by an edge binder;

FIGS. 15A, 15B, 15C and 15D are diagrams illustrating positions of a liquid applier and a crimper during a single stapling by an edge binder;

FIGS. 16A, 16B, 16C, 16D, 16E, 16F, 16G and 16H are diagrams illustrating a liquid applier and a crimper during a dual stapling binding by an edge binder;

FIG. 17 is a diagram illustrating a relation of a liquid applier of an edge binder and a second liquid storage;

FIGS. 18A, 18B and 18C are diagrams illustrating a change in the amount of liquid in a first liquid storage tank in a dry state of a liquid supply member of the liquid applier of FIG. 17;

FIG. 19 is a flowchart of control flow of a liquid supplying operation of a liquid applier;

FIG. 20 is a diagram illustrating liquid leakage that might occur in a first liquid storage tank of a liquid applier;

FIG. 21 is a graph of a relation of the output values of a first liquid level sensor and a second liquid level sensor and a liquid detection threshold value in a time series manner;

FIGS. 22A and 22B are diagrams illustrating a relation of an edge binder and a main tank;

FIGS. 23A and 23B are diagrams illustrating an example of an inconvenience of a sensor that detects a liquid level in a liquid storage tank by applying a direct current voltage to a pair of electrodes;

FIGS. 24A, 24B and 24C are diagrams illustrating detection of a liquid level in a liquid storage tank when an application voltage is a direct current voltage, according to a first embodiment;

FIG. 25 including parts (A), (B) and (C) is a diagram illustrating an inconvenience of detection of a liquid level in a liquid storage tank when an application voltage is a direct current voltage, according to a first embodiment;

FIG. 26 including parts (A), (B) and (C) is a diagram illustrating an overview of an intermittent application control of an application voltage according to a second embodiment;

FIG. 27 is a flowchart of an intermittent application control executable in a medium processing apparatus, according to a second embodiment;

FIG. 28 is a flowchart of a cover open-close monitoring control process to be referred to in an intermittent application control, according to a second embodiment;

FIG. 29A is a flowchart of a process for determining a duty to be used for an intermittent application control, according to a third embodiment;

FIG. 29B is a diagram illustrating images of the duty corresponding to a first material pattern, a second material pattern, and a third material pattern;

FIG. 30A is a flowchart of a process for determining a duty to be used for an intermittent application control, according to a fourth embodiment;

FIG. 30B is a diagram illustrating images of the duty corresponding to a first liquid property pattern, a second liquid property pattern, and a third liquid property pattern;

FIG. 31A is a flowchart of a process for determining a duty to be used for an intermittent application control, according to a fifth embodiment;

FIG. 31B is a diagram illustrating images of the duty corresponding to a first environmental pattern, a second environmental pattern, and a fifth environmental pattern;

FIG. 32 is a diagram illustrating a limitation of a duty to be used for an intermittent application control, according to a sixth embodiment;

FIG. 33 is a flowchart of another intermittent application control executable in a medium processing apparatus, according to a seventh embodiment;

FIG. 34 is a flowchart of an intermittent application control, according to a seventh embodiment;

FIGS. 35A and 35B are schematic views of a post-processing apparatus including controllers according to a first modification;

FIGS. 36A and 36B are schematic views of a post-processing apparatus including controllers according to a second modification;

FIG. 37 is a diagram illustrating the internal configuration of a post-processing apparatus according to another embodiment of the present disclosure;

FIGS. 38A, 38B and 38C are diagrams each illustrating an internal tray of the post-processing apparatus according to another embodiment of the present disclosure;

FIG. 39 is a schematic view of a downstream side of a crimper of a post-processing apparatus according to another embodiment of the present disclosure;

FIGS. 40A and 40B are diagrams illustrating a liquid applier according to another embodiment of the present disclosure, viewed from the thickness direction of a sheet;

FIGS. 41A, 41B, and 41C are cross-sectional views of a liquid application unit of a liquid applier, taken through XXV-XXV of FIG. 40A;

FIGS. 42A, 42B, and 42C are cross-sectional views of a liquid application unit of a liquid applier, taken through XXVI-XXVI of FIG. 40A;

FIG. 43 is a diagram illustrating a hardware configuration of a control block of the post-processing apparatus according to another embodiment of the present disclosure;

FIG. 44 is a flowchart of post-processing performed by a post-processing apparatus according to another embodiment of the present disclosure; and

FIG. 45 is a diagram illustrating an overall configuration of an image forming system according to a modification.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

It will be understood that if an element or layer is referred to as being “on,” “against,” “connected to” or “coupled to” another element or layer, then it can be directly on, against, connected or coupled to the other element or layer, or intervening elements or layers may be present. In contrast, if an element is referred to as being “directly on,” “directly connected to” or “directly coupled to” another element or layer, then there are no intervening elements or layers present. As used herein, the term “connected/coupled” includes both direct connections and connections in which there are one or more intermediate connecting elements. Like numbers refer to like elements throughout. As used herein, the term “and/or” includes any and all combinations of one or more of the associated listed items.

Spatially relative terms, such as “beneath,” “below,” “lower,” “above,” “upper” and the like may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements describes as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors herein interpreted accordingly.

The terminology used herein is for describing particular embodiments and examples and is not intended to be limiting of exemplary embodiments of this disclosure. As used herein, the singular forms “a,” “an,” and “the” are intended to include the plural forms as well, unless the context clearly indicates otherwise. It will be further understood that the terms “includes” and/or “including,” when used in this specification, specify the presence of stated features, integers, steps, operations, elements, and/or components, but do not preclude the presence or addition of one or more other features, integers, steps, operations, elements, components, and/or groups thereof.

Embodiments of the present disclosure are described below with reference to the drawings. The same reference numerals are given to identical or corresponding constituent elements such as parts and members having the same reference numerals, and redundant descriptions thereof are omitted unless otherwise required.

### Embodiment of Image Forming System 1

A description is given below of an image forming system 1 according to an embodiment of the present disclosure, with reference to the drawings.

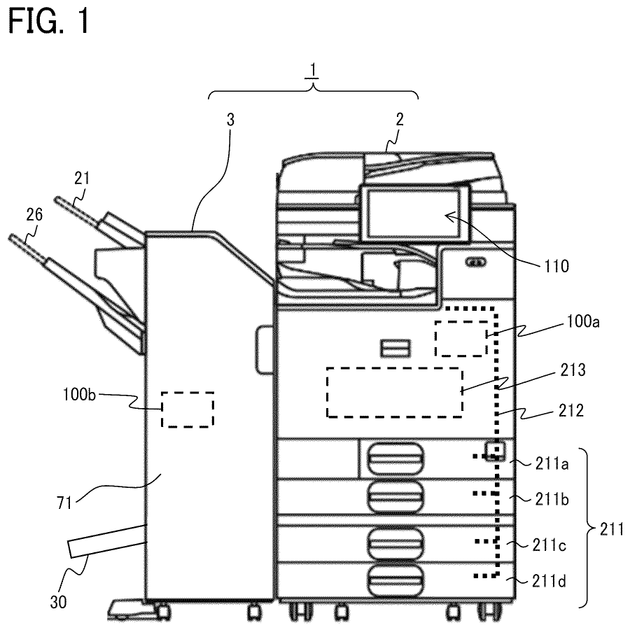

FIG. 1 is a diagram illustrating an overall configuration of the image forming system 1 according to the present disclosure.

The image forming system 1 has a function of forming an image on a sheet as a sheet medium and a function of performing a post-processing operation on the sheet as a process after the image is formed on the sheet. As illustrated in FIG. 1, the image forming system 1 includes an image forming apparatus 2 including the image forming function and a post-processing apparatus 3 serving as a medium processing apparatus including the post-processing function, according to an embodiment of the present disclosure. In the image forming system 1, the image forming apparatus 2 and the post-processing apparatus 3 operate in conjunction with each other.

In the present embodiment, the sheet-shaped medium or sheet-shaped medium to be processed in the image forming system 1 is described on the assumption that the medium is a sheet of “paper.” The object to be processed according to the present embodiment is not limited to a paper. For example, any material or specification may be used as long as an image can be formed on a medium in a known image forming process and the medium is a target object of the image forming process. Examples of the medium include a medium that can be an object of a folding process or a binding process, and the material and specification of the medium are not limited to any particular material and specification.

The image forming apparatus 2 forms an image on a sheet and ejects the sheet having the image to the post-processing apparatus 3. The image forming apparatus 2 includes a sheet tray 211 (e.g., sheet trays 211a, 211b, 211c and 211d) that accommodates sheets, a conveyor 212 that conveys the sheets accommodated in the sheet tray 211, and an image forming device 213 that forms an image on the sheet conveyed by the conveyor 212. The image forming device 213 may be an inkjet system that forms an image using ink or an electrophotographic system that forms an image using toner. The image forming apparatus 2 also includes a controller 100a that controls various operations of the conveyor 212 and the image forming device 213. Since the image forming apparatus 2 has a typical configuration, a detailed description of the configuration is omitted.

Sheets of paper are widely known as an example of sheet-shaped media. In the following description, a sheet-shaped medium as a medium to be processed is referred to as a “sheet P.” Further, in the following description, a media bundle of multiple media is an example of a “sheet bundle Pb.”

A description is given of the post-processing apparatus 3 according to a first embodiment of the present disclosure.

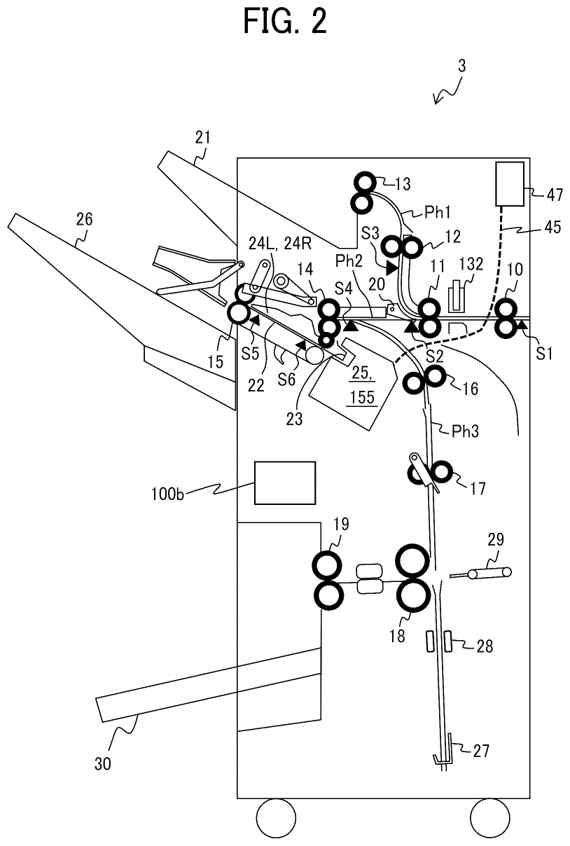

FIG. 2 is a diagram illustrating an internal configuration of the post-processing apparatus 3 according to an embodiment of the present disclosure.

The post-processing apparatus 3 has a function that performs given post-processing on the sheet P on which an image is formed by the image forming apparatus 2. An example of the post-processing according to the present embodiment is a binding process as a “crimp binding” that binds, without staples, multiple sheets P on each of which an image is formed as a bundle of sheets P, which may be referred to as a “sheet bundle Pb”. Another example of the post-processing operation according to the present embodiment is a “stapling operation” to bind, with staples, multiple sheets P on each of which an image is formed as a sheet bundle Pb as a bundle of sheets.

In the present embodiment, a description is given of liquid application in a crimp binding process (operation). However, the liquid application related to a stapling process is similar to the liquid application in the crimp binding process. In the following description, the term “binding process” indicates both the “crimp binding process” and the “stapling process”, and is not limited to a binding method (whether a binding staple is used or a pressing and deforming process is performed).

More specifically, the “crimping process” or “crimp binding process” according to the present embodiment is a process of applying pressure by a crimper 32 as a medium processing device to a binding position corresponding to a part of a sheet bundle Pb to deform the binding position, entangle the fibers of overlapping sheets P with each other, and thus bind the sheets P together. The crimping process partially binds the overlapping portions of the sheets P together to form a sheet bundle Pb. This crimp binding process is referred to as “crimp binding” in the following description.

The binding process (including both the crimp binding and the staple binding) that is executable by the post-processing apparatus 3 includes edge binding and saddle binding. The edge binding is a process to bind an end (including an edge) of the sheet bundle Pb. The saddle binding (center binding) is a process to bind the center of the sheet bundle Pb.

The post-processing apparatus 3 includes conveyance roller pairs 10 to 19 (as conveyors) and a switcher 20. The conveyance roller pairs 10 to 19 convey, inside the post-processing apparatus 3, the sheet P supplied from the image forming apparatus 2. More specifically, the conveyance roller pairs 10, 11, 12 and 13 convey the sheet P along a first conveyance path Ph1. The conveyance roller pairs 14 and 15 convey the sheet P along a second conveyance path Ph2. Further, the conveyance roller pairs 16, 17, 18 and 19 convey the sheet P along a third conveyance path Ph3. A hole punch 132 is disposed between the conveyance roller pair 10 and the conveyance roller pair 11. A hole punch 132 performs punching on a sheet P conveyed by the conveyance roller pair 10 and the conveyance roller pair 11. In addition, the post-processing apparatus 3 includes a controller 100b as a controller or a control unit. The controller 100b controls the operations of, for example, the conveyance roller pairs 10 to 19 and the switcher 20, which are drive members in the post-processing apparatus 3, and acquires detection results from various sensors as detectors or sensors. Details of the controller 100b will be described below.

The first conveyance path Ph1 is a passage extending to a first ejection tray 21 from a sheet supplying port through which the sheet P is supplied from the image forming apparatus 2. The second conveyance path Ph2 is a passage branching from the first conveyance path Ph1 between the conveyance roller pairs 11 and 14 in the conveyance direction of the sheet and extending to a second ejection tray 26 via the internal tray 22. The third conveyance path Ph3 is a passage branching from the first conveyance passage Ph1 between the conveyance roller pairs 11 and 14 in the conveyance direction of the sheet and extending to a third ejection tray 30.

The switcher 20 is disposed at a branching position of the first conveyance path Ph1 and the second conveyance path Ph2. The switcher 20 can be switched between a first position and a second position. The switcher 20 in the first position guides the sheet P to be ejected to the first ejection tray 21 through the first conveyance path Ph1. The switcher 20 in the second position guides the sheet P conveyed through the first conveyance path Ph1 to the second conveyance path Ph2. The conveyance roller pair 14 is rotated in reverse at the timing when the trailing end of the sheet P that has entered the second conveyance path Ph2 passes through the branching position of the second conveyance path Ph2 and the third conveyance path Ph3. Thus, the sheet Pis guided to the third conveyance path Ph3. The post-processing apparatus 3 further includes multiple sensors S1, S2, S3, S4, S5 and S6 that detect the positions of the sheet P in the first conveyance path Ph1, the second conveyance path Ph2, and the third conveyance path Ph3. Each of the multiple sensors S1, S2, S3, S4, S5 and S6 is indicated by a black triangle in FIG. 2.

The post-processing apparatus 3 includes a first ejection tray 21. The sheet P that is output through the first conveyance path Ph1 is placed on the first ejection tray 21. Among the sheet P supplied from the image forming apparatus 2, the sheet P on which the binding process is not performed is ejected to the first ejection tray 21.

The post-processing apparatus 3 further includes the internal tray 22 serving as a sheet stacker on which the sheet P or the sheet bundle Pb are stacked, an edge-binding end fence 23, side fences 24L and 24R, an edge binder 25, a staple binder 155, and a second ejection tray 26. The internal tray 22, the edge-binding end fence 23, the side fences 24L and 24R, the edge binder 25, and the staple binder 155 perform the edge binding on the sheet bundle Pb including the multiple sheets P conveyed from the second conveyance path Ph2 to the internal tray 22. Among the sheets P supplied from the image forming apparatus 2, the sheet bundle Pb subjected to the edge binding is ejected to the second ejection tray 26.

The “edge binding process” here means a binding process performed by the edge binder 25 and the staple binder 155. Specifically, the “edge binding process” includes, but not limited to, a “parallel binding process” that binds the sheet bundle Pb along one side of the sheet bundle Pb parallel to the main scanning direction, an “oblique binding process” that binds a corner of the sheet bundle Pb, and a “vertical binding process” that binds the sheet bundle Pb along one side of the sheet bundle Pb parallel to the conveyance direction.

In the following description, a direction in which the sheet Pis conveyed from the conveyance roller pair 15 toward the edge-binding end fence 23 is defined as a “conveyance direction” of the sheet. In other words, the “conveyance direction” in the present specification corresponds to a direction in which the sheet P output from the image forming apparatus 2 is moved toward the second ejection tray 26 by, for example, the conveyance roller pair 10 and is then changed by the conveyance roller pair 15 to move toward the edge-binding end fence 23 as a direction different from the direction toward the second ejection tray 26. A direction that is orthogonal to the conveyance direction and a thickness direction of the sheet P, in other words, the width direction of the sheet P is defined as a “main scanning direction.”

The multiple sheets P that are sequentially conveyed through the second conveyance path Ph2 are temporarily placed on the internal tray 22 as a sheet stacker. The edge-binding end fence 23 aligns the position, in the conveyance direction, of the sheet P or the sheet bundle Pb placed on the internal tray 22. The side fences 24L and 24R align the position, in the main scanning direction, of the sheet P or the sheet bundle Pb placed on the internal tray 22. The edge binder 25 and the staple binder 155 perform edge binding on the sheet bundle Pb aligned by the edge-binding end fence 23 and the side fences 24L and 24R. The conveyance roller pair 15 ejects the sheet bundle Pb subjected to the edge binding to the second ejection tray 26.

The post-processing apparatus 3 further includes a saddle-binding end fence 27, a saddle binder 28, a sheet folding blade 29, and the third ejection tray 30. The saddle-binding end fence 27, the saddle binder 28, and the sheet folding blade 29 perform the saddle binding on the sheet bundle Pb of the sheets P that are conveyed through the third conveyance path Ph3. Among the sheets P supplied from the image forming apparatus 2, the sheet bundle Pb subjected to the saddle binding is ejected to the third ejection tray 30.

The saddle-binding end fence 27 aligns the positions of the sheets P that are sequentially conveyed through the third conveyance path Ph3, in a direction in which the sheets P are conveyed. The saddle-binding end fence 27 is movable in a direction in which the sheet P is conveyed toward the saddle-binding end fence 27 and in a direction (vertical direction in FIG. 2) opposite thereto so as to locate the center of the sheet bundle Pb at a binding position where the saddle binder 28 faces the center of the sheet bundle Pb and a folding position where the sheet folding blade 29 faces the center of the sheet bundle Pb. The saddle binder 28 binds the center of the sheet bundle Pb aligned by the saddle-binding end fence 27 at the binding position. The sheet folding blade 29 folds, in half, the sheet bundle Pb placed on the saddle-binding end fence 27 at the folding position and causes the conveyance roller pair 18 to nip the sheet bundle Pb. The conveyance roller pair 18 and the conveyance roller pair 19 eject the sheet bundle Pb subjected to the saddle binding to the third ejection tray 30.

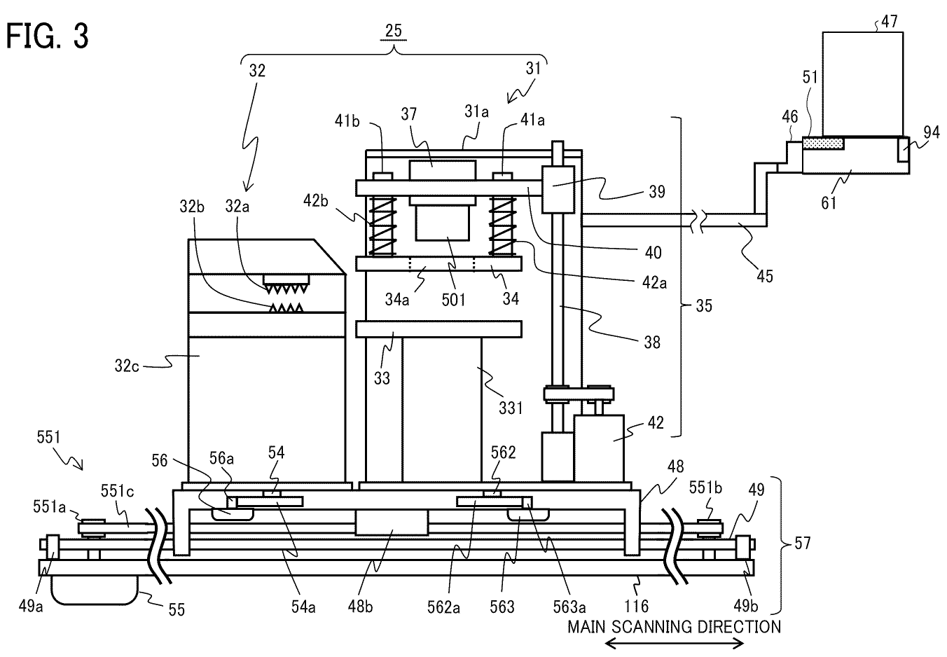

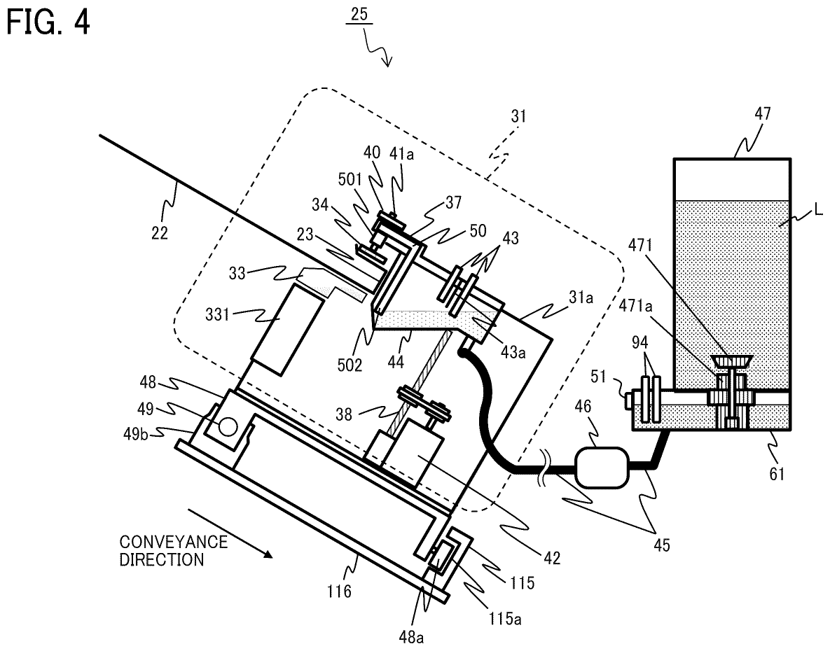

In addition, as illustrated in FIGS. 3 and 4, the post-processing apparatus 3 includes a liquid application member 501 (a part of the liquid applier), a liquid supply member 50 (a part of the liquid supplier), and a first liquid storage tank 44 as a first liquid storage in the edge binder 25. The post-processing apparatus 3 includes a liquid conveyance path 45, a liquid supply pump 46 as a liquid conveyor, a second liquid storage tank 47 as a part of a second liquid storage, and a second liquid storage tank 47 and a second liquid storage tank fixer 61, as a configuration for replenishing the first liquid storage tank 44 with the liquid L. The liquid L that is stored in the second liquid storage tank 47 is supplied to the first liquid storage tank 44 through the second liquid storage tank fixer 61, the liquid supply pump 46, and the liquid conveyance path 45.

### Configuration of Edge Binder 25

FIG. 3 is a schematic view of the edge binder 25 that performs a liquid application process and a crimp binding process, viewed from an upstream side in a conveyance direction of FIG. 2.

FIG. 4 is a schematic view of the edge binder 25, viewed from the side of a liquid applier 31 in the main scanning direction.

As illustrated in FIG. 3, the edge binder 25 includes a liquid applier 31 that applies the liquid L to the sheet P or the sheet bundle Pb, and a crimper 32 that performs a crimp binding on the sheet bundle Pb. The liquid applier 31 and the crimper 32 are disposed downstream from the internal tray 22 in the conveyance direction and adjacent to each other in the main scanning direction.

### Configuration of Liquid Applier 31

As illustrated in FIG. 4, the liquid applier 31 applies the liquid L (referred to a “liquid L in the first liquid storage tank 44” below) stored in the first liquid storage tank 44 to the sheet P or the sheet bundle Pb stacked on the internal tray 22. In the following description, the operation that the liquid applier 31 applies the liquid L to a sheet P or a sheet bundle Pb and the operation of the liquid applier 31 when applying liquid are referred to as “liquid application.” The liquid application operation of the liquid applier 31 accompanied by the control process is referred to as a “liquid application process”.

More specifically, the liquid L that is stored in the first liquid storage tank 44 as liquid for the “liquid application” includes, as a main component, the liquid state of a compound of hydrogen and oxygen compound represented by the chemical formula H2O. The liquid hydrogen-oxygen compound is at any temperature. For example, the liquid hydrogen-oxygen compound may be so-called warm water or hot water. The liquid hydrogen-oxygen compound is not limited to pure water. The liquid hydrogen-oxygen compound may be purified water or may contain ionized salts. The metal ion content ranges from so-called soft water to ultrahard water. In other words, the liquid hydrogen-oxygen compound is at any hardness.

The liquid L that is stored in the first liquid storage tank 44 may include an additive in addition to the main component. The liquid L that is stored in the first liquid storage tank 44 may include residual chlorine used as tap water. Preferably, for example, the liquid that is stored in the first liquid storage tank 44 may include, as an additive, a colorant, a penetrant, a pH adjuster, a preservative such as phenoxyethanol, a drying inhibitor such as glycerin, or a combination thereof. Furthermore, because water is used as a component of ink used for inkjet printers or ink used for water-based pens, such water or ink may be used for the “liquid application”.

The water is not limited to the specific examples described above. The water may be water in a broad sense such as hypochlorous acid water or an ethanol aqueous solution diluted for disinfection. However, tap water may be used simply to enhance the binding strength after the binding process because tap water is easy to obtain and store. A liquid including water as a main component as exemplified above enhances the binding strength of the sheet bundle Pb, in comparison with a liquid of which the main component is not water (liquid).

As illustrated in FIGS. 3 and 4, the liquid applier 31 can be moved in the main scanning direction together with the crimper 32 by the driving force transmitted from the edge binder movement motor 55. The liquid applier 31 includes a lower pressure plate 33 as a sheet stacking table of the sheet P or the sheet bundle Pb, an upper pressure plate 34, and a liquid applier movement assembly 35. The components of the liquid applier 31, which are the lower pressure plate 33, the upper pressure plate 34, the liquid applier movement assembly 35, and a liquid applier movement motor 42, are held by at least one of a liquid application frame 31a and a base 48.

A liquid applier rotation shaft 562 provided with a drive transmission gear 562a is fixed to a bottom face of the liquid application frame 31a that holds the components of the liquid applier 31. The liquid applier rotation shaft 562 and the drive transmission gear 562a are rotatably held by the base 48 on which the liquid application frame 31a is disposed, so as to be rotatable in the forward and reverse directions. The drive transmission gear 562a meshes with an output gear 563a of the liquid applier pivot motor 563. The liquid applier 31 can be rotated in the forward and reverse directions about the liquid applier rotation shaft 562 on the base 48 by a driving force transmitted from the liquid applier pivot motor 563 to the liquid applier rotation shaft 562 via the output gear 563a and the drive transmission gear 562a.

The lower pressure plate 33 and the upper pressure plate 34 are disposed downstream from the internal tray 22 in the conveyance direction. The sheets P or the sheet bundle Pb that is placed on the internal tray 22 is also placed on the lower pressure plate 33. The lower pressure plate 33 is disposed on a lower pressure plate holder 331. The upper pressure plate 34 is movable in the thickness direction of the sheet P or the sheet bundle Pb at a position where the upper pressure plate 34 faces the sheet P or the sheet bundle Pb placed on the internal tray 22. In other words, the lower pressure plate 33 and the upper pressure plate 34 are disposed to face each other in the thickness direction of the sheet P or the sheet bundle Pb with the sheet P or the sheet bundle Pb placed on the internal tray 22 and interposed between the lower pressure plate 33 and the upper pressure plate 34. In the following description, the thickness direction of the sheet P or the sheet bundle Pb may be referred to simply as “thickness direction.”

Further, the upper pressure plate 34 has a through hole 34a penetrating in the thickness direction. Further, the through hole 34a is formed at the position facing the liquid application member 501 as a part of the liquid applier that is held via the holder 37 that is attached to a base plate 40. The liquid application member 501 is attached to one end portion of a liquid supply member 50 as a liquid absorber as described below. Then, the liquid application member 501 applies liquid to the sheet P or the sheet bundle Pb to contact the sheet P or the sheet bundle Pb via the through holes 34a. The liquid application member 501 is at one end portion of the liquid supply member 50 as a liquid absorber. The liquid supply member 50 will be described later in detail.

The liquid applier movement assembly 35 moves the upper pressure plate 34, the base plate 40, the holder 37, the liquid application member 501, the liquid supply member 50, and the first liquid storage tank 44 in the thickness direction of the sheet P or the sheet bundle Pb. The liquid applier movement assembly 35 according to the embodiment moves the upper pressure plate 34, the base plate 40, the holder 37, the liquid application member 501, the liquid supply member 50, and the first liquid storage tank 44 together by the single liquid applier movement motor 42. The liquid applier movement assembly 35 includes, for example, the liquid applier movement motor 42, a trapezoidal screw 38, a nut 39, the base plate 40, columns 41a and 41b, and coil springs 42a and 42b.

The liquid applier movement motor 42 generates a driving force to move the upper pressure plate 34, the base plate 40, the holder 37, the liquid application member 501, the liquid supply member 50, and the first liquid storage tank 44. The trapezoidal screw 38 extends in the thickness direction of the sheet P or the sheet bundle Pb and is provided with the liquid application frame 31a such that the trapezoidal screw 38 is rotatable in the forward and reverse directions. The trapezoidal screw 38 is coupled to an output shaft of the liquid applier movement motor 42 via, for example, a pulley and a belt. The nut 39 is screwed to the trapezoidal screw 38. The trapezoidal screw 38 is rotated in the forward and reverse directions by the driving force transmitted from the liquid applier movement motor 42. The rotation of the trapezoidal screw 38 causes the nut 39 to reciprocate on the trapezoidal screw 38.

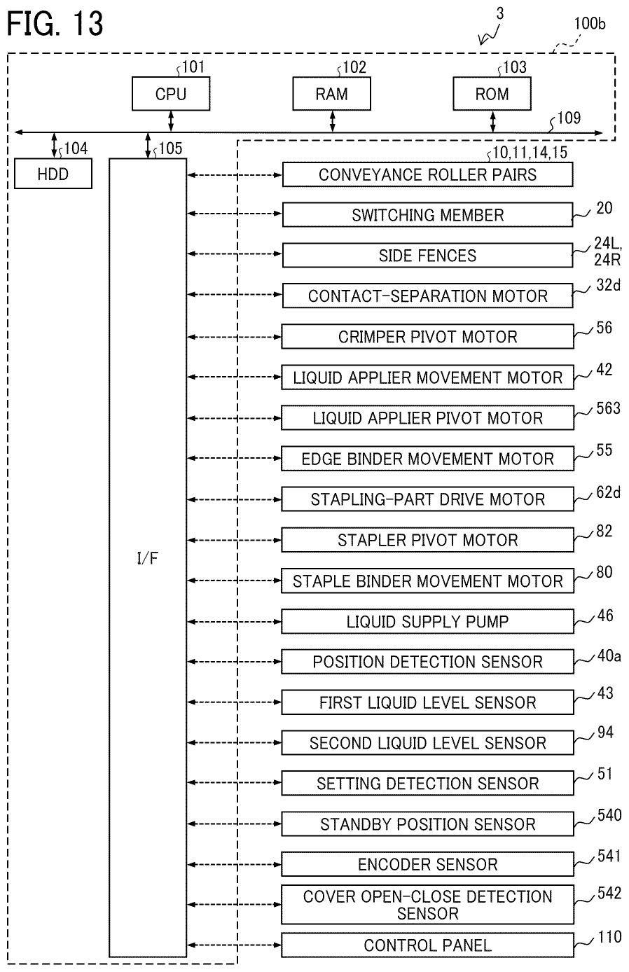

The base plate 40 is positioned apart from the upper pressure plate 34. The base plate 40 holds the liquid application member 501 with the tip portion of the liquid application member 501 protruding from the base plate 40 toward the upper pressure plate 34. The base plate 40 is coupled to the trapezoidal screw 38 via the nut 39 such that base plate 40 can reciprocate along the trapezoidal screw 38 as the trapezoidal screw 38 rotates in the forward and reverse directions. The position of the base plate 40 in the thickness direction of the sheet P or the sheet bundle Pb is detected by a movement sensor 40a (see FIG. 13).

The columns 41a and 41b project from the base plate 40 toward the upper pressure plate 34 around the tip portion of the liquid application member 501. The columns 41a and 41b can relatively move with respect to the base plate 40 in the thickness direction. The columns 41a and 41b hold the upper pressure plate 34 with the respective ends closer to the lower pressure plate 33 than the other ends of the columns 41a and 41b. The other ends of the columns 41a and 41b opposite the ends closer to the lower pressure plate 33 are provided with stoppers that prevent the columns 41a and 41b from being removed from the base plate 40.

The coil springs 42a and 42b are fitted around the columns 41a and 41b, respectively, between the base plate 40 and the upper pressure plate 34. The coil springs 42a and 42b bias the upper pressure plate 34 and the columns 41a and 41b toward the lower pressure plate 33 with respect to the base plate 40.

The liquid applier 31 applies liquid to the sheet P or the sheet bundle Pb placed on the internal tray 22. Specifically, the liquid applier 31 brings the liquid application member 501 into contact with the sheet P or the sheet bundle Pb to perform liquid application on at least one sheet P of the sheet bundle Pb.

The liquid applier 31 includes a first liquid level sensor 43 as a first liquid detector, the first liquid storage tank 44, the liquid application member 501, the liquid supply member 50, and the holder 37. The first liquid storage tank 44 stores the liquid L for performing liquid application on the sheet P or the sheet bundle Pb. The liquid level (stored liquid amount) of the liquid L stored in the first liquid storage tank 44 is detected by the first liquid level sensor 43. The first liquid storage tank 44 is coupled to the base plate 40 via the holder 37.

The liquid application member 501 applies the liquid L in the first liquid storage tank 44 to the sheet P or the sheet bundle Pb. The liquid application member 501, the liquid supply member 50 (an example of a liquid absorber) disposed in close contact with the liquid application member 501 and the first liquid storage tank 44 are held by the holder 37. The holder 37 is held by the base plate 40. The liquid supply member 50 has a first end in close contact with the liquid application member 501 and a second end immersed in the liquid L stored in the first liquid storage tank 44. In other words, the second end of the liquid supply member 50 corresponds to a liquid immersion portion 502 that draws up the liquid L and supplies the liquid L to the liquid application member 501.

Each of the liquid application member 501 and the liquid supply member 50 is made of a material (e.g., sponge or fiber) having a high liquid absorption rate, such as an elastic resin formed of open cells. However, at least one of the liquid application member 501 or the liquid supply member 50 is not limited to a particular kind as long as the at least one of the liquid application member 501 or the liquid supply member 50 is made of a material having a property of absorbing and holding the liquid L and has a property of being crushable in accordance with a pressing force applied when the at least one of the liquid application member 501 or the liquid supply member 50 is in contact with the sheet P or the sheet bundle Pb. In other words, at least one of the liquid application member 501 and the liquid supply member 50 may be made of any material as long as the material can absorb or draw up liquid L by capillary action.

Accordingly, when the liquid immersion portion 502 of the liquid supply member 50 is immersed in the liquid L stored in the first liquid storage tank 44, the liquid supply member 50 draws up the liquid L by capillary phenomenon. In other words, the liquid L in the first liquid storage tank 44 is drawn up from the liquid immersion portion 502 of the liquid supply member 50, and the drawn liquid L is supplied to the liquid application member 501 that is coupled to the tip portion via the liquid supply member 50. Then, the liquid L stored in the first liquid storage tank 44 is drawn up to the liquid application member 501 in close contact with one end portion of the liquid supply member 50, and thus the level of the liquid L in the first liquid storage tank 44 is lowered. Then, when the first liquid level sensor 43 detects the lowering of the level of the liquid L in the first liquid storage tank 44, the supply of the liquid L by the liquid supply pump 46 from the second liquid storage tank 47 to the first liquid storage tank 44 starts. In the following description, the operation of supplying the liquid L by the liquid supply pump 46 from the second liquid storage tank 47 to the first liquid storage tank 44 is referred to as a “liquid supplying operation.”

Although the case where the liquid supply member 50 and the liquid application member 501 are separate bodies has been described above, the liquid supply member 50 and the liquid application member 501 may be integrally formed of a material having the same properties (e.g., a material having a high liquid absorption rate). In other words, the liquid application member 501 may be part of the liquid supply member 50. In such a case, the liquid L can be supplied from the liquid supply member 50 to the liquid application member 501 more smoothly by the capillary phenomenon and a reduction in cost can be achieved.

At this time, the liquid application member 501 draws up the liquid L in the first liquid storage tank 44. Accordingly, the amount (level) of the liquid L in the first liquid storage tank 44 temporarily decreases to a level below the reference liquid level described below. In response to this decrease of liquid in the first liquid storage tank 44, the liquid supplying operation for feeding the liquid L is performed from the second liquid storage tank 47 to the first liquid storage tank 44. The “reference liquid level” is a level of liquid where the liquid L in the first liquid storage tank 44 is sufficiently penetrated to the liquid supply member 50 and the liquid application member 501. In other words, the “reference liquid level” is a level of liquid that indicates the liquid amount stored in the first liquid storage tank 44 for applying the appropriate amount of the liquid L to the sheet P or the sheet bundle Pb by the liquid supply member 50.

This liquid supplying operation is typically performed at the time of activation of the post-processing apparatus 3 or at the time of start of execution of the binding processing involving liquid application in the post-processing apparatus 3, and corresponds to the liquid supply operations for bringing the liquid application using the liquid application member 501 to be executable.

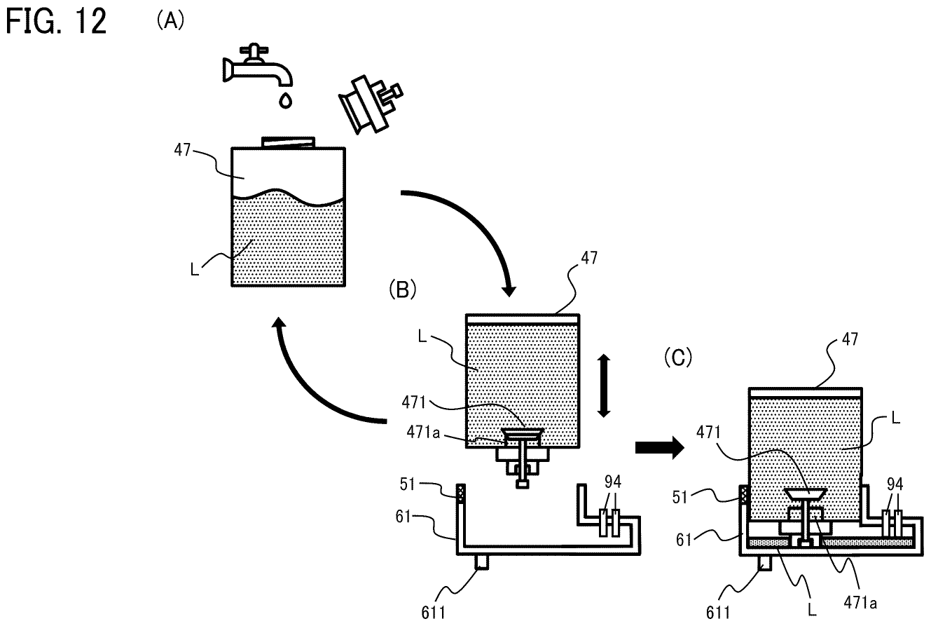

The edge binder 25 or the post-processing apparatus 3 is provided with the second liquid storage tank 47. The second liquid storage tank 47 is detachably attached to the second liquid storage tank fixer 61 as a part of the second liquid storage disposed in the edge binder 25 or the post-processing apparatus 3 (see FIG. 12). The second liquid storage tank fixer 61 may be disposed in either of the edge binder 25 or the post-processing apparatus 3. When the second liquid storage tank 47 is set to the second liquid storage tank fixer 61 at a given posture, the liquid L in the second liquid storage tank 47 can be supplied to the first liquid storage tank 44 via the second liquid storage tank fixer 61.

The operation of supplying the liquid L by the liquid supply pump 46 from the second liquid storage tank 47 to the first liquid storage tank 44 is executed in response to a reduction in the level of the liquid L in the first liquid storage tank 44 to be lower than the reference liquid level described above. The level of the liquid L in the first liquid storage tank 44 is reduced when the liquid Lis consumed by the liquid application by the liquid applier 31. In other words, the operation of supplying the liquid L from the second liquid storage tank 47 to the first liquid storage tank 44 corresponds to the liquid supply operation by the liquid applier 31 along with the execution of the binding process including the liquid application.

This liquid supply operation corresponds to an operation of supplying the liquid L to the first liquid storage tank 44 so as to add the liquid L each time the level of the liquid Lin the first liquid storage tank 44 falls below the reference liquid level described above.

As the second liquid storage tank 47 is set in the second liquid storage tank fixer 61, the liquid L of the second liquid storage tank 47 is filled to the second liquid storage tank fixer 61 by a certain amount. The second liquid storage tank fixer 61 is provided with a setting detection sensor 51 as a setting detector to detect the setting state of the second liquid storage tank 47 (see FIG. 12B). When the setting detection sensor 51 detects the setting state (see FIG. 12C) of the second liquid storage tank 47 to the second liquid storage tank fixer 61, a signal indicating that the second liquid storage tank 47 is set to the second liquid storage tank fixer 61 is transmitted to a controller 100b, which is described below. Thus, the controller 100b determines whether the second liquid storage tank 47 is set to the second liquid storage tank fixer 61, based on the signal received from the setting detection sensor 51. Details of the second liquid storage tank 47 are described later.

The first liquid storage tank 44 and the second liquid storage tank 47 are coupled to each other by the liquid conveyance path 45. The liquid supply pump 46 is disposed near the second liquid storage tank fixer 61. As the liquid supply pump 46 is driven, the liquid L in the second liquid storage tank 47 is supplied from the second liquid storage tank 47 to the first liquid storage tank 44 via the liquid conveyance path 45. Accordingly, the second liquid storage tank fixer 61 is a component of the liquid conveyor that executes the liquid supply operation to supply the liquid L from the second liquid storage tank 47 to the first liquid storage tank 44. The liquid conveyance path 45 includes a flexible material. According to such a configuration, even though the first liquid storage tank 44 is moved by the liquid applier movement assembly 35, the liquid L can be supplied from the second liquid storage tank 47 to the first liquid storage tank 44.

The amount of the liquid L to be supplied from the second liquid storage tank 47 to the first liquid storage tank 44 can be controlled in accordance with the detection result of the first liquid level sensor 43. In other words, the controller 100b, which is described below, determines the level of the liquid L in the first liquid storage tank 44, in other words, the stored liquid amount in the first liquid storage tank 44, based on the detection result of the first liquid level sensor 43. Then, the controller 100b described below controls the operation speed and the operation time of the liquid supply pump 46 according to the level of the liquid L in the first liquid storage tank 44 that is determined by the controller 100b. By so doing, the amount of the liquid L to be supplied from the second liquid storage tank 47 to the first liquid storage tank 44 is adjusted, so that the level of the liquid L in the first liquid storage tank 44 can be held equal to or higher than the given level of liquid.

### Configuration of Crimper 32

As illustrated in FIG. 3, the crimper 32 as a post-processing device disposed in the edge binder 25 is pressed and deformed in at least a portion, in other words, the liquid application position of the sheet bundle Pb, to which liquid has been applied by the liquid applier 31, by serrated upper crimping teeth 32a and serrated lower crimping teeth 32b, and crimps the sheets P of the portion to bind the sheet bundle Pb. In other words, the crimper 32 can bind the sheet bundle Pb without staples. The components of the crimper 32 such as the upper crimping teeth 32a and the lower crimping teeth 32b are disposed on a crimping frame 32c. In the following description, such a way of pressing and deforming a given position on the sheet bundle Pb to bind the sheet bundle Pb may be referred to as “crimp binding.” In other words, the crimper 32 crimps and binds the sheet bundle Pb or performs the crimp binding on the sheet bundle Pb. The crimp binding operation of the crimper 32 that involves a control process is referred to as a “crimp binding operation”.

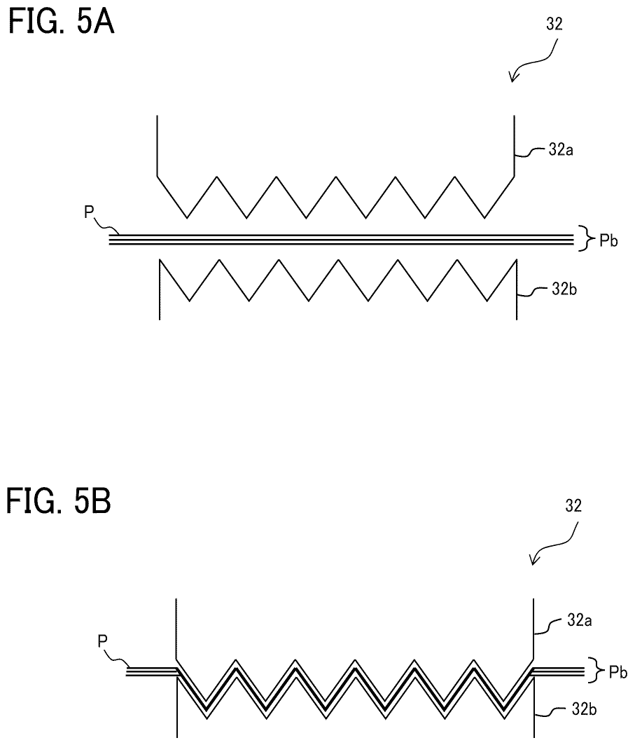

FIGS. 5A and 5B are schematic diagrams illustrating a configuration of the crimper 32.

As illustrated in FIGS. 5A and 5B, the crimper 32 includes the upper crimping teeth 32a and the lower crimping teeth 32b. The upper crimping teeth 32a and the lower crimping teeth 32b are disposed to face each other in the thickness direction of the sheet bundle Pb to pinch the sheet bundle Pb placed on the internal tray 22. The upper crimping teeth 32a and the lower crimping teeth 32b have respective serrate faces facing each other. The serrate face of each of the upper crimping teeth 32a and the lower crimping teeth 32b includes concave portions and convex portions alternately formed. The upper crimping teeth 32a and the lower crimping teeth 32b are formed in a positional relationship in which the concave portions and the convex portions are shifted so as to mesh with each other. The upper crimping teeth 32a and the lower crimping teeth 32b approach and move away from each other by the driving force of a contact-separation motor 32d illustrated in FIG. 13.

In the process of stacking the multiple sheets P of the sheet bundle Pb to the internal tray 22, the upper crimping teeth 32a and the lower crimping teeth 32b are separated from each other as illustrated in FIG. 5A. When multiple sheets P of the sheet bundle Pb are stacked on the internal tray 22, the upper crimping teeth 32a and the lower crimping teeth 32b are engaged with each other as illustrated in FIG. 5B by the driving force of the contact-separation motor 32d to press and deform the sheet bundle Pb in the thickness direction. As a result, the sheet bundle Pb that has been placed on the internal tray 22 is crimped and bound. The sheet bundle Pb thus crimped and bound is ejected to the second ejection tray 26 by the conveyance roller pair 15.

The configuration of the crimper 32 as a crimping assembly is not limited to the configuration of an operating assembly exemplified in the present embodiment, and may be any other suitable structure in which the upper crimping teeth 32a and the lower crimping teeth 32b of the crimping assembly engage with each other. For example, the crimping assembly may bring the upper crimping teeth 32a and the lower crimping teeth 32b into contact with each other and separate the upper crimping teeth 32a and the lower crimping teeth 32b from each other with a link mechanism and a driving source that simply rotates in the forward direction or that rotates the forward and backward directions (e.g., the crimping assembly disclosed in Japanese Patent No. 6057167). Alternatively, the crimping assembly may employ a linear motion system to linearly bring the upper crimping teeth 32a and the lower crimping teeth 32b into contact with each other and separate the upper crimping teeth 32a and the lower crimping teeth 32b from each other with a screw assembly that converts the forward and backward rotational motions of a driving source into linear reciprocating motion.

As illustrated in FIG. 3, the edge binder 25 includes an edge binder movement assembly 57. The edge binder movement assembly 57 moves the edge binder 25, in other words, the liquid applier 31 and the crimper 32, in the main scanning direction along a downstream end, in the conveyance direction, of the sheet P placed on the internal tray 22. The edge binder movement assembly 57 includes, for example, the base 48, a guide shaft 49, the edge binder movement motor 55, and a driving force transmission assembly 551 that transmits the driving force of the edge binder movement motor 55 to the base 48, and a standby position sensor 540 (see FIG. 13).

The liquid applier 31 and the crimper 32 are attached to the base 48 such that the liquid applier 31 and the crimper 32 are adjacent to each other in the main scanning direction. As illustrated in FIGS. 3 and 4, the guide shaft 49 is disposed in the main scanning direction on the upstream side of a binding assembly base 116 in the conveyance direction and is held by multiple guide shaft brackets 49a and 49b. As illustrated in FIG. 3, the guide shaft 49 is disposed to extend in the main scanning direction on the binding assembly base 116, and holds the base 48 to be movable in the main scanning direction. As illustrated in FIG. 4, the guide rail 115 is disposed in the downstream side of the binding assembly base 116 in the conveyance direction and extends in the main scanning direction. As illustrated in FIG. 4, the guide rail 115 has a fitting target portion 115a that fits a scanning roller 48a, which is rotatably disposed on the base 48, across the main scanning direction. In other words, the base 48 is movably held by the guide shaft 49 and the guide rail 115 in the main scanning direction on the binding assembly base 116.

The edge binder movement motor 55 generates a driving force to move the edge binder 25. The driving force transmission assembly 551 transmits the driving force of the edge binder movement motor 55 to the base 48 via pulleys 551a and 551b, a timing belt 551c, and a fastening portion 48b that fastens the base 48 and the timing belt 551c. As a result, the liquid applier 31 and the crimper 32 integrated by the base 48 move in the main scanning direction along the guide shaft 49.

The edge binder movement motor 55 according to the present embodiment is, for example, a servo motor. With a servo motor, the edge binder 25 can be stopped at any target position without returning the edge binder 25 to the original position each time the edge binder 25 moves. In other words, the edge binder movement motor 55 can stop the edge binder 25 at a target position, in other words, a first liquid application position B1 (a first binding position B1) and a second liquid application position B2 (a second binding position B2) described below, without returning the edge binder 25 to an original position (for example, a standby position HP described below) each time the edge binder 25 moves.

The post-processing apparatus 3 further includes a standby position sensor 540 and an encoder sensor 541. The standby position sensor 540 is, for example, a standby position sensor 540 (see FIG. 13) to detect that the edge binder 25 has reached a standby position HP (see FIG. 13A). The encoder sensor 541 (see FIG. 13) is attached to an output shaft of the edge binder movement motor 55. The standby position sensor 540 is, for example, a light-shielding optical sensor. The controller 100b, which will be described below, detects that the edge binder 25 has reached the standby position HP, based on a detection result of the standby position sensor 540. The controller 100b also counts pulse signals output from the encoder sensor 541 to ascertain the current position of the edge binder 25 moved from the standby position HP.

However, a specific method of stopping the edge binder 25 at the target position without returning the edge binder 25 to the standby position HP is not limited to the aforementioned example. As another example, the post-processing apparatus 3 may include a sensor that detects that the edge binder 25 has reached a predetermined target position.

As illustrated in FIG. 3, a crimper shaft 54 provided with a drive transmission gear 54a is fixed to a bottom face of the crimping frame 32c that holds the components of the crimper 32. The crimper shaft 54 and the drive transmission gear 54a are held by a base 48 on which the crimping frame 32c is disposed, so as to be rotatable in the forward and reverse directions. The drive transmission gear 54a meshes with an output gear 56a of a crimper pivot motor 56. The crimper 32 can be rotated in the forward and reverse directions about the crimper shaft 54 on the base 48 by a driving force transmitted from the crimper pivot motor 56 to the crimper shaft 54 via the output gear 56a and the drive transmission gear 54a.

In the above description, the edge binder 25 has a configuration of moving along the guide shaft 49 with the crimper 32 and the liquid applier 31 being integrated, the embodiments of the present disclosure are not limited to the above-described configuration. For example, the crimper 32 and the liquid applier 31 may have a configuration of moving separately from each other.

### Example of Modification of Edge Binder 25

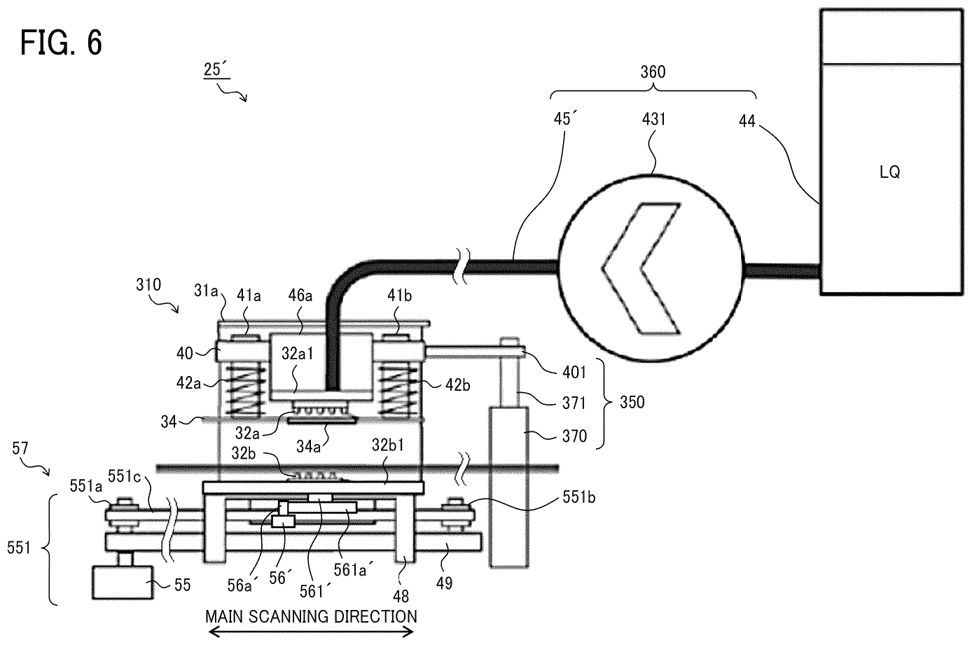

Specifically, referring now to FIGS. 6 to 8C, a description is given of an edge binder 25′ as a modification of the edge binder 25 included in the post-processing apparatus 3. A difference of the edge binder 25′ from the edge binder 25 according to the present disclosure illustrated in FIG. 3 is that the liquid applier 31 and the crimper 32 are integrated as a single unit. In the following description, the same or like components as those of the edge binder 25 described above are denoted by the same or like reference numerals, and redundant descriptions thereof may be omitted.

FIG. 6 is a diagram illustrating an edge binder 25′ according to a modification, viewed from the upstream side in the conveyance direction.

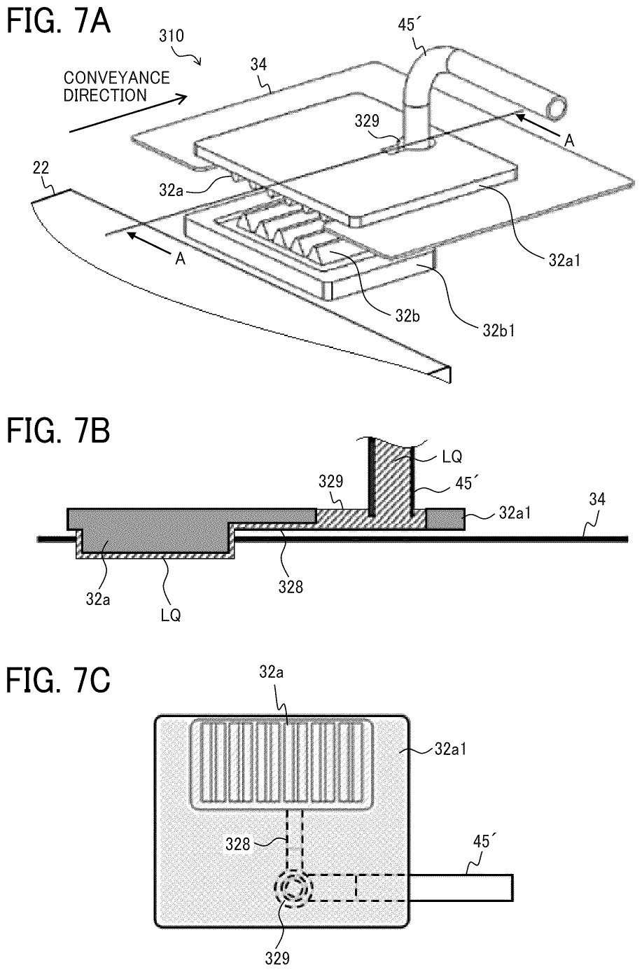

FIG. 7A is a perspective view of a liquid application crimper 310.

FIG. 7B is a side view of the liquid application crimper 310 taken along line A-A in FIG. 7A.

FIG. 7C is a plan view of the upper crimping teeth 32a of FIG. 7A as viewed from the side at which the lower crimping teeth 32b is disposed.

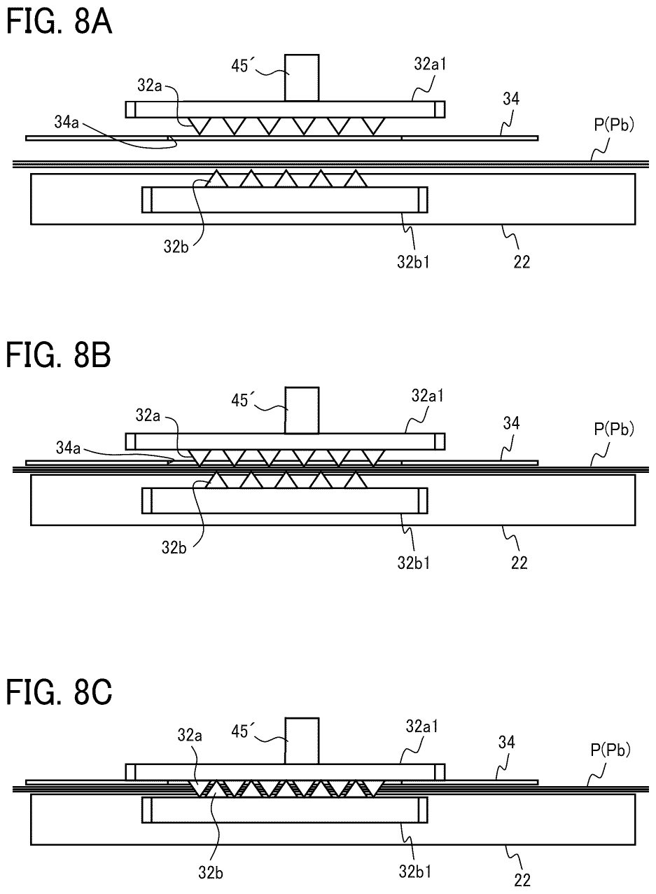

FIGS. 8A, 8B, and 8C are diagrams each illustrating a liquid applying operation and a crimp binding operation performed by the liquid application crimper 310 of FIGS. 7A, 7B, and 7C, viewed from the downstream side in the conveyance direction.

As illustrated in FIG. 6, the edge binder 25′ includes the liquid application crimper 310 in which the liquid applier 31 and the crimper 32 of the edge binder 25 according to the present disclosure are integrated as a single unit. The liquid application crimper 310 is disposed downstream from the internal tray 22 in the conveyance direction.

The liquid application crimper 310 applies liquid LQ stored in the first liquid storage tank 44 to a sheet P or a sheet bundle Pb placed on the internal tray 22. The liquid application crimper 310 can be moved in the main scanning direction by the driving force that is transmitted from the edge binder movement motor 55 to the base 48 by the driving force transmission assembly 551. The liquid application crimper 310 includes the upper pressure plate 34, the upper crimping teeth (upper binding teeth) 32a, the lower crimping teeth (lower binding teeth) 32b, a liquid application crimper movement assembly 350, and a liquid supply assembly 360. Components of the liquid application crimper 310 are held by at least one of the liquid application frame 31a and the base 48.

A liquid application crimper shaft 561′ provided with a drive transmission gear 561a′ is fixed to a bottom face of the liquid application frame 31a. The liquid application crimper shaft 561′ and the drive transmission gear 561a′ are held by the base 48 on which the liquid application frame 31a is disposed, so as to be rotatable in the forward and reverse directions. The drive transmission gear 561a′ meshes with an output gear 56a′ of a liquid application crimper pivot motor 56′. The liquid application crimper 310 can be rotated in the forward and reverse directions about the liquid application crimper shaft 561′ on the base 48 by a driving force transmitted from the liquid application crimper pivot motor 56′ to the liquid application crimper shaft 561′ via the output gear 56a′ and the drive transmission gear 561a′.

The liquid application crimper movement assembly 350 moves the upper pressure plate 34, the base plate 40, and the upper crimping teeth 32a in cooperation with each other in the thickness direction of the sheet P or the sheet bundle Pb by an electric cylinder 370. The base plate 40 holds the upper crimped teeth holder 32al and the upper crimping teeth 32a via a holder 46a. The base plate 40 movably holds the upper pressure plate 34 via the columns 41a and 41b. The base plate 40 is attached to the leading end of a rod 371 of the electric cylinder 370 through a coupler 401.

The columns 41a and 41b hold the upper pressure plate 34 at lower ends of the columns 41a and 41b. The coil springs 42a and 42b are externally inserted into the columns 41a and 41b between the base plate 40 and the upper pressure plate 34. The coil springs 42a and 42b bias the upper pressure plate 34 and the columns 41a and 41b in a direction away from the base plate 40.

The liquid supply assembly 360 includes the first liquid storage tank 44, a liquid supply pump 431, and a liquid conveyance path 45′. The liquid supply pump 431 supplies the liquid LQ via the liquid conveyance path 45′ to a liquid reservoir 329 disposed in the upper crimped teeth holder 32al as illustrated in FIG. 7A. The liquid conveyance path 45′ is coupled to the liquid supply pump 431 at the base end and to the liquid reservoir 329 at the tip end. The liquid conveyance path 45′ includes a long and elastic member.

As illustrated in FIG. 7B, the upper crimping teeth 32a are integrated with the upper crimped teeth holder 32a1. The upper crimping teeth holder 32al is provided with the liquid reservoir 329 and a liquid supply path 328 for supplying the liquid LQ stored in the liquid reservoir 329 to the upper crimping teeth 32a. As illustrated in FIG. 7C, the surface of the upper crimping teeth 32a is subjected to a hydrophilic treatment so that the liquid LQ that is supplied through the liquid supply path 328 uniformly spreads over the surface of the upper crimping teeth 32a. On the other hand, the portion of the upper crimped teeth holder 32al other than the upper crimping teeth 32a is subjected to a hydrophobic treatment so that the liquid LQ efficiently spreads over the surface of the upper crimping teeth 32a.

As illustrated in FIG. 6, the lower crimping teeth 32b are integrated with a lower crimping teeth holder 32b1, which is a part of the liquid application frame 31a. The lower crimping teeth 32b are attached to the base 48 via the lower crimping teeth holder 32b1.

A description is given below of the liquid application operation and the crimping operation of the liquid application crimper 310 with reference to FIGS. 8A, 8B, and 8C.

In the process of stacking a sheet P to the internal tray 22, as illustrated in FIG. 8A, the upper crimping teeth 32a and the lower crimping teeth 32b are separated from each other. When the sheet P is placed on the internal tray 22, the electric cylinder 370 is contracted to move the upper crimping teeth 32a and the upper pressure plate 34 toward the sheet P. Then, as illustrated in FIG. 8B, the upper pressure plate 34 first comes into contact with the sheet P, and then the upper crimping teeth 32a pass through the through hole 34a of the upper pressure plate 34 and come into contact with the sheet P. At this time, since the liquid LQ is spread over the surfaces of the upper crimping teeth 32a, bringing the upper crimping teeth 32a into contact with the sheet P allows the liquid LQ to be applied to the liquid application position on the sheet P. When liquid application to the liquid application position is completed, the electric cylinder 370 is extended to separate the upper crimping teeth 32a and the upper pressure plate 34 from the sheet P. The contact and separation operation of the upper crimping teeth 32a and the upper pressure plate 34 with respect to the sheets P described above is repeatedly performed on sheets P of the sheet bundle Pb. In other words, a liquid applying operation is repeatedly performed by the liquid application crimper 310.

When the sheet bundle Pb including a predetermined number of sheets P is placed on the internal tray 22, the electric cylinder 370 is further contracted to move the upper crimping teeth 32a form the liquid application position toward the lower crimping teeth 32b. Then, as illustrated in FIG. 8C, the upper crimping teeth 32a further moves toward the lower crimping teeth 32b, with the sheet bundle Pb sandwiched between the upper crimping teeth 32a and the lower crimping teeth 32b. Thus, the upper crimping teeth 32a and the lower crimping teeth 32b press and deform the sheet bundle Pb to crimp and bind the sheet bundle Pb. In other words, a crimp binding operation is repeatedly performed by the liquid application crimper 310.

### Configuration of Staple Binder 155

A detailed description is now given of the staple binder 155 having a function of executing a stapling process.

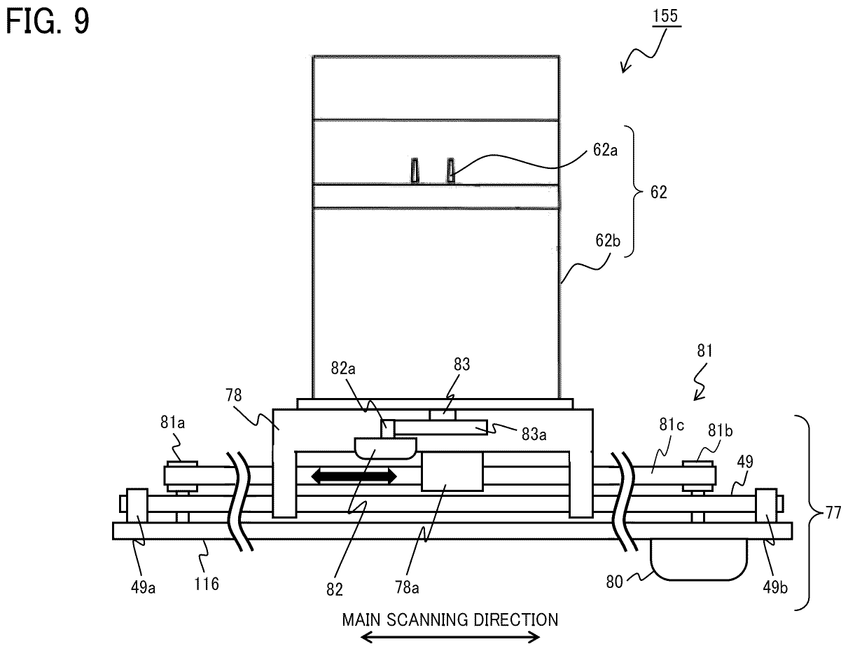

FIG. 9 is a schematic diagram illustrating the staple binder 155, viewed from the upstream side of the staple binder 155 in the conveyance direction.

The staple binder 155 includes a stapler 62 that binds the sheet bundle Pb with staples. The stapler 62 is disposed downstream from the internal tray 22 in the conveyance direction of the sheet P and spaced apart from the edge binder 25 in the main scanning direction.

The stapler 62 serving as a post-processing device has a configuration of performing so-called “staple binding” to bind a sheet bundle Pb with a staple(s). More specifically, the stapler 62 includes a stapling-part drive motor 62d (see FIG. 13) that drives the stapling part 62a. The stapling part 62a binds the sheet bundle Pb by causing the binding staple loaded in the stapling part 62a to penetrate the sheet bundle Pb by the driving force of the stapling-part drive motor 62d. The configuration of the stapler 62 is already known, and thus detailed description thereof will be omitted.

As illustrated in FIG. 9, the staple binder 155 includes a staple binder movement assembly 77. The staple binder movement assembly 77 moves the staple binder 155 in the main scanning direction along a downstream end in the conveyance direction of the sheet P or the sheet bundle Pb placed on the internal tray 22. The staple binder movement assembly 77 includes, for example, a base 78, the guide shaft 49, a staple binder movement motor 80, and a driving force transmission assembly 81. The driving force transmission assembly 81 transmits a driving force of the staple binder movement motor 80 to the base 78 via pulleys 81a and 81b, a timing belt 81c, and a fastening portion 78a that fastens the base 78 and the timing belt 81c. A stapler rotation shaft 83 including a drive transmission gear 83a is fixed to a bottom face of a stapling frame 62b that holds the components of the stapler 62.

The stapler rotation shaft 83 and the drive transmission gear 83a are held by the base 78 on which the stapling frame 62b is disposed, so as to be rotatable in the forward and reverse directions. The drive transmission gear 83a meshes with an output gear 82a of a stapler pivot motor 82. The stapler 62 is rotatable in the forward and reverse directions about the stapler rotation shaft 83 on the base 78 by a driving force transmitted from the stapler pivot motor 82 to the stapler rotation shaft 83 via the output gear 82a and the drive transmission gear 83a.

The edge binder 25 and the staple binder 155 are supported by the common guide shaft 49. In other words, the edge binder movement assembly 57 and the staple binder movement assembly 77 move the edge binder 25 and the staple binder 155 in the main scanning direction along the common guide shaft 49. The edge binder movement assembly 57 and the staple binder movement assembly 77 can separately move the edge binder 25 and the staple binder 155.

### Configuration of Modification of Staple Binder 155

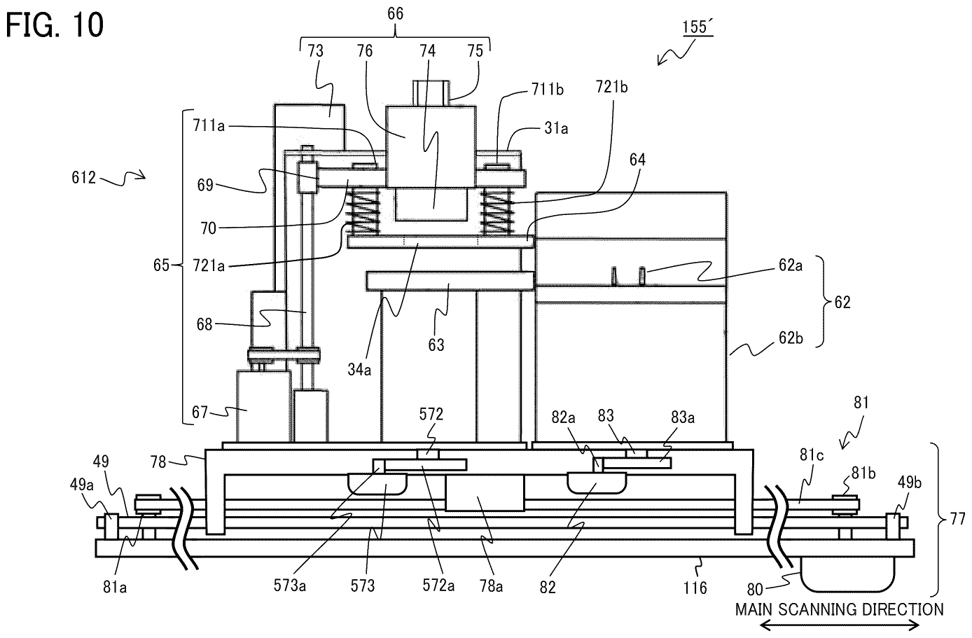

FIG. 10 illustrates a staple binder 155′ as a modification of the staple binder 155.

Specifically, FIG. 10 is a view of an upstream side of the staple binder 155′ in the conveyance direction. The staple binder 155′ is different from the staple binder 155 in that the staple binder 155′ includes a second liquid applier 612 in addition to the stapler 62. As illustrated in FIG. 10, the staple binder 155′ includes the second liquid applier 612 and the stapler 62. The second liquid applier 612 and the stapler 62 are disposed adjacent to each other in the main scanning direction on the downstream side of the internal tray 22 in the conveyance direction.

The second liquid applier 612 performs the liquid application of applying liquid L stored in a third liquid storage tank 73 to the sheet P or the sheet bundle Pb placed on the internal tray 22. A given area including a position to which the liquid is applied on the sheet P or the sheet bundle Pb by the second liquid applier 612 corresponds to a binding position to be stapled by the stapler 62. As illustrated in FIG. 10, the second liquid applier 612 includes a second lower pressure plate 63, a second upper pressure plate 64, a second liquid applier movement assembly 65, and a second liquid application assembly 66. The second liquid applier movement assembly 65 includes, for example, a second liquid applier movement motor 67, a second trapezoidal screw 68, a second nut 69, a second base plate 70, second columns 711a and 711b, and second coil springs 721a and 721b.

The second liquid application assembly 66 includes the third liquid storage tank 73, a second liquid supply member 75, a second liquid application member 74, and a second holder 76. Since the second liquid application assembly 66 and the liquid application assembly of the liquid applier 31 including the first liquid storage tank 44, the liquid supply member 50, the liquid application member 501, and the holder 37, illustrated in FIGS. 3 and 4, have common configurations, redundant descriptions thereof will be omitted unless otherwise required. Since the stapler 62 has a configuration similar to the configuration of the staple binder 155 illustrated in FIG. 9, a detailed description thereof is omitted below unless otherwise required. The configuration of the rotation mechanism of the second liquid applier 612 that includes the second liquid applier rotation motor 573, the second output gear 573a, the second drive transmission gear 572a, and the second liquid applier rotation shaft 572 is common to the configuration of the rotation mechanism of the liquid applier 31 that includes the liquid applier pivot motor 563, the output gear 563a, the drive transmission gear 562a, and the liquid applier rotation shaft 562 illustrated in FIG. 3, and the redundant descriptions thereof will be omitted unless otherwise required.

In the binding process, the staple binder 155′ that is illustrated in FIG. 10 performs the liquid application process on the sheet P to loosen and soften the binding position, allowing the staple to easily pass through the sheet bundle Pb. As a result, the number of sheets to be bound per sheet bundle Pb can be increased as compared with a case where the stapling process is performed without applying the liquid.

### Configuration of Second Liquid Storage Tank 47

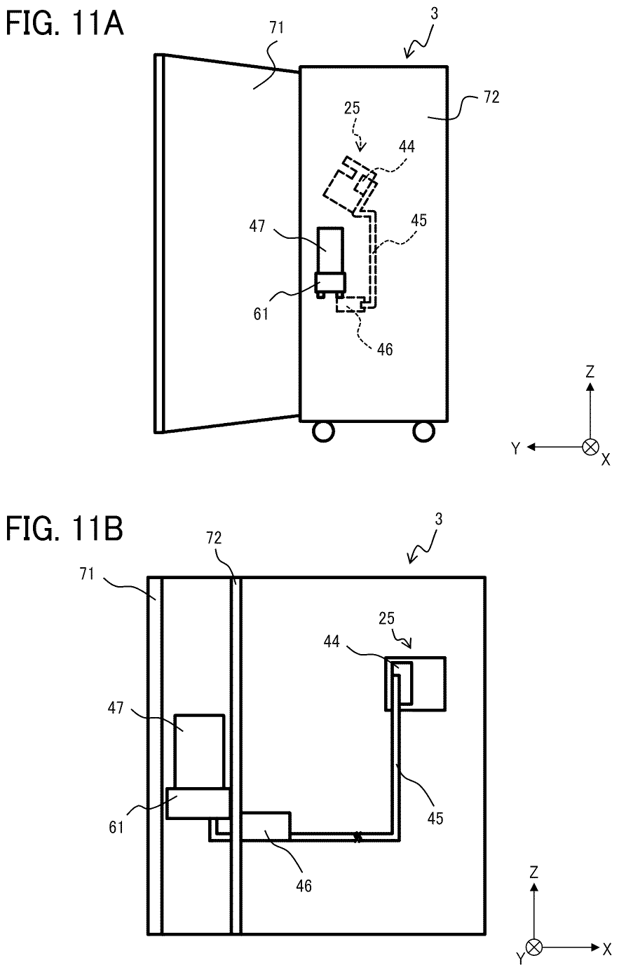

A description is given of the location and configuration of the second liquid storage tank 47 in the post-processing apparatus 3, with reference to FIGS. 11A, 11B and 12 including parts (A), (B) and (C).

FIGS. 11A and 11B illustrate example location and configuration of the second liquid storage tank 47 as the main tank in the post-processing apparatus 3.

FIG. 11A illustrates a state where a cover 71 as a part of the apparatus housing of the post-processing apparatus 3 is opened.

FIG. 11B is a cross-sectional side view of the post-processing apparatus 3, illustrating the post-processing apparatus 3 with the cover 71 closed.

As illustrated in FIGS. 11A and 11B, the second liquid storage tank 47 is located so as to be accessible when the cover 71 of the post-processing apparatus 3 is opened. As illustrated in FIG. 11B, the second liquid storage tank 47 and the second liquid storage tank fixer 61 are disposed on the near side in a depth direction (X direction) of the post-processing apparatus 3. The first liquid storage tank 44 is disposed on the far side in the depth direction (X direction) of the post-processing apparatus 3. A main body side plate 72 of the post-processing apparatus 3 is disposed between the location of the second liquid storage tank 47 and the second liquid storage tank fixer 61 and the location of the first liquid storage tank 44 and so forth. The second liquid storage tank fixer 61 is attached to the main body side plate 72 of the post-processing apparatus 3.

FIG. 12 including parts (A), (B) and (C) is a diagram illustrating a configuration of attachment and detachment of the second liquid storage tank 47 in the post-processing apparatus 3.

FIG. 12 illustrates a state in which the second liquid storage tank 47 is attachable to and detachable from the second liquid storage tank fixer 61 and a state in which liquid L is replenished to the second liquid storage tank 47.

As illustrated in the part (A) of FIG. 12, the second liquid storage tank 47 is attachable to and detachable from the second liquid storage tank fixer 61 so as to replenish the first liquid storage tank 44 with liquid L. As illustrated in the part (B) of FIG. 12, the second liquid storage tank fixer 61 is provided with the setting detection sensor 51 to detect that the second liquid storage tank 47 is set on the second liquid storage tank fixer 61.

When the setting detection sensor 51 detects the set state of the second liquid storage tank 47 to the second liquid storage tank fixer 61 (see the part (C) of FIG. 12), a signal indicating the set state is transmitted to the controller 100b, which is described below. Thus, the controller 100b determine whether the second liquid storage tank 47 is set on the second liquid storage tank fixer 61.

The second liquid storage tank fixer 61 includes a second liquid level sensor 94 as a second liquid detector or sensor to detect the liquid level of the liquid L stored in the second liquid storage tank fixer 61 (referred to as a “liquid L in the second liquid storage tank fixer 61” below). The output value of the second liquid level sensor 94, in other words, the detection voltage of the second liquid level sensor 94 is notified to the controller 100b. The controller 100b that is described below determines the output value of the second liquid level sensor 94. By so doing, the controller 100b determines whether the liquid level of the liquid L in the second liquid storage tank fixer 61 is at or above a sufficient liquid level, in other words, whether the liquid amount in the second liquid storage tank fixer 61 is the sufficient liquid amount. When the controller 100b that is described below determines that the second liquid storage tank 47 is set on the second liquid storage tank fixer 61 based on the output signal of the setting detection sensor 51, the controller 100b turns on the power of the second liquid level sensor 94. Accordingly, the second liquid level sensor 94 can be in a state where the second liquid level sensor 94 can detect the liquid level of the liquid L in the second liquid storage tank fixer 61, in other words, whether there is the liquid L in the second liquid storage tank fixer 61.

When the second liquid storage tank 47 is not on the second liquid storage tank fixer 61, a liquid discharge port 471a is closed by a liquid supply valve 471 so that liquid L does not leak. As illustrated in the part (C) of FIG. 12, when the second liquid storage tank 47 is set to the second liquid storage tank fixer 61, the liquid supply valve 471 is pushed up to open the liquid discharge port 471a of the second liquid storage tank 47. As a result, the liquid L stored in the second liquid storage tank 47 flows out to the second liquid storage tank fixer 61. The liquid L that has flowed out from the second liquid storage tank 47 is stored in the second liquid storage tank fixer 61.

As a measurement to prevent liquid L from being frozen during maintenance of the post-processing apparatus 3, a liquid draining process may be performed to drain the liquid L in the post-processing apparatus 3. In the liquid draining process, the liquid L remaining in the first liquid storage tank 44 and the liquid conveyance path 45 is supplied by the liquid supply pump 46 to the second liquid storage tank fixer 61 via the liquid conveyance path 45 in the reverse direction. For that purpose, the second liquid storage tank fixer 61 is set to the capacity that can sufficiently store liquid L in the first liquid storage tank 44 and the liquid conveyance path 45.

As illustrated in the parts (B) and (C) of FIG. 12, the second liquid storage tank fixer 61 is provided with a liquid drain plug 611. In the liquid draining process, the liquid L remaining in the first liquid storage tank 44 and the liquid conveyance path 45 is supplied by the liquid supply pump 46 to the second liquid storage tank fixer 61 in the reverse direction, so as to open the liquid drain plug 611. As the liquid drain plug 611 is open, the liquid L in the second liquid storage tank fixer 61 can be discharged to the outside of the post-processing apparatus 3.

### Configuration of Control Block of Post-Processing Apparatus 3

A description is given below of a control block of the post-processing apparatus 3, with reference to FIG. 13.

FIG. 13 is a block diagram illustrating a hardware configuration of control blocks that control the post-processing apparatus 3 according to the present disclosure.

As illustrated in FIG. 13, the post-processing apparatus 3 includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3.

The RAM 102 is a volatile storage medium that allows high speed reading and writing of data, and is used as a working area when the CPU 101 processes information.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3 processes, for example, a control program stored in the ROM 103 and an information processing program (application program) loaded into the RAM 102 from a storage medium such as the HDD 104. Such processing configures a software controller including various functional modules of the post-processing apparatus 3. The software controller thus configured cooperates with hardware resources of the post-processing apparatus 3 to construct functional blocks that implement functions of the post-processing apparatus 3. In other words, the CPU 101, the RAM 102, the ROM 103, the HDD 104, and the I/F 105 constitute at least part of the controller 100b as a control device that controls the operation of the post-processing apparatus 3.

The I/F 105 is an interface that connects the conveyance roller pairs 10, 11, 14, and 15, the switcher 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, the liquid supply pump 46, the movement sensor 40a, the first liquid level sensor 43, the second liquid level sensor 94, the setting detection sensor 51, the standby position sensor 540, the encoder sensor 541, a cover detection sensor 542, and a control panel 110, to the common bus 109.

The controller 100b controls, via the I/F 105, the operations of the conveyance roller pairs 10, 11, 14, and 15, the switcher 20, the side fences 24L and 24R, the contact-separation motor 32d, the crimper pivot motor 56, the liquid applier movement motor 42, the liquid applier pivot motor 563, the edge binder movement motor 55, the stapling-part drive motor 62d, the stapler pivot motor 82, the staple binder movement motor 80, and the liquid supply pump 46. The controller 100b acquires detection results of the movement sensor 40a, the first liquid level sensor 43, the second liquid level sensor 94, the setting detection sensor 51, the standby position sensor 540, the encoder sensor 541, and the cover detection sensor 542. Although FIG. 13 illustrates only the components related to the edge binder 25 and the staple binder 155 that perform the edge binding, the components related to the saddle binder 28 that performs the saddle binding are also controlled by the controller 100b.

As illustrated in FIG. 1, the image forming apparatus 2 includes the control panel 110. The control panel 110 includes an operation device that receives instructions input by an operator and a display serving as a notification unit that notifies the operator (user) of information. The operation device includes, for example, physical input buttons and a touch panel overlaid on a display. The control panel 110 acquires information from the user through the operation unit and provides the information to the user through the display. A specific example of the notifier is not limited to the display and may be a light-emitting diode (LED) lamp or a speaker. The post-processing apparatus 3 may include a control panel 110 similar to the above-described control panel 110 of the image forming apparatus 2.

As described above, the post-processing apparatus 3 implements the function of performing operation control related to the liquid application by software, in other words, control program, executed by the CPU 101 with hardware resources included in the controller 100b.

As described above, the post-processing apparatus 3 includes the edge binder 25 that can perform the post-processing such as the crimp binding process that performs liquid application after the liquid application process. When the number of sheets P that makes up the sheet bundle Pb is small, the edge binder 25 may perform the crimp binding operation with no liquid application, i.e., the crimp binding operation using the crimper 32 only, in a similar manner to the crimp binding in the related art.

The liquid application executed by the post-processing apparatus 3 may be performed by the staple binder 155 including the stapler 62 only, and the liquid application may be performed by using the liquid applier 31 included in the edge binder 25. By contrast, the edge binder 25 may include only the crimper 32, and the liquid application may be performed in a mode in which the second liquid applier 612 is used. In other words, the post-processing apparatus 3 may have a configuration in which only one of the liquid applier 31 and the second liquid applier 612 performs the liquid application, regardless of the type of the binding process.

In the above description, the staple binder 155′ has a configuration in which the stapler 62 and the second liquid applier 612 move along the guide shaft 49 as a single unit. However, the configuration of the staple binder is not limited to the above-described configuration. For example, the stapler 62 and the second liquid applier 612 may move separately.

A description is given of a binding process according to an embodiment of the present disclosure.

A description is given below of the binding process executed by the edge binder 25 included in the post-processing apparatus 3.

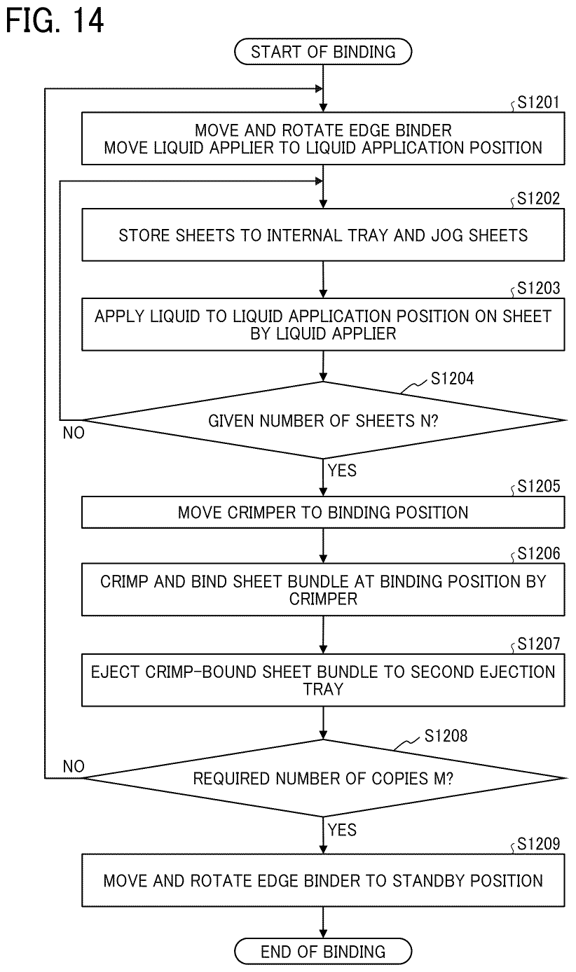

FIG. 14 is a flowchart of the single stapling binding performed by the edge binder 25.

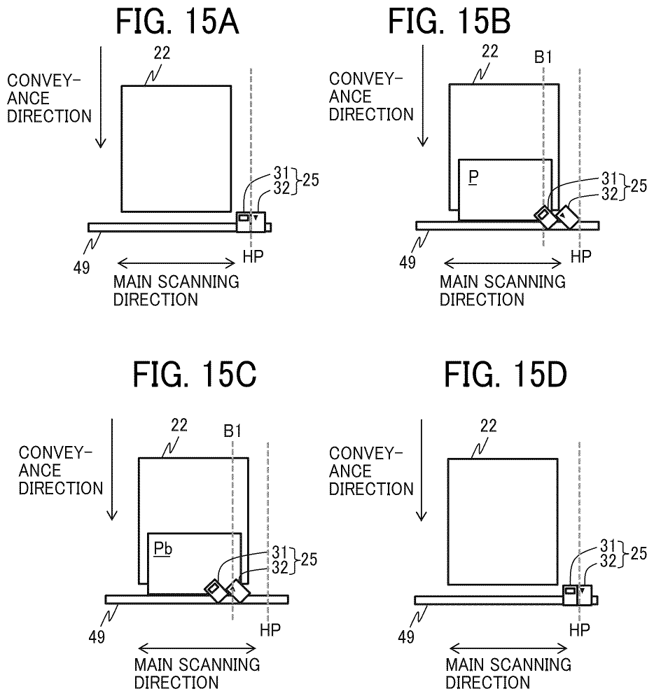

FIGS. 15A, 15B, 15C and 15D are diagrams illustrating the position shift of the edge binder 25 including the liquid applier 31 and the crimper 32 during a single stapling binding by the edge binder 25.

FIGS. 15A, 15B, 15C, and 15D do not illustrate changes in the postures of the liquid applier 31 and the crimper 32. The position (referred to a “liquid application position” below) to which liquid is applied on a sheet P or a sheet bundle Pb by the liquid applier 31 corresponds to the binding position on the sheet bundle Pb to be crimped by the crimper 32. For this reason, in the following description, the liquid application position and the binding position are denoted by the same reference numeral (B1 and B2).

For example, the controller 100b starts the binding process illustrated in FIG. 14 when the controller 100b acquires an execution command of the binding process from the image forming apparatus 2. In the following description, the execution command of the binding process may be referred to as a “binding command.”

The binding command includes information of, for example, the sheet type of the sheet P, the number of sheets P of the sheet bundle Pb, the number of sheet bundles Pb to be bound in the binding process, the binding position on the sheet bundle Pb, and a binding posture of the edge binder 25. The information of the sheet type of the sheet P includes information that affects the spread of the liquid L, such as the material and the thickness. In the following description, the number of sheets P of the sheet bundle Pb is referred to as a “given number N of sheets”. The number of copies of the sheet bundles Pb to be subjected to the binding process is denoted as a “requested number of copies M”.

The liquid applier 31 and the crimper 32 are assumed to be in a parallel binding posture and located at a standby position HP, as illustrated in FIG. 15A, that is a position shifted in the main scanning direction from the sheets P placed on the internal tray 22 at the start of the binding process.

When the posture that is instructed by the binding command is the “oblique binding posture”, the controller 100b drives the liquid applier pivot motor 563 and the crimper pivot motor 56 to rotate the liquid applier 31 and the crimper 32 included in the edge binder 25 into the oblique binding posture (step S1201). When the posture is the “inclined binding posture”, the crimper 32 alone may be rotated to the inclined binding posture and the liquid applier 31 may be restricted not to rotate in the forward and reverse directions. Such a configuration can simplify the driving mechanism as compared with a configuration in which both the liquid applier 31 and the crimper 32 are rotated in the forward and reverse directions. Thus, the effects of cost reduction, the downsizing of the apparatus, and the reduction of a failure of devices are obtained.

On the other hand, when the posture that is instructed by the binding command is the “parallel binding posture,” the controller 100b omits the aforementioned operation of rotating the liquid applier 31 and the crimper 32 included in the edge binder 25 to the inclined binding posture.

The controller 100b drives the edge binder movement motor 55 to move the edge binder 25 in the main scanning direction by the edge binder movement assembly 57 so that the liquid applier 31 faces the first liquid application position B1 instructed by the binding command (step S1201). The controller 100b executes the operation of step S1201 before a first sheet Pis conveyed to the internal tray 22 by the conveyance roller pairs 10, 11, 14, and 15.

The controller 100b rotates the conveyance roller pairs 10, 11, 14, and 15 to store the sheet P, on which the image has been formed by the image forming apparatus 2, onto the internal tray 22 (step S1202). The controller 100b also moves the side fences 24L and 24R as aligners reciprocally in the main scanning direction to align the position of the sheet P or the sheet bundle Pb placed on the internal tray 22 in the main scanning direction. In short, the controller 100b performs so-called jogging (step S1202).

In step S1203, the controller 100b causes the liquid applier 31 facing the first liquid application position B1 to apply liquid to the first liquid application position B1 of the sheet P placed on the internal tray 22 in the immediately preceding step S1202, based on the liquid application control data adjusted in advance. In other words, the controller 100b drives the liquid applier movement motor 42 to bring the liquid application member 501 into contact with the first liquid application position B1 on the sheet P placed on the internal tray 22 (see FIG. 15B). In the liquid application process in step S1703, the controller 100b adjusts the position at which the liquid application member 501 applies liquid to the sheet P in accordance with the type of the sheet P and the binding position included in the binding command. The controller 100b adjusts the amount of pressing the liquid application member 501 against the sheet P. In other words, the controller 100b controls the driving of the liquid applier movement motor 42 based on the adjusted control data, and adjusts the amount of movement of the liquid application member 501 with respect to the binding position B1 of the sheet P placed on the internal tray 22.

The controller 100b determines whether the number of sheets P placed on the internal tray 22 has reached the given number of sheets N instructed by the binding command in step S1204. When the controller 100b determines that the number of sheets P placed on the internal tray 22 has not reached the given number of sheets N (NO in step S1204), the controller 100b executes the operations of steps S1202 to S1204 again until the number of sheets P placed on the internal tray 22 reaches the given number of sheets N (YES in step S1204). In other words, the controller 100b executes the processes of step S1202 to step S1204 each time the sheet Pis conveyed to the internal tray 22 by the conveyance roller pairs 10, 11, 14, and 15. The liquid application by the liquid applier 31 may be performed not only on all of the plurality of sheets P included in the sheet bundle Pb but also on only some of the plurality of sheets P included in the sheet bundle Pb.

When the controller 100b determines that the number of sheets P placed on the internal tray 22 has reached the given number of sheets N (YES in step S1204), in step S1205, the controller 100b drives the edge binder movement motor 55 to move the edge binder 25 in the main scanning direction by the edge binder movement assembly 57 such that the crimper 32 faces the first binding position B1 as illustrated in FIG. 15C.

In step S1206, the controller 100b causes the crimper 32 to crimp the sheet bundle Pb placed on the internal tray 22. In step S1207, the controller 100b causes the conveyance roller pair 15 to eject the sheet bundle Pb thus crimped and bound by the crimper 32 to the second ejection tray 26. Specifically, the controller 100b drives the contact-separation motor 32d to cause the upper crimping teeth 32a and the lower crimping teeth 32b to nip the first binding position B1 on the sheet bundle Pb placed on the internal tray 22. Specifically, the controller 100b drives the contact-separation motor 32d to cause the upper crimping teeth 32a and the lower crimping teeth 32b to nip the first binding position B1 on the sheet bundle Pb placed on the internal tray 22. The sheet bundle Pb is pressed and deformed between the upper crimping teeth 32a and the lower crimping teeth 32b, and thus the sheet bundle Pb is crimped. Then, the controller 100b rotates the conveyance roller pair 15 to eject the sheet bundle Pb thus crimped and bound to the second ejection tray 26.

The sheet bundle Pb that is supported on the internal tray 22 has a crimping area (in other words, the first binding position B1) sandwiched between the upper crimping teeth 32a and the lower crimping teeth 32b in step S1206. The crimping area overlaps with a liquid application area (in other words, the first liquid application position B1) contacted by a distal end of the liquid application member 501 in step S1203. In other words, the crimper 32 crimps an area to which liquid is applied by the liquid applier 31 on the sheet bundle Pb placed on the internal tray 22. The crimping area that is pinched by the upper crimping teeth 32a and the lower crimping teeth 32b may completely or partially overlap with the liquid application area contact by the distal end of the liquid application member 501, to obtain a sufficient binding strength.

In step S1208, the controller 100b determines whether the number of sheet bundles Pb thus ejected to the second ejection tray 26 has reached the requested number of copies M indicated by the binding command. When the controller 100b determines that the number of sheet bundles Pb thus ejected has not reached the requested number of copies M (NO in step S1208), the controller 100b executes the operations of step S1201 and the following steps again. In other words, when the controller 100b determines that the number of sheet bundles Pb thus ejected has not reached the requested number of copies M (NO in step S1208), the controller 100b repeats the operations of steps S1201 to S1208 until the number of sheet bundles Pb ejected to the second ejection tray 26 reaches the requested number of copies M (YES in step S1208).

On the other hand, when the controller 100b determines that the number of sheet bundles Pb output to the second ejection tray 26 has reached the requested number of copies M (YES in step S1208), in step S1209, the controller 100b drives the edge binder movement motor 55 to move the edge binder 25 including the liquid applier 31 and the crimper 32 to the standby position HP as illustrated in FIG. 15D. When the posture that is instructed by the binding command is the “oblique binding posture,” the controller 100b drives the liquid applier pivot motor 563 and the crimper pivot motor 56 to rotate the liquid applier 31 and the crimper 32 into the parallel binding posture (step S1209). On the other hand, when the posture that is instructed by the binding command is the “parallel binding posture,” the controller 100b skips the aforementioned operation of rotating the liquid applier 31 and the crimper 32 to the parallel binding posture. As a result, the edge binder 25 including the liquid applier 31 and the crimper 32 returns to the standby position HP as illustrated in FIG. 15D. In steps S1201 and S1209, the execution order of the movement of the edge binder 25 in the main scanning direction by the edge binder movement assembly 57 and the rotation of the liquid applier 31 and the crimper 32 in the forward and reverse directions by the liquid applier pivot motor 563 and the crimper pivot motor 56 is not limited to the aforementioned order and may be reversed.

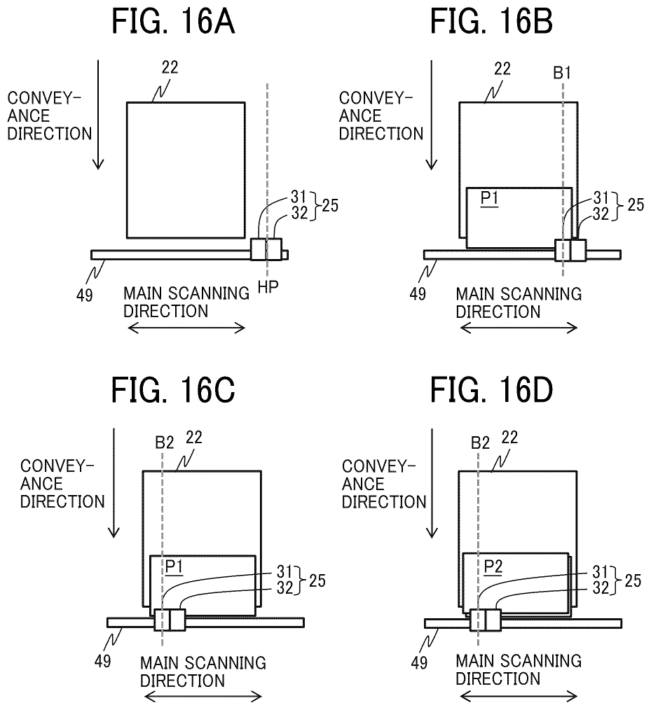

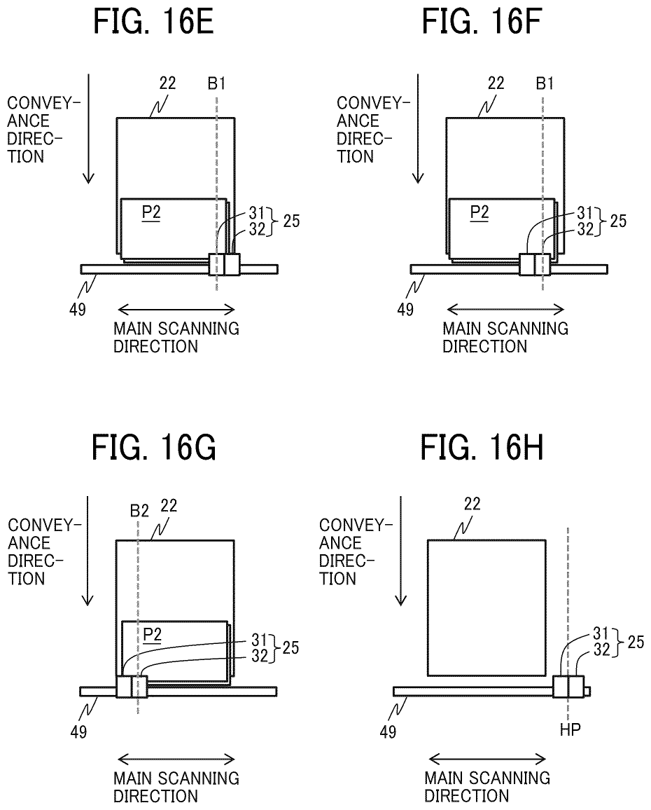

FIGS. 16A, 16B, 16C, 16D, 16E, 16F, 16G, and 16H are diagrams illustrating the position shift of the edge binder 25 during a dual stapling binding.

A detailed description is given of points common to the process described with reference to FIGS. 15A to 15D, and the differences will be mainly described.

As illustrated in FIG. 16A, it is assumed that the edge binder 25 is located at the standby position HP at the start point of the dual stapling binding. The first binding position B1 and the second binding position B2 are apart from each other in the main scanning direction. Further, FIGS. 16A to 16H illustrate the case where two sheets P1 and P2 are crimped and bound (i.e., N=2). In the case of executing the dual stapling binding, the number of sheets P included in the sheet bundle Pb is not limited to two, and the dual stapling binding can be performed on a sheet bundle Pb having the same number of sheets as the number of sheets that can be bound in the single stapling binding.

Before a first sheet P1 for a sheet bundle Pb is conveyed to the internal tray 22, the controller 100b causes the edge binder movement assembly 57 to move the edge binder 25 in the main scanning direction such that the liquid applier 31 can face the first liquid application position B1 (see FIG. 16B). As illustrated in FIG. 16B, the liquid applier 31 is disposed at a position at which the liquid applier 31 can face the first liquid application position B1. In such a state, the controller 100b causes the first sheet P1, on which an image has been formed by the image forming apparatus 2, to be placed on the internal tray 22 and performs a jogging process on the first sheet P1 by the side fences 24L and 24R. In response to the placement of the first sheet P1 on the internal tray 22, the controller 100b causes the liquid applier 31 to apply the liquid to the first liquid application position B1 of the first sheet P1.

Subsequently, as illustrated in FIG. 16C, the controller 100b causes the edge binder movement assembly 57 to move the edge binder 25 in the main scanning direction such that the liquid applier 31 faces the second liquid application position B2 of the first sheet P1. Then, the controller 100b causes the liquid applier 31 to apply the liquid to the second liquid application position B2 of the first sheet P1.

In response to the application of the liquid L to the first liquid application position B1 and the second liquid application position B2 of the first sheet P1, the controller 100b causes a second sheet P2 for the sheet bundle Pb to be placed on the internal tray 22 and performs the jogging process on the second sheet P2 by the side fences 24L and 24R in a state where the liquid applier 31 is disposed at a position which the liquid applier 31 can face the second liquid application position B2 as illustrated in FIG. 16D. In response to the placement of the second sheet P2 on the internal tray 22, the controller 100b causes the liquid applier 31 to apply the liquid to the second liquid application position B2 of the second sheet P2.

Then, as illustrated in FIG. 16E, the controller 100b causes the edge binder movement assembly 57 to move the edge binder 25 in the main scanning direction such that the liquid applier 31 faces the first liquid application position B1 of the second sheet P2. Subsequently, the controller 100b causes the liquid applier 31 to apply the liquid at the first liquid application position B1 of the second sheet P2.

In other words, the controller 100b controls the conveyance roller pairs 10, 11, 14, and 15 and the liquid applier 31 to repeatedly execute the conveyance of the sheet P and the liquid application to the first liquid application position B1 and the second liquid application position B2 until the number of sheets P placed on the internal tray 22 reaches the given number of sheets N. At this time, the controller 100b causes the liquid applier 31 to perform the liquid application to the B-th sheet P (B<N) in the order of the first liquid application position B1 and the second liquid application position B2. The controller 100b also causes the liquid applier 31 to perform the liquid application to the (B+1)-th sheet P in the order of the second liquid application position B2 and the first liquid application position B1. In other words, the controller 100b changes the order in which the liquid applier 31 applies the liquid to the first liquid application position B1 and the second liquid application position B2 for each sheet P. The controller 100b also causes the edge binder 25 to move from one side of the first liquid application position B1 and the second liquid application position B2 to the other side of the first liquid application position B1 and the second liquid application position B2 in the shortest distance without passing through the standby position HP.

Subsequently, when the controller 100b determines that the number of sheets P placed on the internal tray 22 has reached the given number of sheets N, the controller 100b causes the edge binder movement assembly 57 to move the edge binder 25 in the main scanning direction such that the crimper 32 faces the first binding position B1 as illustrated in FIG. 16F. The controller 100b causes the crimper 32 to perform crimp binding at the first binding position B1 on the sheet bundle Pb including the first sheet P1 and the second sheet P2 placed on the internal tray 22.

Then, as illustrated in FIG. 16G, the controller 100b causes the edge binder movement assembly 57 to move the edge binder 25 in the main scanning direction such that the crimper 32 faces the second binding position B2 of the sheet bundle Pb. The controller 100b causes the crimper 32 to perform crimp binding on the second binding position B2 of the sheet bundle Pb placed on the internal tray 22.

In the example illustrated in FIGS. 16A to 16H, since the controller 100b causes the liquid applier 31 to finally apply the liquid to the first liquid application position B1, the crimper 32 performs the crimp binding processes in the order of the first binding position B1 and the second binding position B2. On the other hand, in a case where the controller 100b causes the liquid applier 31 to execute the liquid application to the second liquid application position B2 last, the controller 100b may cause the crimper 32 to execute the crimping in the order of the second binding position B2 and the first binding position B1.

In other words, as illustrated in FIGS. 16A to 16H, the controller 100b can cause the edge binder movement assembly 57 to move the edge binder 25 by the shortest distance between the position at which the liquid applier 31 faces the first liquid application position B1 and the position at which the liquid applier 31 faces the second liquid application position B2 without passing through the standby position HP. The edge binder movement assembly 57 can also move the edge binder 25 by the shortest distance between the position at which the crimper 32 faces the first binding position B1 and the position at which the crimper 32 faces the second binding position B2 without passing through the standby position HP. Further, the controller 100b causes the edge binder movement assembly 57 to move the edge binder 25 by the shortest distance between the position at which the liquid applier 31 faces the first liquid application position B1 (or the second liquid application position B2) and the position at which the crimper 32 faces the first binding position B1 (or the second binding position B2) without passing through the standby position HP. Accordingly, the productivity of the crimp binding can be enhanced.

Then, the controller 100b causes the conveyance roller pair 15 to rotate to eject the sheet bundle Pb to the second ejection tray 26 after the sheet bundle Pb is crimped and bound by the crimper 32 at the first binding position B1 and the second binding position B2. Further, as illustrated in FIG. 16H, the controller 100b drives the edge binder movement motor 55 to move the edge binder 25 including the liquid applier 31 and the crimper 32 to the standby position HP.

Although an example in which one or two positions of the sheet bundle Pb are crimped and bound has been described in the above-described embodiment, an embodiment of the present disclosure is also applicable to a case in which three or more positions of the sheet bundle Pb spaced apart from each other in the main scanning direction are crimped and bound. In such cases, the controller 100b causes the liquid applier 31 to apply the liquid to three or more liquid application positions (corresponding to the crimp binding positions) and causes the crimper 32 to perform crimping. According to an embodiment of the present disclosure, the productivity of crimping can be enhanced even when three or more positions are crimped and bound.

However, liquid application may not need to be performed to all the liquid application positions corresponding to the crimp binding positions of all the sheets P of the sheet bundle Pb. For example, when crimping is performed on three liquid application positions (corresponding to crimping (binding) positions) apart from each other in the main scanning direction, the controller 100b may cause the liquid applier 31 to apply the liquid to three liquid application positions (corresponding to crimping (binding) positions) of an E-th sheet P1 (E<N−2), apply the liquid to two liquid application positions (corresponding to crimping (binding) positions) of an (E+1)-th sheet P2, and apply the liquid to one liquid application position (corresponding to a crimping (binding) position) of an (E+2)-th sheet P2.

### Configurations of Liquid Applier 31 and Second Liquid Storage Tank 47

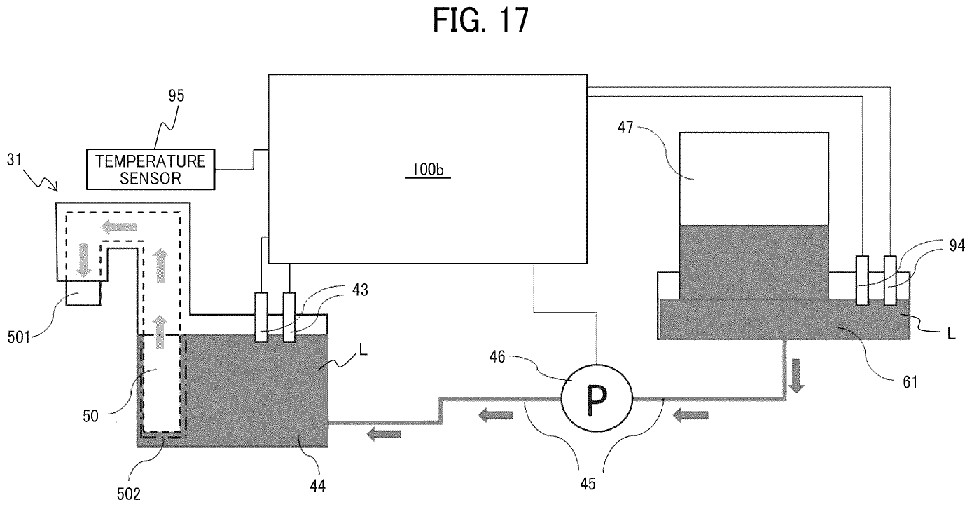

FIG. 17 is a diagram illustrating a relation of the liquid applier 31 and the second liquid storage tank 47 according to the present disclosure.

The liquid applier 31 includes the liquid supply member 50 that includes the liquid application member 501 and the liquid immersion portion 502, the first liquid storage tank 44, and the first liquid level sensor 43 that detects the liquid level of the liquid L in the first liquid storage tank 44. The liquid applier 31 further includes the second liquid storage tank 47 that stores liquid to be supplied to the first liquid storage tank 44. The second liquid storage tank 47 includes the second liquid level sensor 94 that detects the liquid level of the liquid L in the second liquid storage tank 47. The first liquid storage tank 44 and the second liquid storage tank 47 are coupled to each other via the liquid conveyance path 45. Further, the liquid conveyance path 45 includes the liquid supply pump 46. The liquid L is supplied between the first liquid storage tank 44 and the second liquid storage tank 47 via the liquid conveyance path 45 by the operation of the liquid supply pump 46. The controller 100b is connected to the first liquid level sensor 43, the second liquid level sensor 94, the temperature sensor 95, and the liquid supply pump 46. The controller 100b controls the operation of the liquid supply pump 46 based on the detection results of the first liquid level sensor 43, the second liquid level sensor 94, and the temperature sensor 95.

The liquid supply member 50 includes the liquid immersion portion 502 on one end and the liquid application member 501 on another end. The liquid immersion portion 502 is immersed in the liquid stored in the first liquid storage tank 44. The liquid application member 501 contacts the sheet P or the sheet bundle Pb to apply liquid on the sheet P or the sheet bundle Pb. The liquid supply member 50 incudes a liquid absorber.

The second liquid storage tank 47 stores liquid to be supplied to the first liquid storage tank 44. The liquid stored in the second liquid storage tank 47 is supplied to the first liquid storage tank 44 through the liquid conveyance path 45 by the operation of the liquid supply pump 46.

The first liquid storage tank 44 includes the first liquid level sensor 43 to detect the liquid level of the liquid in the first liquid storage tank 44. The first liquid level sensor 43 is an electrode sensor having a pair of electrodes.

The output value, in other words, the detection voltage of the first liquid level sensor 43, that is output when the first liquid level sensor 43 detects the liquid (liquid level) in the first liquid storage tank 44 is input to the controller 100b as a control device. The controller 100b determines whether there is any liquid in the first liquid storage tank 44 based on whether the output value, which is input from the first liquid level sensor 43, exceeds the “liquid detection threshold value” (threshold value). When the controller 100b determines that liquid needs to be replenished to the first liquid storage tank 44, the controller 100b operates the liquid supply pump 46 to supply the liquid from the second liquid storage tank 47 to the first liquid storage tank 44.

The controller 100b controls the timing of application of the voltage to the electrodes of the first liquid level sensor 43. The controller 100b also controls the operation of the liquid supply pump 46 in accordance with the output value of the first liquid level sensor 43. Further, when the first liquid level sensor 43 detects the liquid level of the liquid in the first liquid storage tank 44, the controller 100b stops the operation of the liquid supply pump 46, and also stops application of the voltage to the first liquid level sensor 43.

The controller 100b measures the elapsed time after the operation of the liquid supply pump 46 is stopped. When the elapsed time exceeds a first predetermined time, the controller 100b energizes (i.e., applies a voltage to) the electrodes of the first liquid level sensor 43 and performs the detection process of detecting the liquid (liquid level) in the first liquid storage tank 44 to the first liquid level sensor 43 again.

It takes time for the liquid stored in the first liquid storage tank 44 to be drawn up by the capillary phenomenon of the liquid supply member 50 and sent from the liquid immersion portion 502 to the liquid application member 501 through the liquid supply member 50. For this reason, the controller 100b detects the liquid (liquid level) in the first liquid storage tank 44 to the first liquid level sensor 43 again after waiting for the predetermined time to elapse as described above. At this stage, the liquid level (stored liquid amount) of liquid in the first liquid storage tank 44 decreases due to the drawing-up of the liquid in the first liquid storage tank 44 by the liquid supply member 50. When the first liquid level sensor 43 does not detect the liquid level of the liquid in the first liquid storage tank 44, the controller 100b operates the liquid supply pump 46 again to supply the liquid in the second liquid storage tank 47 to the first liquid storage tank 44.

The second liquid storage tank 47 is provided with the second liquid level sensor 94. The second liquid level sensor 94 is also an electrode sensor including a pair of electrodes, similarly to the first liquid level sensor 43. When liquid contacts the electrodes, the controller 100B determines the variation of the output value caused by the voltage applied between the electrodes, thus allowing detection of the presence or absence of the liquid in the second liquid storage tank fixer 61.

Further, the second liquid storage tank 47 is also provided with the second liquid level sensor 94, so that this configuration works for the following cases. The liquid applier 31 according to the present embodiment is more effective, for example, when the first liquid level sensor 43 disposed in the first liquid storage tank 44 cannot detect whether the liquid is in the first liquid storage tank 44 because the type of the liquid in the second liquid storage tank 47 is different from the type of the liquid in the first liquid storage tank 44. A detailed description is now given below.

As illustrated in FIG. 9, as described above, when the second liquid storage tank 47 is removed from the post-processing apparatus 3 and the second liquid storage tank 47 is replenished with liquid L, the type (property) of the replenished liquid L may be changed. For example, the liquid in the second liquid storage tank 47 and the second liquid storage tank fixer 61 may be changed from the liquid La illustrated in FIG. 21 to the liquid Lb. In this case, the liquid detection threshold value of the first liquid level sensor 43 is set to the “liquid detection threshold value for the liquid La” illustrated in FIG. 21. For this reason, first, the controller 100b turns on the power of the second liquid level sensor 94 when the second liquid storage tank 47 is mounted. At this time, the output value (voltage) of the second liquid level sensor 94 is a value (e.g., output voltage V3) indicating a state where the liquid Lb in the second liquid storage tank 47 is detected.

Then, the controller 100b changes the liquid detection threshold value of the first liquid level sensor 43 from the “liquid detection threshold value for the liquid La” illustrated in FIG. 21 to the “liquid detection threshold value for the liquid Lb” based on the output value (e.g., the output value V3) of the second liquid level sensor 94. In this case, the controller 100b determines the output value of the first liquid level sensor 43 using the newly set liquid detection threshold value, in other words, “liquid detection threshold value for the liquid Lb”, to determine whether there is any liquid in the first liquid storage tank 44, in other words, determine the amount of liquid stored in the first liquid storage tank 44. In the above case, the method of changing the liquid detection threshold value of the first liquid level sensor 43 can be described by replacing the vertical axis V with the “output value of the second liquid level sensor 94” in the description of FIG. 21 described later, and thus the detailed description is omitted.

When there is another possibility that the type of the liquid used for liquid application, in other words, the property of the liquid, has changed, the liquid detection threshold value described above may be positively reviewed. For example, a case is assumed in which the property of the liquid is changed due to a change in the ambient temperature of the first liquid storage tank 44, the second liquid storage tank 47, or both. In this case, a temperature sensor 95 as a temperature detector or sensor is provided to detect the ambient temperature of the first liquid storage tank 44, the second liquid storage tank 47, or both, as illustrated in FIG. 17. Then, the liquid detection threshold value may be reviewed in a case where the fluctuation range of the ambient temperature detected by the temperature sensor 95 and the ambient temperature at the present point exceed a given fluctuation range when the liquid supplying operation was previously performed. The given fluctuation range is, for example, ±10° C.

The output values of the first liquid level sensor 43 and the second liquid level sensor 94 correspond to electrical signals that change according to the amount of contact of the electrodes with the liquid in the first liquid storage tank 44 and the second liquid storage tank 47. Examples of the electrical signal include, but not limited to, a signal indicating an electrical resistance value, a signal indicating a voltage value, and a signal indicating a current value. In other words, the “electrical signal” may be any signal indicating an electrical value that changes when a current passes between the electrodes, in other words, when a voltage is applied, depending on whether the pair of electrodes of the electrode sensor is immersed in the liquid.

In the present embodiment, the electrode sensor has been described as an example of the first liquid level sensor 43 and the second liquid level sensor 94. However, the first liquid detector or sensor and the second liquid detector or sensor are not limited to the electrode sensors and may be other types of sensors. For example, a float sensor or a capacitance sensor may be used to detect the presence or absence of the liquid. Further, the first liquid level sensor 43 and the second liquid level sensor 94 are not limited to a sensor that detects the liquid level of the liquid in the first liquid storage tank 44 and the second liquid storage tank 47, and may be any sensor that can detect the amount of liquid stored in the first liquid storage tank 44 and the second liquid storage tank 47.

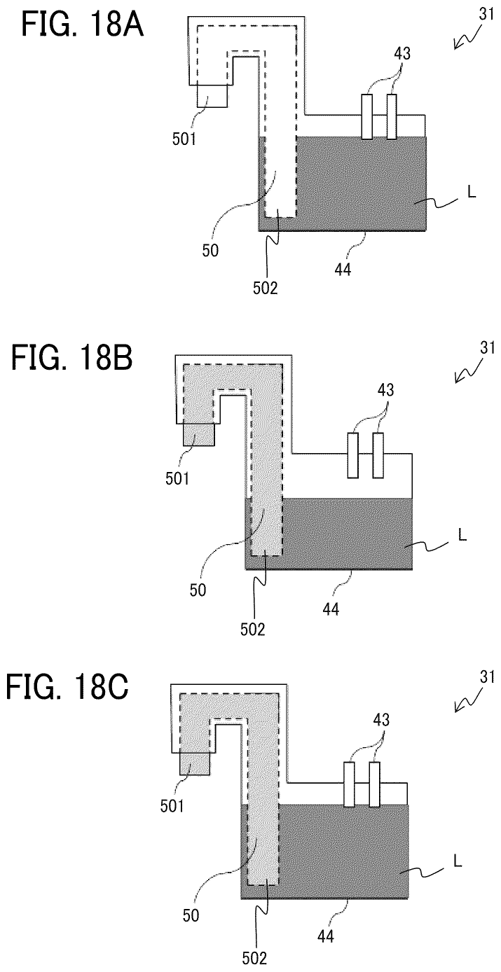

FIGS. 18A, 18B and 18C are diagrams illustrating a change in the level of liquid in the first liquid storage tank 44 when the liquid supply member 50 is dry.

A change of liquid in the first liquid storage tank 44 is referred to as a “change in liquid level” below.

First, as illustrated in FIG. 18A, liquid is supplied from the second liquid storage tank 47 to the first liquid storage tank 44, and the first liquid level sensor 43 is set to detect the liquid level in the first liquid storage tank 44. At this time, the liquid supply member 50 including the liquid immersion portion 502 is dry. The liquid level in the first liquid storage tank 44 at the time when the first liquid level sensor 43 detects the liquid in the first liquid storage tank 44, in other words, the amount of liquid stored in the first liquid storage tank 44 is referred to as a “reference liquid level”.

Then, as illustrated in FIG. 18B, the liquid is drawn up from the liquid immersion portion 502 by the capillary phenomenon, and the liquid supply member 50 is moistened with the drawn liquid. At this time, the liquid level of the liquid stored in the first liquid storage tank 44 is lowered from the reference liquid level. At the stage when the liquid level is lowered, in other words, at the stage when the liquid supply member 50 is moistened by drawing the liquid, the controller 100b determines the output value from the first liquid level sensor 43 again. At this stage, when the controller 100b determines that the amount (liquid level) of liquid stored in the first liquid storage tank 44 is less than the reference liquid level, the controller 100b operates the liquid supply pump 46 to supply the liquid from the second liquid storage tank 47 to the first liquid storage tank 44 again.

In a case where an electrode sensor is used as the first liquid level sensor 43, there is a concern that the metal used for the electrodes might be corroded due to electrolytic corrosion if the pair of electrodes is energized (applied with electricity) constantly. Further, since the voltage is always applied to the liquid stored in the first liquid storage tank 44, there is a concern that the liquid might be electrolyzed or that the electrodes might be dissolved due to adhesion of foreign matter to the surface of the electrodes by electrolysis, which might induce deterioration of the electrodes. For this reason, the controller 100b controls the timing of power on of the first liquid level sensor 43 such that the power of the first liquid level sensor 43 is not turned on all the time but is turned on (power ON) only when the first liquid level sensor 43 detects the liquid level of liquid stored in the first liquid storage tank 44.

### Control Flow of Liquid Supplying Operation

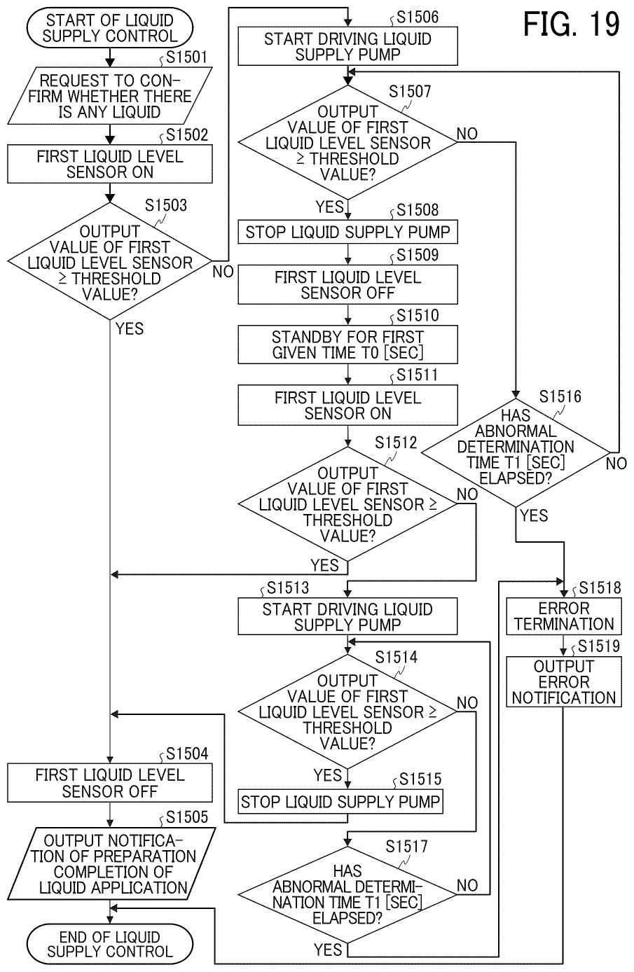

FIG. 19 is a flowchart of control flow of the liquid supplying operation controlled by the controller 100b.

This control flow is referred to as a “liquid supply control flow” below. The liquid supplying operation according to the present embodiment is executed at the time of activation of the post-processing apparatus 3 or at the time of start of the crimp binding process with liquid application (referred to as “liquid application and crimp binding operation” in the following description).

For example, when the post-processing apparatus 3 is activated, the liquid supply control flow is started. When the liquid supply control flow is started, in step S1501, a liquid presence check request is instructed to the controller 100b. The liquid presence check request may be instructed based on information input by the user from the control panel 110 of one or both of the image forming apparatus 2 and the post-processing apparatus 3. In response to receipt of the liquid presence check request instructed from the image forming apparatus 2, in step S1502, the controller 100b applies a voltage to the first liquid level sensor 43, in other words, turns on the power of the first liquid level sensor 43.

Subsequently, in step S1503, the controller 100b acquires an output value (voltage) that is output when the first liquid level sensor 43 detects the liquid in the first liquid storage tank 44, in other words, the detection voltage of the first liquid level sensor 43, and determines the liquid level of the liquid L in the first liquid storage tank 44, in other words, the stored liquid amount of the liquid in the first liquid storage tank 44. The determination of the stored liquid amount of liquid in the first liquid storage tank 44 is performed based on whether the output value output from the first liquid level sensor 43 exceeds a “liquid detection threshold value” that is a threshold value set in advance. For example, when the output value from the first liquid level sensor 43 is equal to or greater than the liquid detection threshold value (e.g., output voltage VTh1), the controller 100b determines that the stored liquid amount of liquid L stored in the first liquid storage tank 44 is a sufficient amount (YES in step S1503). In this case, the controller 100b stops the application of the voltage to the first liquid level sensor 43 (turns the energization of the first liquid level sensor 43 off) in step S1504, displays a completion notice of the preparation for liquid application on, for example, the control panel 110 in step S1505, and ends the liquid supply control flow.

On the other hand, when the output value from the first liquid level sensor 43 is less than the liquid detection threshold value (e.g., the output voltage VTh1) in step S1503 (NO in step S1503), the controller 100b operates the liquid supply pump 46 to execute the supply of the liquid L from the second liquid storage tank 47 to the first liquid storage tank 44 in step S1506.

Subsequently, in step S1507, the controller 100b determines whether the output value from the first liquid level sensor 43 is equal to or greater than the liquid detection threshold value set in advance. When the output value from the first liquid level sensor 43 is equal to or greater than the liquid detection threshold value (e.g., the output voltage VTh1), the controller 100b determines that a sufficient amount of liquid L has been supplied from the second liquid storage tank 47 into the first liquid storage tank 44 by the liquid supply pump 46 (YES in step S1507). On the other hand, when the output value from the first liquid level sensor 43 is less than the liquid detection threshold value (e.g., the output voltage VTh1) (NO in step S1507), in step S1516, the controller 100b determines whether an elapsed time from the start (step S1506) of the operation of the liquid supply pump 46 has exceeded the abnormality determination time (T1 (sec.)). When the elapsed time has not reached the abnormality determination time T1 (NO in step S1516), the controller 100b continues the supply of the liquid L from the second liquid storage tank 47 to the first liquid storage tank 44 by the liquid supply pump 46 until the output value (voltage) from the first liquid level sensor 43 becomes equal to or greater than the liquid detection threshold value (e.g., output value V1) (YES in step S1507).

On the other hand, when the elapsed time has reached the abnormality determination time T1 (YES in step S1516), in step S1518, the controller 100b determines that some abnormality (such as a failure of the liquid supply pump 46, the first liquid level sensor 43, or both) has occurred in a device, and executes an error stop process of stopping the liquid supply pump 46, turning off the energization of the first liquid level sensor 43, or both. In step S1519, the controller 100b causes the control panel 110 to display an abnormality notification, and ends the liquid supply control flow.

When the output value from the first liquid level sensor 43 becomes equal to or greater than the liquid detection threshold value (e.g., output value VTh1) in step S1507 (YES in step S1507), in step S1508, the controller 100b stops the liquid supply pump 46 and stops the supply of liquid L from the second liquid storage tank 47 to the first liquid storage tank 44. In step S1509, the controller 100b stops the application of voltage to the first liquid level sensor 43, in other words, turns off the energization of the first liquid level sensor 43.

Then, in step S1510, the liquid supply control flow is temporarily stopped until a standby time (first predetermined time TO (sec.)) elapses. The standby time is set in advance as a time taken until liquid L in the first liquid storage tank 44 is drawn up by, e.g., capillary phenomenon and the liquid supply member 50 turns to an executable state for liquid application, in other words, a state where the liquid Lis sufficiently stored in at least one of the liquid application member 501 and the liquid supply member 50.

After the first predetermined time TO has elapsed, the controller 100b turns on the power of the first liquid level sensor 43 again (in step S1511), acquires an output value that is output when the first liquid level sensor 43 detects the liquid L in the first liquid storage tank 44, and determines the stored liquid amount of liquid L in the first liquid storage tank 44 (in step S1512). At this stage, the liquid level (liquid storage amount) of the liquid L in the first liquid storage tank 44 is lowered by the suction of the liquid supply member 50. However, if the output value from the first liquid level sensor 43 is equal to or greater than the liquid detection threshold value (e.g., the output voltage VTh1) (YES in step S1512), the controller 100b stops the application of the voltage to the first liquid level sensor 43 (i.e., turns the first liquid level sensor 43 off) (step S1504). In step S1505, the controller 100b displays a completion notice of the preparation for liquid application on, for example, the control panel 110, and ends the liquid supply control flow.

On the other hand, when the output value from the first liquid level sensor 43 is less than the liquid detection threshold value (e.g., the output value VTh1) in step S1512 (NO in step S1512), the controller 100b operates the liquid supply pump 46 to the supply of the liquid L from the second liquid storage tank 47 to the first liquid storage tank 44 (step S1513).

Subsequently, the controller 100b acquires an output value that is output when the first liquid level sensor 43 detects liquid L in the first liquid storage tank 44, and determines the stored liquid amount of liquid L in the first liquid storage tank 44 (step S1514) Subsequently, when the output value from the first liquid level sensor 43 is equal to or greater than the liquid detection threshold value (e.g., the output value VTh1) (YES in step S1514), the controller 100b determines that a sufficient amount of liquid L has been supplied into the first liquid storage tank 44. In this case, the controller 100b stops the liquid supply pump 46 to stop the supply of liquid L from the second liquid storage tank 47 to the first liquid storage tank 44 (step S1515). Then, the controller 100b stops the application of the voltage to the first liquid level sensor 43 (i.e., turns the energization of the first liquid level sensor 43 off) in step S1504, displays a completion notice of the preparation for liquid application on, for example, the control panel 110 in step S1505, and ends the liquid supply control flow.

On the other hand, when the output value from the first liquid level sensor 43 is less than the liquid detection threshold value (e.g., the output voltage VTh1) (NO in step S1514), in step S1517, the controller 100b determines whether an elapsed time from the start (step S1513) of the operation of the liquid supply pump 46 has exceeded the abnormality determination time (T1 seconds). When the elapsed time has not reached the abnormality determination time T1 (NO in step S1517), the controller 100b continues the supply of the liquid L from the second liquid storage tank 47 to the first liquid storage tank 44 by the liquid supply pump 46 until the output value from the first liquid level sensor 43 becomes equal to or greater than the liquid detection threshold value (e.g., output voltage VTh1) (YES in step S1514).

On the other hand, when the elapsed time has reached the abnormality determination time T1 (YES in step S1514), in step S1518, the controller 100b determines that some kind of abnormality has occurred in the apparatus, and executes error stop process of stopping the liquid supply pump 46, turning off the energization of the first liquid level sensor 43, or both. In step S1519, the controller 100b causes the control panel 110 to display an abnormality notification, and ends the liquid supply control flow.

The “abnormality notification” may be, for example, a display of a warning on the control panel 110 to prompt a check because there is a possibility that one or both of the liquid supply pump 46 and the first liquid level sensor 43 are out of order.

As described above, the execution of the control flow of the liquid supplying operation according to the present embodiment can stably obtain a certain amount of liquid L in the liquid supply member 50, the liquid application member 501, or both, which enables liquid application by the liquid application member 501. As a result, the frequency of the liquid supply operation of the liquid L from the second liquid storage tank 47 to the first liquid storage tank 44 can be reduced, and the efficiency of the liquid application process can be enhanced.

A description is given below of the relation of the liquid supply control flow described in the flowchart of FIG. 19 and the change in the liquid level of the liquid L in the first liquid storage tank 44 described with reference to FIGS. 18A, 18B and 18C.

First, when the presence or absence of liquid L in the first liquid storage tank 44 is checked in the stage preceding to the state illustrated in FIG. 18A, the controller 100b determines that the first liquid storage tank 44 in the state of “no liquid” (NO in step S1503) and drives the liquid supply pump 46 to supply liquid L in the second liquid storage tank 47 to the first liquid storage tank 44 in step S1506. When the amount (liquid level) of the liquid L stored in the first liquid storage tank 44 reaches the state of FIG. 18A, the output value from the first liquid level sensor 43 becomes equal to or greater than the liquid detection threshold value (e.g., the output voltage VTh1) (YES in step S1507). The controller 100b stops the liquid supply pump 46 in step S1508 and turns off the energization of the first liquid level sensor 43 in step S1509.

Subsequently, when the first predetermined time TO, which is set in advance as the time taken until the liquid supply member 50 draws up liquid L as illustrated in FIG. 18B and turns to an executable state for liquid application by the liquid application member 501, has elapsed, in step S1511, the controller 100b turns on the power of the first liquid level sensor 43 again. At this stage, a given amount of liquid Lis drawn up by the liquid supply member 50 from the first liquid storage tank 44 to the liquid supply member 50. As a result, the amount of the liquid L stored in the first liquid storage tank 44 decreases and the liquid level of the liquid L in the first liquid storage tank 44 becomes lower than the reference liquid level. As a result, the output value from the first liquid level sensor 43 becomes less than the liquid detection threshold value (e.g., the output voltage VTh1) (NO in step S1512).

Then, the controller 100b causes the liquid supply pump 46 to operate again in step S1513 and supply of the liquid L in the second liquid storage tank 47 to the first liquid storage tank 44 until the output value from the first liquid level sensor 43 becomes equal to or greater than the liquid detection threshold value (e.g., the output voltage VTh1) (YES in step S1514). When the output value from the first liquid level sensor 43 becomes equal to or greater than the liquid detection threshold value (e.g., the output voltage VTh1), the controller 100b stops the liquid supply pump 46 in step S1515 and turns off the energization of the first liquid level sensor 43 in step S1504. As a result, as illustrated in FIG. 18C, the liquid L in the first liquid storage tank 44 is sufficiently stored in the entirety of at least one of the liquid supply member 50 or the liquid application member 501, and the controller 100b causes the control panel 110 to display the completion notice of the preparation for liquid application (step S1505).

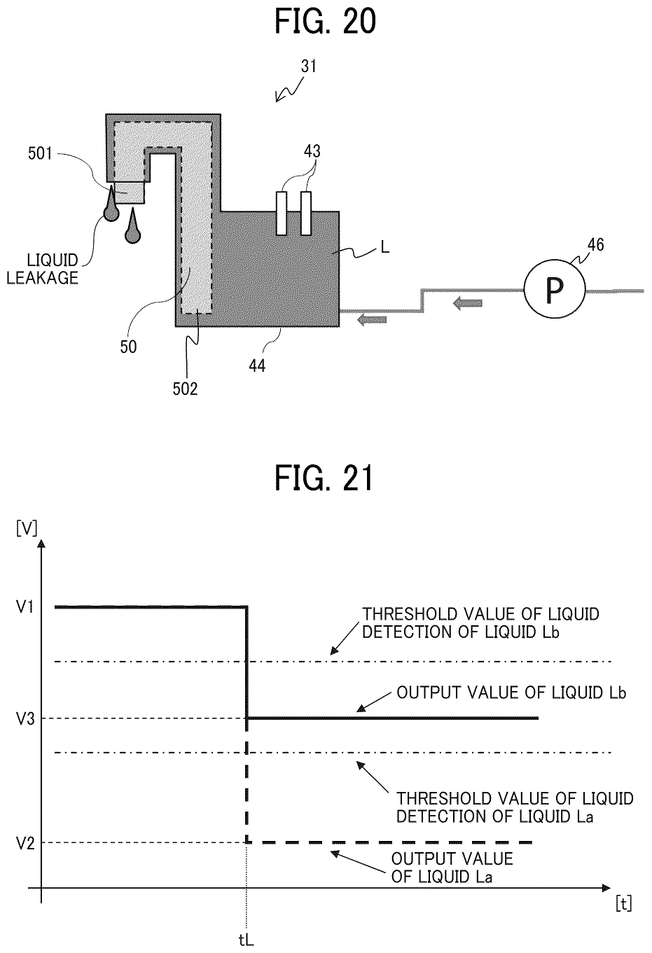

FIG. 20 is a diagram illustrating liquid leakage that might occur in the first liquid storage tank 44 of the liquid applier 31 according to the present disclosure.

The liquid applier 31 according to the present embodiment supplies liquid L to the second liquid storage tank 47. Accordingly, the properties (e.g., hardness, pH, chlorine content, and conductance) of the liquid L vary depending on the type of the liquid L supplied to the second liquid storage tank 47. In other words, when the stored liquid amount of liquid L stored in the first liquid storage tank 44 is determined based on the output value of the first liquid level sensor 43, it is assumed that a situation may arise in which it is difficult to accurately detect the stored liquid amount of liquid L stored in the first liquid storage tank 44 even if the determination is made with the liquid detection threshold value fixed at a specific value.

For example, it is assumed that the liquid L supplied into the first liquid storage tank 44 is a liquid having extremely low conductance (e.g., ultrapure water used in the industrial field). It is further assumed that the liquid detection threshold value set on the premise of tap water is used. In such a case, even when the liquid L in the first liquid storage tank 44 contacts the first liquid level sensor 43, the output value (output value of ultrapure water) at that time may not satisfy the condition for detecting the liquid level of the liquid L in the first liquid storage tank 44 in comparison with the liquid detection threshold value set on the premise of tap water. As a result, the supply of the liquid L to the first liquid storage tank 44 by the liquid supply pump 46 would not be stopped at an appropriate timing, and the first liquid storage tank 44 would entirely be filled with the liquid L, which may cause a failure such as a gap between the liquid supply member 50 and the first liquid storage tank 44 or liquid leakage from the tip of the liquid application member 501 as illustrated in FIG. 20.

For this reason, the liquid applier 31 according to the present embodiment varies the liquid detection threshold value used for determining the presence or absence of the liquid L in the first liquid level sensor 43 depending on the type of the liquid L. FIG. 21 is a graph of a relation of the change in the output value of the first liquid level sensor 43 and the liquid detection threshold value of the first liquid level sensor 43 in a time series. In FIG. 21, the horizontal axis t represents the elapsed time when the liquid supply pump 46 is operated to supply the liquid L in the second liquid storage tank 47 to the first liquid storage tank 44, and the vertical axis V represents the output value of the first liquid level sensor 43.

Before the pair of electrodes of the first liquid level sensor 43 comes into contact with the liquid L in the first liquid storage tank 44 (see FIG. 18B), air is detected with the first liquid level sensor 43. The output value of the first liquid level sensor 43 at this time is referred to as “V1.” If the liquid type is “La” having a predetermined conductance, the output value is assumed to change from “V1” to “V2” when the liquid La contacts the electrodes at the elapsed time tL. Then, in order to detect the liquid La with the first liquid level sensor 43, the controller 100b sets the liquid detection threshold value of the first liquid level sensor 43 between the output value V1 and the output value V2 as illustrated in FIG. 21.

The liquid detection threshold value of the first liquid level sensor 43 is preferably set to an intermediate value between the output value V1 and the output value V2 in consideration of, for example, variations and noise in the output value V1 and the output value V2.

In addition, in the case where the liquid type of the liquid Lis not “La” but “Lb” having a lower conductance than “La”, the output value is assumed to change from “V1” to “V3” when the liquid Lb comes into contact with the electrodes. The output value V3 is assumed to be greater than the output value V2 and smaller than the output value V1. In this case, when the liquid Lb comes into contact with the electrodes at the elapsed time tL, the output value changes from “V1” to “V3” and does not reach “V2.” In other words, even though the liquid detection threshold value of the first liquid level sensor 43, in other words, the liquid detection threshold value for the liquid La, is set to an intermediate value between the output value V1 and the output value V2 as illustrated in FIG. 21, the liquid level of the liquid Lb in the first liquid storage tank 44, in other words, the liquid storage amount of the liquid Lb in the first liquid storage tank 44, is not detected by the first liquid level sensor 43.

For this reason, in the case of the liquid Lb, the controller 100b sets the liquid detection threshold value of the first liquid level sensor 43 to an intermediate value between the output value V1 and the output value V3, not the intermediate value between the output value V1 and the output value V2 as illustrated in FIG. 21. In other words, the liquid detection threshold value of the first liquid level sensor 43 is changed depending on the type of the liquid L such that the first liquid level sensor 43 can accurately detect the liquid level of the liquid L in the first liquid storage tank 44.

### Drawing of Relation of Edge Binder and Second Liquid Storage

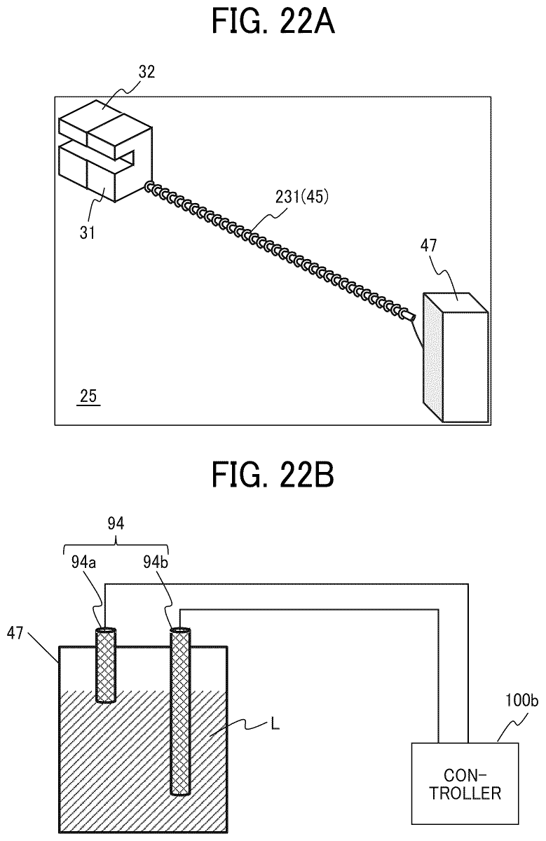

FIGS. 22A and 22B are diagrams illustrating a relation of the edge binder 25 and the second liquid storage tank 47 as a second liquid storage according to the present disclosure.

As described above with reference to FIGS. 11A, 11B, and 12 including FIG. 12 including the parts (A), (B) and (C), the post-processing apparatus 3 opens and closes the cover 71 when a liquid replenishing operation to replenish liquid L to the second liquid storage tank 47. The cover 71 corresponds to a part of the exterior of the post-processing apparatus 3. Opening the cover 71 of the edge binder 25 causes the user to be accessible to the edge binder 25 disposed in the post-processing apparatus 3.

As illustrated in FIG. 22A, the edge binder 25 includes a crimper 32, a liquid applier 31, a second liquid storage tank 47, a coil tube 231, and a liquid supply pump 46. The crimper 32 serves as at least one medium processing device. The liquid applier 31 is disposed in the vicinity of the crimper 32 to apply liquid at the sheet binding position of the sheet bundle Pb on which the sheet binding operation is performed by the crimper 32. The second liquid storage tank 47 stores the liquid to be supplied to the liquid applier 31. The coil tube 231 includes a liquid conveyance path 45 to convey the liquid L in the second liquid storage tank 47 to the first liquid storage tank 44 disposed in the liquid applier 31. The liquid supply pump 46 conveys the liquid L in the second liquid storage tank 47 to the first liquid storage tank 44. The configuration of the liquid conveyance path 45 is not limited to the coil tube 231. The material and structure of the member are not limited as long as the member can convey an appropriate amount of the liquid L from the second liquid storage tank 47 to the first liquid storage tank 44 disposed in the liquid applier 31 at an appropriate time. The first liquid storage tank 44 and the liquid supply pump 46 illustrated in FIG. 4 are omitted in FIG. 22A.

Further, the post-processing apparatus 3 includes the controller 100b. The controller 100b controls the operation of the edge binder 25. In other words, the controller 100b controls, for example, the processing operation of the crimper 32 and the liquid applier 31, and the liquid replenishing operation of the liquid L from the second liquid storage tank 47 to the liquid applier 31. The controller 100b also controls the remaining amount detection operation to detect the remaining amount of the liquid L stored in the second liquid storage tank 47.

Further, as illustrated in FIG. 22B, the second liquid storage tank 47 of the edge binder 25 stores the liquid L to be used for liquid application performed in the liquid applier 31. In the present embodiment, water is assumed to be an example of the liquid L. However, the liquid to be used for liquid application performed in the post-processing apparatus 3 according to the present embodiment is not limited to water. Further, the second liquid storage tank 47 is provided with the second liquid level sensor 94. The second liquid level sensor 94 includes a pair of a first electrode 94a and a second electrode 94b.

As illustrated in FIG. 22B, the second liquid level sensor 94 includes a pair of electrodes, which are the first electrode 94a and the second electrode 94b. When a voltage is applied to both the first electrode 94a and the second electrode 94b so as to generate a potential difference, a current flows between the first electrode 94a and the second electrode 94b in a case where both the first electrode 94a and the second electrode 94b are in contact with the liquid L in the second liquid storage tank 47, as illustrated in FIG. 22B. On the other hand, when either one of the first electrode 94a and the second electrode 94b is not in contact with the liquid L in the second liquid storage tank 47, no current flows between the first electrode 94a and the second electrode 94b. In other words, the change in the current value of the current flowing between the first electrode 94a and the second electrode 94b of the second liquid level sensor 94 can be detected by the controller 100b as a change in the detection voltage, in other words, a change in the output value of the second liquid level sensor 94. Accordingly, the controller 100b can detect the liquid level of the liquid L in the second liquid storage tank 47, in other words, the stored liquid amount of the liquid L in the second liquid storage tank 47, based on the output value of the second liquid level sensor 94.

As illustrated in FIG. 13, the controller 100b includes a hardware configuration included in an information processing apparatus such as the CPU 101, the RAM 102, and the ROM 103. The controller 100b executes a control program stored in the ROM 103 to control, for example, a liquid level detection process by the first liquid level sensor 43 and the second liquid level sensor 94, a liquid supplying operation by the liquid supply pump 46, and an opening and closing detection process of the cover 71 by the cover detection sensor 542. As described later, the controller 100b controls the intermittent application operation of the application voltage to the second liquid level sensor 94, and sets the start timing of the intermittent application of the application voltage based on the opening and closing detection process of the cover 71.

In the configuration illustrated in FIGS. 22A and 22B, when the power source to be applied to the first electrode 94a and the second electrode 94b (referred to as a “pair of electrodes”) is a direct current (DC) power source, there is a concern that a voltage rises due to the adhesion of electrolytes in the ionized liquid L, in other words, scales, to the pair of electrodes, and the liquid level of the liquid L in the second liquid storage tank 47, in other words, the remaining amount of the liquid L in the second liquid storage tank 47 is erroneously detected.

For example, when the application voltage for detecting the liquid level of the liquid L in the second liquid storage tank 47 is a DC voltage, the magnitude and the direction (polarity) of the current do not change. On the other hand, when the application voltage is an alternating current (AC) voltage, the magnitude and the direction (polarity) of the current changes periodically. When the DC voltage is used, the application is continued in the same direction and with the same magnitude, and thus the electrolysis of the liquid L proceeds and the electrolyte in the liquid Lis gradually ionized. If the AC voltage is used, since the magnitude and direction of the application voltage are periodically changed, the electrolytes in the liquid L are not ionized.

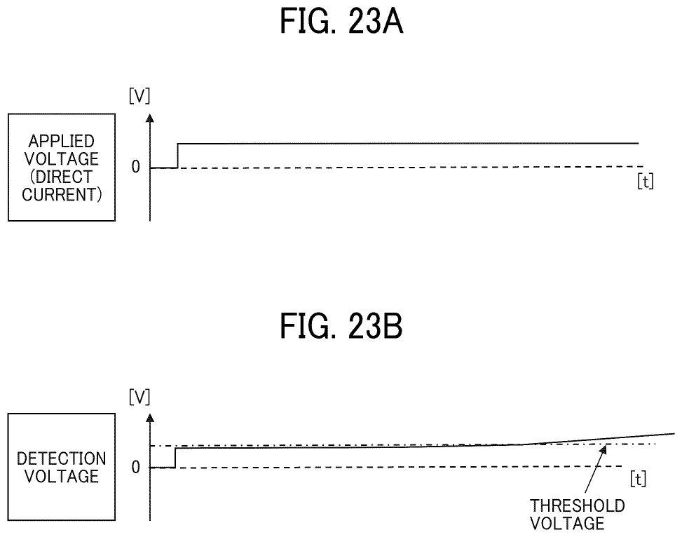

FIGS. 23A and 23B are diagrams illustrating the relation of the application voltage that is the DC voltage and the change with time in the detection voltage detected by the pair of electrodes of the second liquid level sensor 94.

As illustrated in FIG. 23A, when the application voltage is a DC voltage, the magnitude and polarity of the voltage do not change with time and are constant. As the DC voltage is continuously applied to the pair of electrodes, ionization of the electrolyte in the liquid L proceeds. As a result, as illustrated in FIG. 23B, the value of the detection voltage of the second liquid level sensor 94 is affected by the progress of ionization, and rises over time.

The second liquid level sensor 94 detects the stored liquid amount of the liquid L in the second liquid storage tank 47 by the comparison of the detection voltage and the threshold voltage. Accordingly, even in a case where the application voltage is constant and the stored liquid amount of the liquid L in the second liquid storage tank 47 does not change, when the applied voltage is a DC voltage, the detection voltage of the second liquid level sensor 94 exceeds the threshold voltage due to the influence of ionization of the electrolyte in the liquid L, and the stored liquid amount of the liquid L in the second liquid storage tank 47 is erroneously detected as the liquid amount corresponding to the detection voltage exceeding the threshold voltage. In other words, as the application voltage is a DC voltage and is continuously applied, the detection accuracy in the liquid level of the liquid L in the second liquid storage tank 47 may decrease by the change in the detection voltage value of the second liquid level sensor 94 with no relation with the liquid level of the liquid L in the second liquid storage tank 47.

In order to prevent the decrease in the detection accuracy of the liquid level of the liquid L in the second liquid storage tank 47 described above, the application voltage may be set to an AC voltage. In other words, an alternating current (AC) power supply may be used as an application voltage power supply for applying a voltage to the second liquid level sensor 94. However, when the power supply for detection is made to be an alternating current, there is an issue that the post-processing apparatus 3 becomes large and the manufacturing cost of the post-processing apparatus 3 increases.

### First Embodiment

In the post-processing apparatus 3 according to a first embodiment, in order to address the above-described inconvenience, the DC power supply is employed as the power supply used for detecting the liquid level of the liquid L in the second liquid storage tank 47, and the energization control of the second liquid level sensor 94 is performed so as to prevent the decrease in the detection accuracy due to the ionization of the electrolyte in the liquid L.

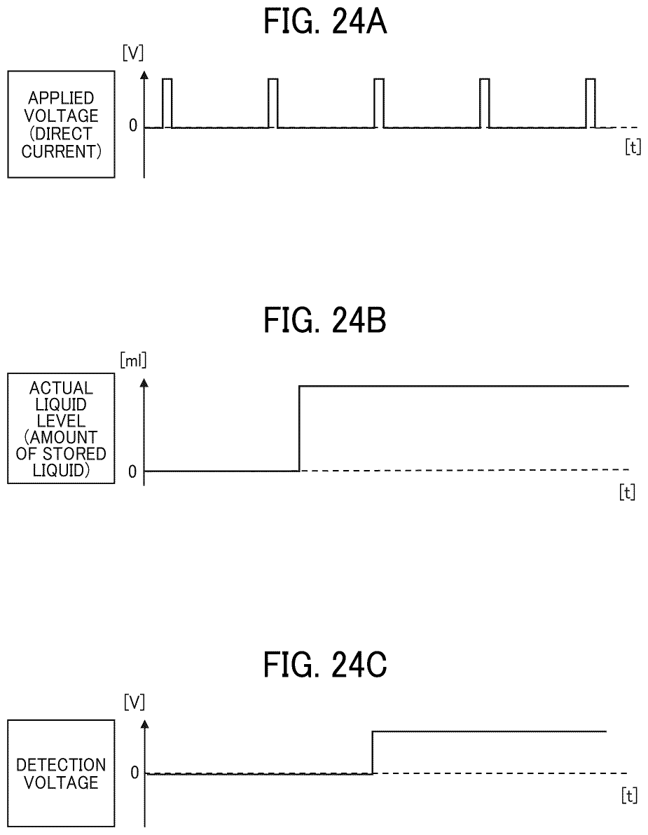

A description is given of an overview of the energization control according to the first embodiment, with reference to FIGS. 24A, 24B and 24C.

FIGS. 24A, 24B and 24C are diagrams illustrating detection of the liquid level of the liquid L in the liquid storage tank when the application voltage is a DC voltage, according to the first embodiment.

Specifically, FIG. 24A illustrates a pattern of the application voltage in a case where the intermittent application control is performed such that the duty of the application voltage to the pin electrodes (i.e., the first electrode 94a and the second electrode 94b) is equal to or less than a given ratio. The “duty” corresponds to a ratio (proportion) of a time duration of an “application state” that is a state where a DC voltage is applied to the pin electrodes (i.e., the first electrode 94a and the second electrode 94b) to a time duration of a “non-application state” that is a state where a DC voltage is not applied to the pin electrodes when the application state and the non-application state are repeated with time at a constant time duration.

FIG. 24B illustrates the change over time in the remaining amount of the liquid L in the second liquid storage tank 47.

FIG. 24C illustrates the detection state of the liquid L in the second liquid storage tank 47 by the second liquid level sensor 94 over time in the case where the voltage applied to the pin electrodes (i.e., the first electrode 94a and the second electrode 94b) is controlled to be intermittently applied as illustrated in FIG. 24A.

As illustrated in FIGS. 24A, 24B and 24C, the detection state of the liquid L in the second liquid storage tank 47 by the second liquid level sensor 94 when the voltage is applied results in the actual remaining amount of the liquid L in the second liquid storage tank 47. In other words, by performing the intermittent application control on the application voltage, the same effect as the AC power supply in a pseudo manner, in other words, the progress of ionization of the electrolyte in the liquid L can be prevented or reduced. Accordingly, erroneous detection of the second liquid level sensor 94 due to a voltage increase caused by ionization of the electrolyte in the liquid L can be prevented or reduced.

### Second Embodiment

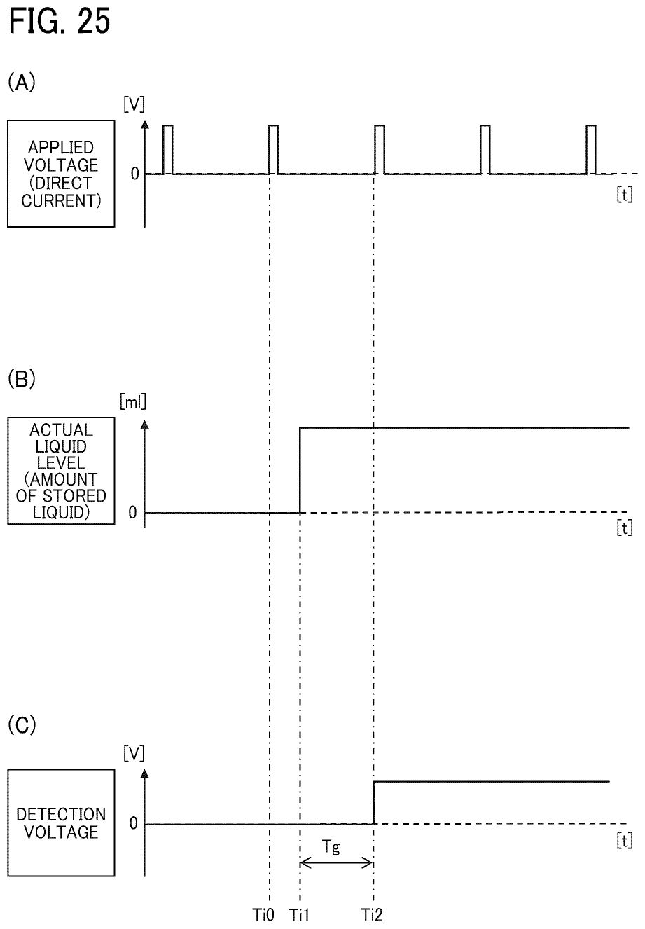

FIG. 25 including parts (A), (B) and (C) is a diagram illustrating an inconvenience of detection of the liquid level in the second liquid storage tank 47 when the DC voltage is applied to the pair of electrodes of the second liquid level sensor 94 that is described in FIGS. 24A, 24B and 24C.

In the first embodiment, as illustrated in FIG. 25, when the DC voltage is applied to perform the intermittent application control with the given duty, the application state changes, in other words, the second liquid level sensor 94 can detect the liquid level of the liquid Lin the second liquid storage tank 47 at a timing Ti0 at which the power of the second liquid level sensor 94 is turned on. Accordingly, in a case where the user replenishes the second liquid storage tank 47 with the liquid as described with reference to FIG. 12 including the parts (A), (B) and (C), for example, in the non-application state, i.e., in a state where the second liquid level sensor 94 is in the energization OFF state after the timing Ti0, the change in the liquid level of the liquid L in the second liquid storage tank 47 due to the liquid replenishing operation is detected by the second liquid level sensor 94 at a timing Ti2 when the subsequent application state is set. In other words, the second liquid level sensor 94 can detect a change in the liquid level of the liquid L in the second liquid storage tank 47 immediately after the timing Ti1, at the timing Ti2. In other words, by performing the intermittent application control on the application voltage, a time lag Tg is generated between a timing Ti1 at which the actual liquid level of the liquid L in the second liquid storage tank 47 changes and the timing Ti2 at which the change in the liquid level of the liquid L in the second liquid storage tank 47 is detected by the second liquid level sensor 94. As a result, there is an issue that the change in the liquid level of the liquid L in the second liquid storage tank 47 cannot be detected by the second liquid level sensor 94.

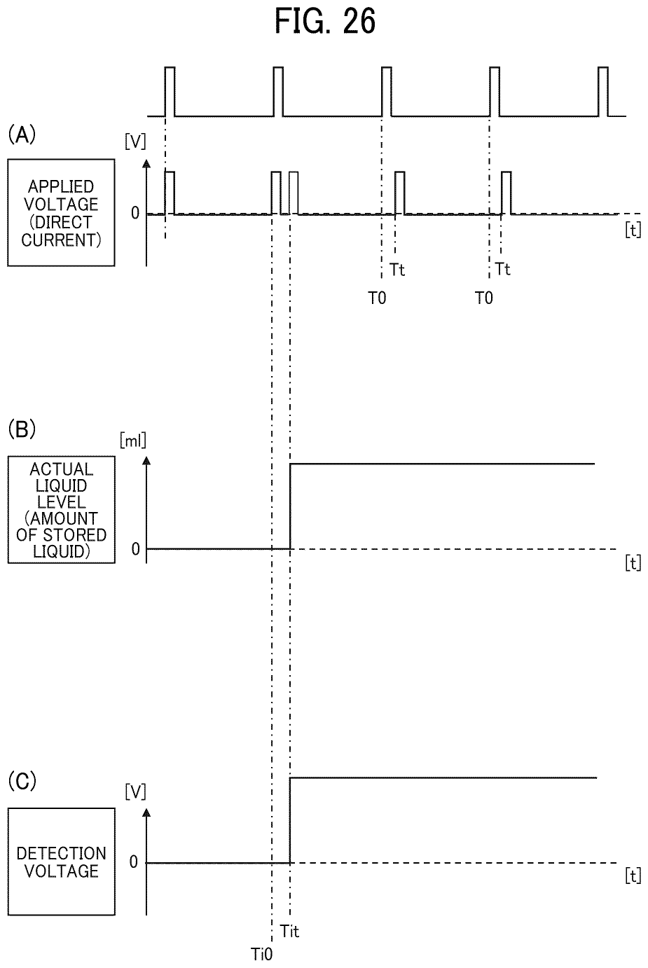

FIG. 26 including parts (A), (B) and (C) is a diagram illustrating the overview of the intermittent application control of an application voltage according to a second embodiment.

In order to deal with such an inconvenience, as illustrated in FIG. 26, the post-processing apparatus 3 according to the second embodiment applies the voltage at an application switching timing defined by the duty, in other words, at a timing Ti0 that is the timing of switching from the non-application state to the application state. Then, the time at which the operation that is performed in the liquid replenishing operation of the liquid L to the second liquid storage tank 47 occurs is detected, and this time is newly set as an application switching timing Tit. Then, as illustrated in the part (A) of FIG. 26, the intermittent application operation is started at the application switching timing defined by the duty from the application switching timing Tit. In other words, in the post-processing apparatus 3 according to the second embodiment, the application switching timing defined by the duty in the intermittent application control is changed from the timing Ti0 to the application switching timing Tit that is the timing at which the liquid level of the liquid L in the second liquid storage tank 47 changes, and the intermittent application control of switching the application state is executed at the application switching timing Tit after the change.

According to the intermittent application control according to the second embodiment, the timing at which the liquid level of the liquid L in the second liquid storage tank 47 actually changes (see the part (B) of FIG. 26) is the same as the application switching timing Tit of the voltage application to the pair of electrodes of the second liquid level sensor 94 (see the part (C) of FIG. 26). In other words, since the time lag Tg described in FIG. 25 is not generated, the actual liquid level of the liquid L in the second liquid storage tank 47 can be detected by the second liquid level sensor 94 at an appropriate time.

Further, an operation that occurs in the liquid replenishing operation of the liquid L to the second liquid storage tank 47 is, for example, an open-close operation of the cover 71 that is provided in the post-processing apparatus 3 and is to be opened and closed in order to access the second liquid storage tank 47. Specifically, the intermittent application operation is started at the application switching timing Tit when the cover 71 is changed from the opened state to the closed state, in other words, at the timing when the cover 71 is changed from the opened state to the closed state based on the detection result of the cover 71 by the cover detection sensor 542. By so doing, the liquid level of the liquid L in the second liquid storage tank 47 after the replenishment of the liquid L can be detected at an appropriate time.

### Process Flow of Intermittent Application Control

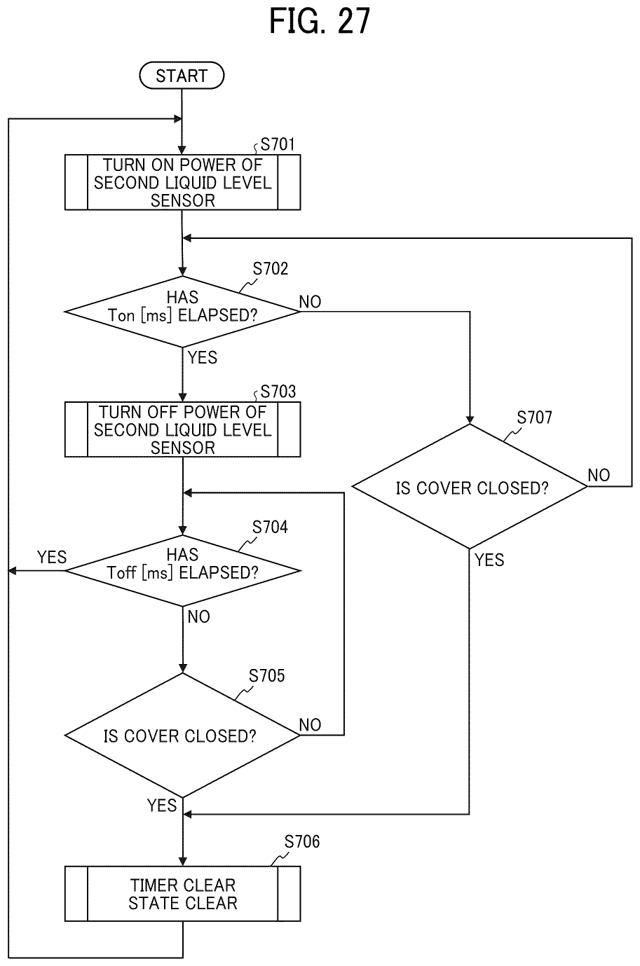

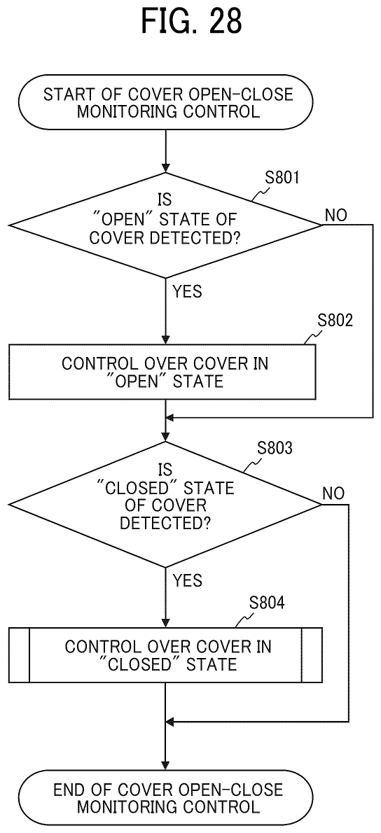

A description is given of the flow of the intermittent application control of an application voltage according to a second embodiment, with reference to FIGS. 27 and 28.

FIG. 27 is a flowchart of the intermittent application control according to the second embodiment.

FIG. 28 is a flowchart of a monitoring control process of the cover 71.

A description is given of the flow of the intermittent application control process, with reference to FIG. 27.

When the intermittent application control process starts, the controller 100b turns on the power of the second liquid level sensor 94 (step S701). Subsequently, the controller 100b determines whether the elapsed time from when the power of the second liquid level sensor 94 is turned on (referred to as an “elapsed time after the power on”) elapses the given time “Ton: (ms)” (step S702). In step S702, when the controller 100b determines that the elapsed time after the power on elapses the given time Ton (YES in step S702), the controller 100b turns off the power of the second liquid level sensor 94 (step S703).

Subsequently, the controller 100b determines whether the elapsed time from the second liquid level sensor 94 is turned off (referred to as an “elapsed time after the power off”) elapses the given time “Toff: (ms)” (step S704). In step S704, when the controller 100b determines that the elapsed time after the power off elapses the given time Toff (YES in step S704), the process returns to step S701, and the controller 100b turns on the power of the second liquid level sensor 94.

On the other hand, in step S704, when the elapsed time after the power off does not elapse the given time Toff (NO in step S704), the controller 100b determines whether the cover 71 is closed (closed state) based on the detection result of the cover detection sensor 542 (step S705). In step S705, when the controller 100b determines that the cover 71 is not closed, in other words, the cover 71 is open (NO in step S705), the process returns to step S704. On the other hand, in step S705, when the controller 100b determines that the cover 71 is closed (YES in step S705), the controller 100b initializes the timer process and the internal state (the time is cleared and the internal state is cleared) (step S706), the process returns to step S701, and sets the second liquid level sensor 94 to the power on state.

Further, in step S702, when the controller 100b determines that the elapsed time after the power on does not elapse the given time Ton (NO in step S702), the controller 100b determines whether the cover 71 is closed (closed state) based on the detection result of the cover detection sensor 542 (step S707). In step S707, when the controller 100b determines that the cover 71 is not closed, in other words, the cover 71 is open (NO in step S707), the process returns to step S702. On the other hand, in step S707, when the controller 100b determines that the cover 71 is closed (YES in step S707), the controller 100b initializes the timer process and the internal state (the time is cleared and the internal state is cleared) (step S706), the process returns to step S701, and sets the second liquid level sensor 94 to the power on state. In other words, the intermittent application control with the given duty is executed by repeatedly executing the processes from step S701 to step S707.

A description is given below of the cover open-close monitoring control process, with reference to FIG. 28.

As the cover open-close monitoring control is started, the controller 100b determines whether the cover 71 is open (open state) by the cover detection sensor 542 (step S801). In step S801, when the controller 100b determines that the cover 71 is open (open state) (YES in step S801), the controller 100b executes the open cover control (step S802). At this time, the controller 100b outputs the instruction to the cover detection sensor 542 to issue an event indicating that the cover 71 to be used for determination in steps S705 and 707 is open (open state). On the other hand, in step S801, when the controller 100b determines that the cover 71 is not open (NO in step S801), the controller 100b does not execute the cover open control of step S802, and the process proceeds to step S803.

Subsequently, the controller 100b determines whether the cover 71 is closed (closed state) by the cover detection sensor 542 (step S803). In step S803, when the controller 100b determines that the cover 71 is closed (YES in step S803), the controller 100b executes the closed cover control (step S804). At this time, the controller 100b outputs the instruction to the cover detection sensor 542 to issue an event indicating that the cover 71 to be used for determination in steps S705 and 707 is closed (closed state). On the other hand, in step S803, when the controller 100b determines that the cover 71 is not closed (NO in step S803), the controller 100b does not execute the closed cover control of step S804, and the cover open-close monitoring control ends.

The cover open-close monitoring control process is repeatedly executed at given time intervals. In the intermittent application control process, the opening and closing events of the cover 71 provided by the cover detection sensor 542 not at a timing at which the application state and the non-application state are switched but at the timing at which the application state and the non-application state are continued is referred to. When there is an operation of switching the cover 71 from the open state to the closed state, the timer of the duty is temporarily reset, and the power of the second liquid level sensor 94 is newly turned on. By so doing, the detection of the liquid level by the second liquid level sensor 94 can be performed at an appropriate time at the timing at which the liquid level of the liquid L in the second liquid storage tank 47, and the liquid level of the liquid L in the second liquid storage tank 47, i.e., the detection accuracy of the remaining amount of the liquid L in the second liquid storage tank 47, can be enhanced.

### Third Embodiment

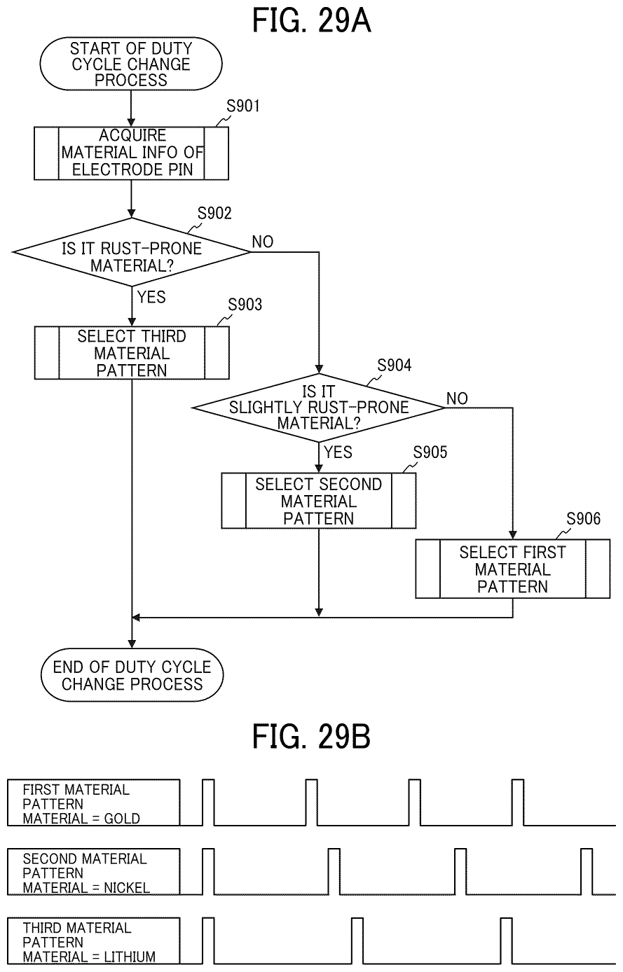

A description is given of an example of the process of changing the intermittent application control pattern of the application voltage, with reference to FIGS. 29A and 29B.

FIG. 29A is a flowchart of the flow of an intermittent application control pattern change process, in other words, the duty change process, according to a third embodiment.

It is known that the trends of ionization of the electrolyte in the liquid L are different according to the material of the electrode pins of the second liquid level sensor 94, i.e., the pair of electrodes of the second liquid level sensor 94.

For this reason, the duty can be selected to be optimal according to the material of the electrode pin of the second liquid level sensor 94. The setting of the material information of the electrode pins is stored in a memory of the controller 100b. Alternatively, the material of the electrode pins may be set to any value by the user through the control panel 110. Further, the information of the duty pattern corresponding to the set materials of the electrode pins is also stored in the memory of the controller 100b.

When the duty change process is started, the controller 100b first acquires the material information of the electrode pins (step S901). Subsequently, the controller 100b determines whether the material of the electrical pins to be determined based on the materials information of the electrical pins is “rust-prone material” (step S902). In step S902, when the controller 100b determines that the material of the electrical pins is “rust-prone material” (YES in step S902), the controller 100b selects the duty including the third material pattern (step S903). Then, the controller 100b sets a “given time Ton” that is a determination condition in step S702 of FIG. 27 and a “given time Toff” that is a determination condition in step S704.

In step S902, the controller 100b determines that the material of the electrical pins is not “rust-prone material” (NO in step S902), the controller 100b then determines whether the material of the electrical pins is “slightly rust-prone material” (step S904). In step S904, when the controller 100b determines that the material of the electrical pins is “slightly rust-prone material” (YES in step S904), the controller 100b selects the duty including the second material pattern (step S905). Then, the controller 100b sets a “given time Ton” that is a determination condition in step S702 of FIG. 27 and a “given time Toff” that is a determination condition in step S704.

In step S904, when the controller 100b determines that the material of the electrical pins is not “slightly rust-prone material” (NO in step S904), the controller 100b selects the duty including the first material pattern (step S906). Then, the controller 100b sets a “given time Ton” that is a determination condition in step S702 of FIG. 27 and a “given time Toff” that is a determination condition in step S704.

FIG. 29B is a diagram illustrating an example of images of the duty corresponding to the first material pattern, the second material pattern, and the third material pattern.

As illustrated in FIG. 29B, the duty of the first material pattern, i.e., the duty of the “rust-resistant material” is set as an initial value. In the third embodiment, the “rust-resistant material” is, for example, gold. The duty of the second material pattern, i.e., the “slightly rusty material” is set to be slightly lower than the duty of the first material pattern. In the third embodiment, the “slightly rust-prone material” corresponds to, for example, nickel. Further, the duty of the third material pattern, i.e., the duty of the “rust-prone material” is set to be lower than the duty of the first material pattern. In the third embodiment, the “rust-prone material” corresponds to, for example, lithium.

In the third embodiment, gold, nickel, and lithium are described as examples of the “material of the electrode pins”. However, the material of the electrode pins is not limited to the above-described examples and may be other types of metals such as zinc and iron. In this case, an appropriate duty corresponding to the other metals employed may be defined in advance and stored in the memory of the controller 100b.

### Fourth Embodiment

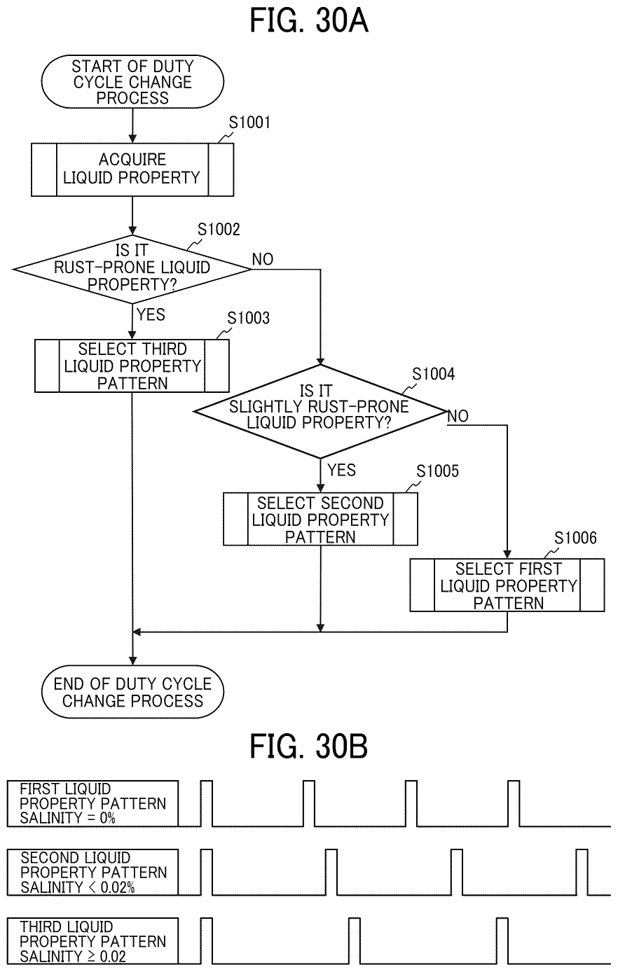

A description is given of another example of the process of changing the intermittent application control pattern of the application voltage, with reference to FIGS. 30A and 30B.

FIG. 30A is a flowchart of the flow of an intermittent application control pattern change process, in other words, the duty change process, according to a fourth embodiment.

It is known that the trends of ionization of the electrolyte in the liquid L are different according to the property (liquid property) of the liquid L in which the electrode pins (i.e., the first electrode 94a and the second electrode 94b) of the second liquid level sensor 94 are immersed. In the fourth embodiment, the “liquid property of the liquid L” is exemplified by the salt concentration of the liquid L stored in the second liquid storage tank 47.

For this reason, the duty can be selected to be optimal according to the salt concentration of the liquid L. Further, the correlation of the salt concentration of the liquid L and the pattern information of the duty is stored in the memory of the controller 100b. Alternatively, the salt concentration of the liquid L may be set to any value by the user through the control panel 110.

When the duty change process is started, the controller 100b first acquires the liquid property of the liquid L (step S1001). Subsequently, the controller 100b determines whether the liquid property of the liquid L is the “rust-prone liquid property” (step S1002). In step S1002, when the controller 100b determines that the liquid property of the liquid L is the “rust-prone liquid property” (YES in step S1002), the controller 100b selects the duty including the third liquid property pattern (step S1003). Then, the controller 100b sets a “given time Ton” that is a determination condition in step S702 of FIG. 27 and a “given time Toff” that is a determination condition in step S704.

In step S1002, the controller 100b determines that the liquid property of the liquid L is not “rust-prone liquid property” (NO in step S1002), the controller 100b then determines whether the liquid property of the liquid Lis “slightly rust-prone liquid property” (step S1004). In step S1004, when the controller 100b determines that the liquid property of the liquid Lis the “slightly rust-prone liquid property” (YES in step S1004), the controller 100b selects the duty including the second liquid property pattern (step S1005). Then, the controller 100b sets a “given time Ton” that is a determination condition in step S702 of FIG. 27 and a “given time Toff” that is a determination condition in step S704.

In step S1004, when the controller 100b determines that the liquid property of the liquid L is not the “slightly rust-prone liquid property” (NO in step S1004), the controller 100b selects the duty including the first liquid property pattern (step S1006). Then, the controller 100b sets a “given time Ton” that is a determination condition in step S702 of FIG. 27 and a “given time Toff” that is a determination condition in step S704.

FIG. 30B is a diagram illustrating an example of images of the duty corresponding to the first liquid property pattern, the second liquid property pattern, and the third liquid property pattern.

As illustrated in FIG. 30B, the duty of the first liquid property pattern, i.e., the duty of the “rust-resistant liquid property” is set as an initial value. In the fourth embodiment, the “rust-resistant liquid property” is, for example, 0% of the salinity in liquid. The duty of the second liquid property pattern, i.e., the “slightly rust-prone liquid property” is set to be slightly lower than the duty including the first liquid property pattern. In the fourth embodiment, the “slightly rust-prone liquid property” corresponds to, for example, a case where the salinity in liquid is less than 0.02%. The duty of the third liquid property pattern, i.e., the “rust-prone liquid property” is set to be slightly lower than the duty including the first liquid property pattern. In the fourth embodiment, the “rust-prone liquid property” corresponds to, for example, a case where the salinity in liquid is 0.02% or more.

In the fourth embodiment, the salinity in liquid is made as an example of the “liquid property of the liquid L”. However, the liquid property of the liquid L is not limited to the salinity in liquid but may be the hardness of the liquid L or may be the material property included in different liquid L. In this case, an appropriate duty according to the liquid property of the liquid L may be defined in advance and stored in the memory of the controller 100b.

### Fifth Embodiment

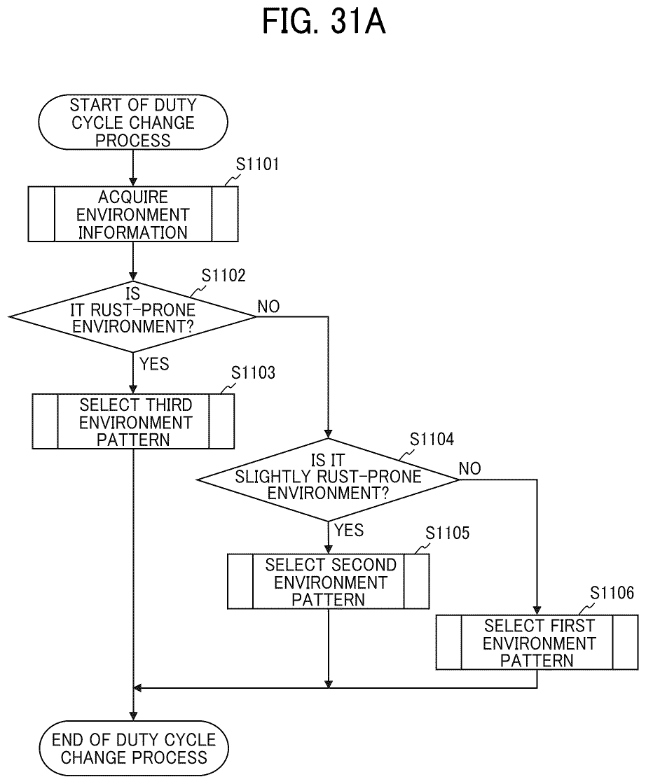

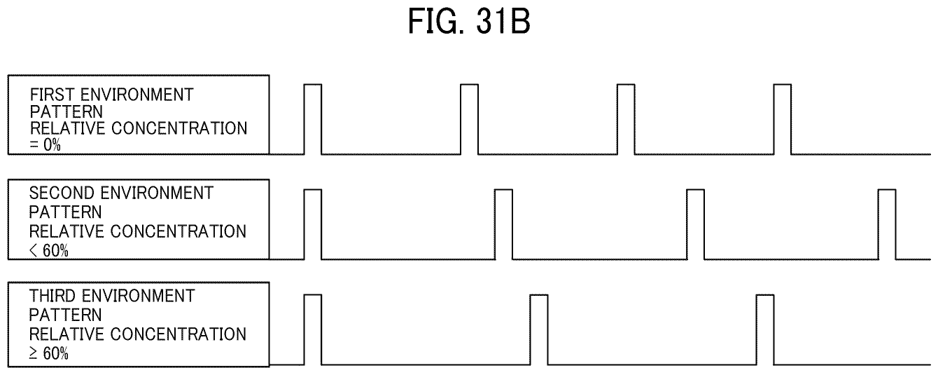

A description is given of another example of the process of changing the intermittent application control pattern of the application voltage, with reference to FIGS. 31A and 31B.

FIG. 31A is a flowchart of the flow of an intermittent application control pattern change process, in other words, the duty change process, according to a fifth embodiment.

It is known that the trends of ionization of the electrolyte in the liquid L are different according to the installation environment on which the post-processing apparatus 3 is installed. In the fifth embodiment, the “environmental information” indicating the installation environment is, for example, the relative humidity of the surroundings where the post-processing apparatus 3 is operated.

For this reason, the duty can be selected to be optimal according to the relative humidity. Further, the correlation of the relative humidity and the pattern information of the duty is stored in the memory of the controller 100b. Alternatively, the environmental information may be set to any value by the user through the control panel 110.

When the duty change process is started, the controller 100b first acquires the environmental information (step S1101). Subsequently, the controller 100b determines whether the installation environment of the post-processing apparatus 3 is the “rust-prone environment” (step S1102). In step S1102, when the controller 100b determines that the installation environment of the post-processing apparatus 3 is the “rust-prone environment” (YES in step S1102), the controller 100b selects the duty including the third environment pattern (step S1103). Then, the controller 100b sets a “given time Ton” that is a determination condition in step S702 of FIG. 27 and a “given time Toff” that is a determination condition in step S704.

In step S1102, the controller 100b determines that the installation environment of the post-processing apparatus 3 is not the “rust-prone environment” (NO in step S1102), the controller 100b then determines whether the installation environment of the post-processing apparatus 3 is the material of the electrical pins is “slightly rust-prone environment” (step S1104). In step S1104, when the controller 100b determines that the installation environment of the post-processing apparatus 3 is the “slightly rust-prone environment” (YES in step S1104), the controller 100b selects the duty including the second environment pattern (step S1105). Then, the controller 100b sets a “given time Ton” that is a determination condition in step S702 of FIG. 27 and a “given time Toff” that is a determination condition in step S704.

In step S1104, when the controller 100b determines that the installation environment of the post-processing apparatus 3 is not the “slightly rust-prone environment” (NO in step S1104), the controller 100b selects the duty including the first environment pattern (step S1106). Then, the controller 100b sets a “given time Ton” that is a determination condition in step S702 of FIG. 27 and a “given time Toff” that is a determination condition in step S704.

FIG. 31B is a diagram illustrating an example of images of the duty corresponding to the first environment pattern, the second environment pattern, and the third environment pattern.

As illustrated in FIG. 31B, the duty of the first environment pattern, i.e., the duty of the “rust-resistant environment” is set as an initial value. In the fifth embodiment, the “rust-resistant environment” corresponds to, for example, a case where the relative humidity is 0%. Further, the duty of the second environment pattern, i.e., the “slightly rust-prone environment” is set to be slightly lower than the duty including the first environment pattern. In the fifth embodiment, the “slightly rust-prone environment” corresponds to, for example, a case where the relative humidity is less than 60%. Further, the duty of the third environment pattern, i.e., the “rust-prone environment” is set to be lower than the duty including the first environment pattern. In the fifth embodiment, the “rust-prone environment” corresponds to, for example, a case where the relative humidity is equal to or greater than 60%.

In the fifth embodiment, the relative humidity is an example of the “environmental information”. However, the environmental information is not limited to the relative humidity and may be a temperature or a component in air. In this case, an appropriate duty according to the environmental information may be defined in advance and stored in the memory of the controller 100b. Further, the determination condition of the relative temperature is set to 60%. However, this is an example, and in the case of the “slightly rust-prone environment” in the relation with the duty, the duty may be set to be lower.

### Sixth Embodiment

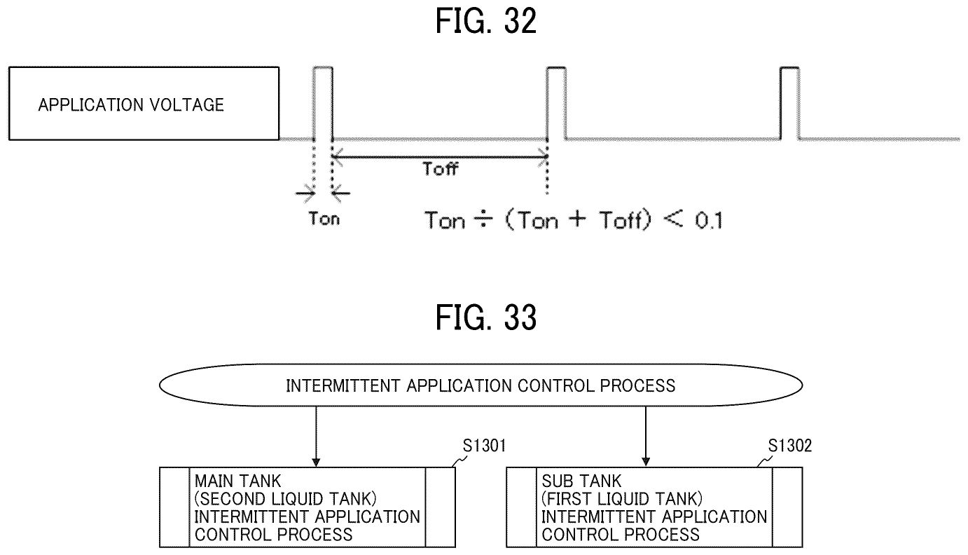

A descriptions is given below of the feature of a second embodiment of the present disclosure, in which the duty corresponding to the time ratio in a unit time between the application state and the non-application state of the application voltage is set to “10% or less”, with reference to FIG. 32.

As described above, as the duty, i.e., the value indicating the ratio of the voltage application period to the electrode pin, the more advantageous it is for reducing the ionization of the electrolyte in the liquid L, i.e., for preventing the increase in the detection voltage of the second liquid level sensor 94. However, the lower limit value of the application period may be restricted.

For example, as illustrated in FIG. 32, a case where the power ON time (Ton: application period in the application state) is “1 millisecond” and the power OFF time (Toff: non-application period in the non-application state) is “9 milliseconds”, i.e., a case where the duty is “10%” is assumed. In this case, the frequency “f” of the application voltage by the intermittent application control becomes a 100 Hz. In other words, the frequency f of the application voltage is the ratio of the application period to the total period of the application period and the non-application period (f=1/(0.001+0.009)).

Similarly, even in a case where the duty is 10%, the frequency “f” when the power ON time (i.e., application period in the application state) is “1 second” and the power OFF time (Toff: non-application period in the non-application state) is “9 seconds” is “0.1 Hz” since the frequency f is the ratio (0.1) of the application period (1) to the total period (1+9).

When only a time lag (responsiveness) from the detection of the change in the liquid level of the liquid L in the second liquid storage tank 47 to the determination of the change is taken into consideration, it is desirable that the frequency by the duty is higher. However, when the power ON time is “1 millisecond”, the liquid remaining amount of the liquid L in the second liquid storage tank 47 may not be accurately determined. For this reason, it is to regulate the lower limit value of the power ON time.

In consideration of this point, in the sixth embodiment, the duty is limited to less than 10% in order to reduce the duty instead of the frequency. Accordingly, the effect of reducing ionization of the electrolyte in the liquid L, in other words, preventing the increase in the detection voltage of the second liquid level sensor 94 can be achieved without deteriorating the operability.

### Seventh Embodiment

A descriptions is given below of another example of the intermittent application control that is executable in the post-processing apparatus 3 according to a seventh embodiment, with reference to the flowchart of FIG. 33.

Instead of supplying the liquid L to be used for liquid application in the liquid applier 31 from the second liquid storage tank 47 as a main tank, the first liquid storage tank 44 as a sub-tank may be disposed in the liquid applier 31 (see FIG. 4), and the liquid L in the first liquid storage tank 44 may be supplied to the liquid application member 501 provided in the liquid applier 31 in the liquid applying operation. In this case, when the liquid level of the liquid L in the first liquid storage tank 44 as a sub tank, i.e., the remaining amount of the liquid L in the first liquid storage tank 44 is below the given value, the liquid L in the second liquid storage tank 47 as a main tank may be supplied to the first liquid storage tank 44 as a sub tank.

In a case where the liquid applier 31 includes the first liquid storage tank 44 as a sub tank and the first liquid level sensor 43 as a liquid level sensor to detect the liquid level of the liquid L in the first liquid storage tank 44, the intermittent application control with respect to the second liquid level sensor 94 disposed in the second liquid storage tank 47 as a main tank that is described with respect to FIG. 27 can be executed in the first liquid storage tank 44 as a sub tank. In this case, the intermittent application control in the second liquid storage tank 47 as a main tank is executed concurrently with the intermittent application control in the first liquid storage tank 44.

In other words, as illustrated in the flowchart of FIG. 33, the intermittent application control process with respect to the second liquid level sensor 94 disposed in the second liquid storage tank 47 as a main tank is executed as an intermittent application control process (step S1301). Since the intermittent application control process in step S1301 is an intermittent application control process described with reference to FIG. 27, the detailed description of the intermittent application control process in step S1301 is omitted.

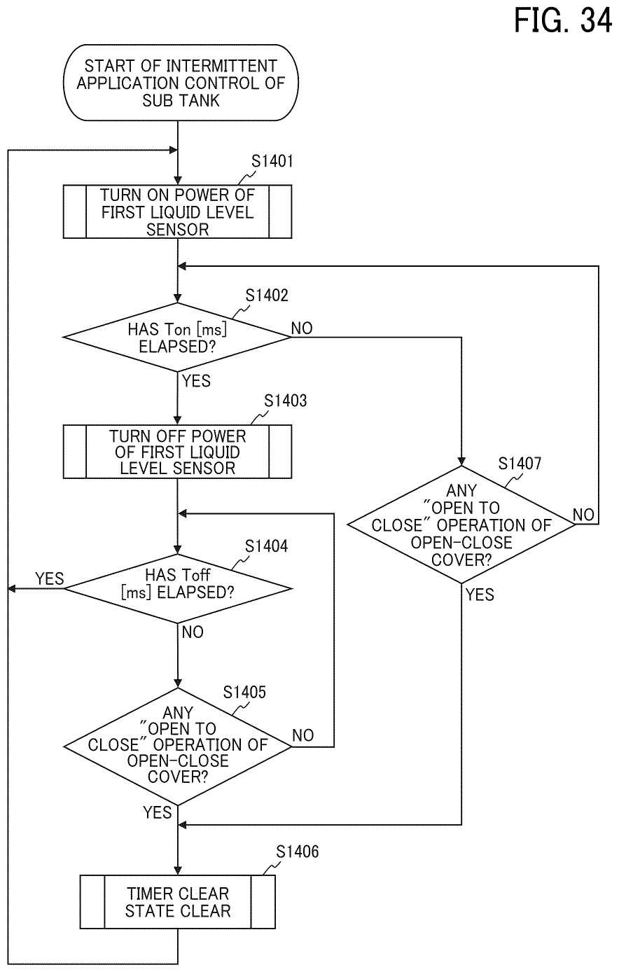

Further, as illustrated in the flowchart of FIG. 33, concurrently with the intermittent application control process in step S1301, the intermittent application control process with respect to the first liquid level sensor 43 disposed in the first liquid storage tank 44 as a sub tank (step S1302). Although the detailed description of the intermittent application control process in step S1302 is illustrated in FIG. 34, this intermittent application control process can be described by replacing the “second liquid level sensor 94” to the “first liquid level sensor 43” in the intermittent application control process with respect to the second liquid level sensor 94 disposed in the second liquid storage tank 47 as a main tank that is described with reference to the flowchart of FIG. 27. For this reason, the detailed description of the intermittent application control process in FIG. 34 is omitted.

As described above, in the post-processing apparatus 3 according to the present embodiment that performs a process using a liquid, the voltage to be applied to the pair of electrodes of the liquid level sensor is switched between ON and OFF at regular time intervals. For this reason, the liquid level sensor can be switched between the power ON state and the power OFF state at regular time intervals. In other words, it is possible to prevent the pair of electrodes of the liquid level sensor from being continuously turned on, and to reduce the adhesion of scale to the electrodes due to ionization of the electrolyte in the liquid even when the voltage is applied to the pair of electrodes of the liquid level sensor by the DC power supply. Accordingly, this configuration can prevent an increase in the detection voltage due to the adhesion of scale to the pair of electrodes of the liquid level sensor, and reduce the possibility of the liquid level sensor erroneously detecting the remaining amount of the liquid in the liquid storage tank.

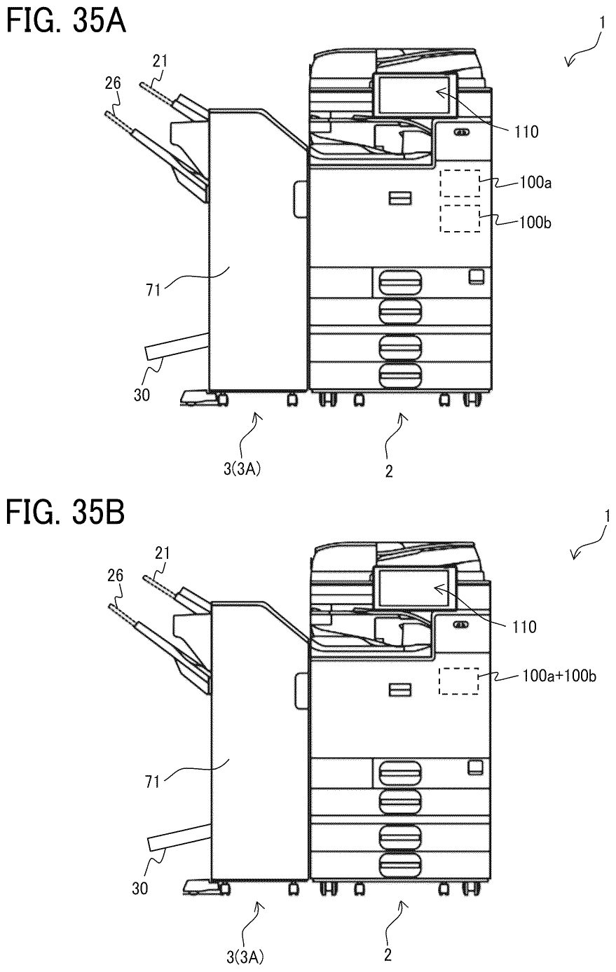

In the above description, the controller 100b of the post-processing apparatus 3 is provided separately from the controller 100a of the image forming apparatus 2 as illustrated in FIG. 1. However, embodiments of the present disclosure are not limited to the above-described configuration. For example, as illustrated in FIG. 35A, the controller 100b of the post-processing apparatus 3 may be disposed in the image forming apparatus 2. Further, as illustrated in FIG. 35B, the controller 100b of the post-processing apparatus 3 may be integrated with the controller 100a of the image forming apparatus 2.

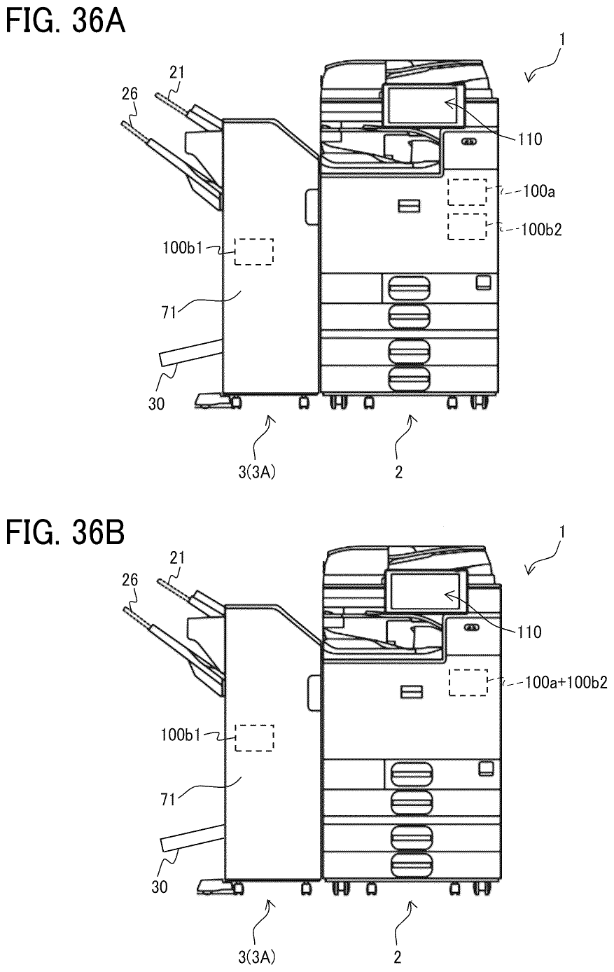

As illustrated in FIG. 36A, the controller 100b of the post-processing apparatus 3 may be divided into a controller 100b1 (e.g., a driver system such as a motor) and a controller 100b2 (e.g., a detector system such as a sensor) according to the functions, and only the controller 100b2 of the post-processing apparatus 3 may be disposed in the image forming apparatus 2. For example, of the controller 100b1 and the controller 100b2 divided from the controller 100b, the controller 100b of the post-processing apparatus 3A may be disposed in the image forming apparatus 2. Further, as illustrated in FIG. 36B, the controller 100b2 of the post-processing apparatus 3 disposed in the image forming apparatus 2 may be integrated with the controller 100a of the image forming apparatus 2.

### Another Embodiment of Post-Processing Apparatus 3

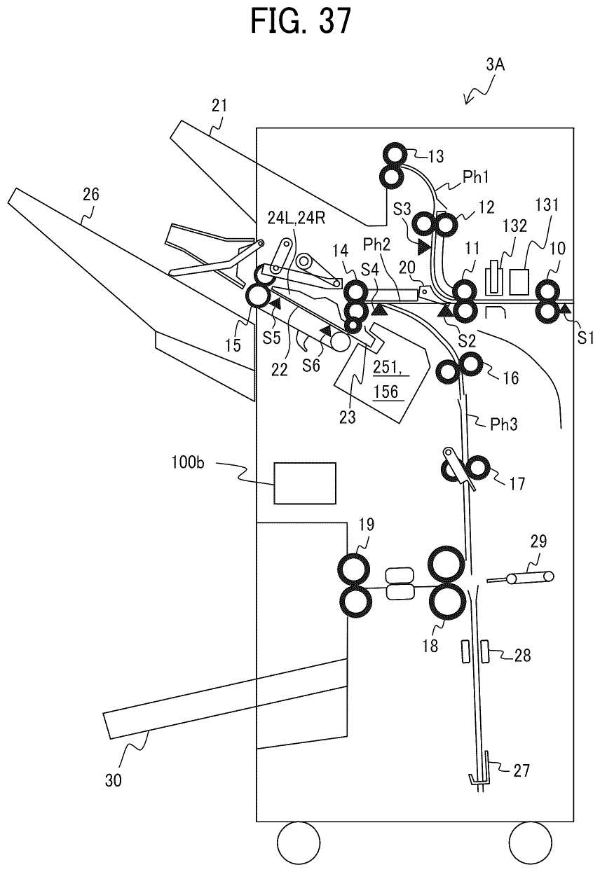

A description is given below of the post-processing apparatus 3A according to another embodiment of the post-processing apparatus 3 according to the present disclosure, with reference to FIGS. 37 to 45.

Components common to those of the post-processing apparatus 3 according to the present disclosure are attached with the same or like reference signs, and detailed descriptions may be omitted.

An edge binder 251 of the post-processing apparatus 3A according to another embodiment is different from the edge binder 25 of the post-processing apparatus 3 according to the present disclosure, in which the liquid applier 31 and the crimper 32 are arranged side by side, in that the edge binder 251 includes a crimper 32′ only and a liquid applier 131 is disposed on the upstream side in a conveyance path. Such a configuration allows a given number of sheets P to be stacked in advance after the liquid application process and conveyed to the crimper 32′ of the edge binder 251 disposed at a downstream position in the direction in which the sheet P is conveyed. Accordingly, the productivity of the sheet binding operation performed by the crimper 32′ is enhanced.

Since the direction in which the conveyance roller pairs 10, 11, and 14 convey the sheet P is opposite to the “conveyance direction” defined above, the direction in which the conveyance roller pairs 10, 11, and 14 convey the sheet P is defined as an “opposite conveyance direction” in the following description. A direction that is orthogonal to both the opposite conveyance direction and the thickness direction of the sheet P, in other words, the width direction of the sheet P is defined as the “main scanning direction.” The liquid application position on a sheet P or a sheet bundle Pb onto which liquid application is performed by the liquid applier 131 corresponds to the binding position on the sheet bundle Pb to be crimped by the crimper 32′. For this reason, in the following description, the liquid application position and the binding position are denoted by the same reference sign (B1).

FIG. 37 is a diagram illustrating the internal configuration of the post-processing apparatus 3A according to another embodiment of the present disclosure.

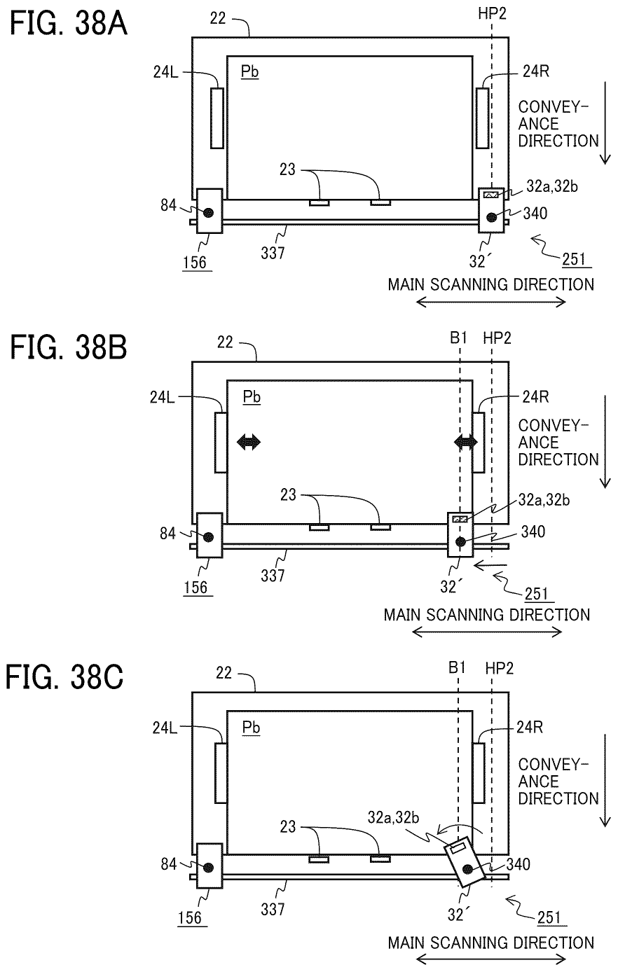

As illustrated in FIGS. 38A, 38B, 38C, the edge binder 251 includes the crimper 32′. As illustrated in FIGS. 38A, 38B, and 38C, the crimper 32′ and the staple binder 156 are disposed downstream from the internal tray 22 in the conveyance direction. In addition, the crimper 32′ and the staple binder 156 are located to face a downstream end, in the conveyance direction, of the sheet bundle Pb placed on the internal tray 22 and is movable in the main scanning direction.

Further, the crimper 32′ and the staple binder 156 are respectively rotatable in the forward and reverse directions about a crimper rotation shaft 340 and a stapler shaft 84 both extending in the thickness direction of the sheet bundle Pb placed on the internal tray 22. In other words, in such an alternative embodiment of the present disclosure the crimper 32′ and the staple binder 156 bind, at any desired angle, a desired position in the main scanning direction on the sheet bundle Pb placed on the internal tray 22 in, for example, corner oblique binding, parallel single stapling binding, or parallel dual stapling binding.

The crimper 32′ presses and deforms the sheet bundle Pb with the serrate upper crimping teeth 32a and the serrate lower crimping teeth 32b to bind the sheet bundle Pb. In the following description, such a binding way may be referred to as “crimp binding.” In other words, the crimper 32′ crimps and binds the sheet bundle Pb or performs the crimp binding on the sheet bundle Pb. On the other hand, the staple binder 156 passes the staple through a binding position on the sheet bundle Pb placed on the internal tray 22 to staple the sheet bundle Pb.

FIGS. 38A, 38B, and 38C are schematic diagrams illustrating the internal tray 22 viewed from the thickness direction of the sheet bundle Pb.

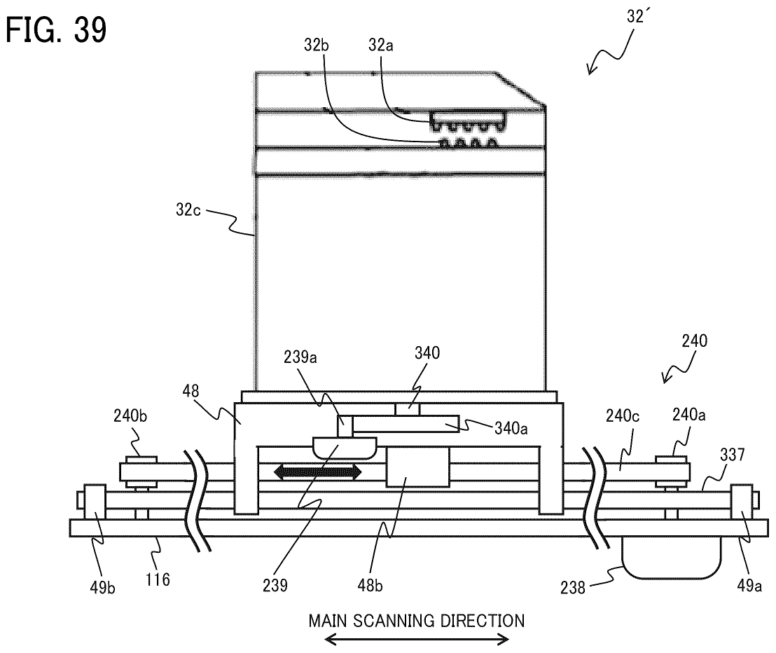

FIG. 39 is a schematic diagram illustrating a downstream side of the crimper 32′ in the conveyance direction.

As illustrated in FIGS. 38A, 38B, and 38C, the crimper 32′ and the staple binder 156 are disposed downstream from the internal tray 22 in the conveyance direction. The crimper 32′ is movable in the main scanning direction along the surface of the sheet bundle Pb placed on the internal tray 22. Further, the crimper 32′ is rotatable in the forward and reverse directions about the crimper rotation shaft 340 extending in the thickness direction of the sheet bundle Pb placed on the internal tray 22.

Similarly, the staple binder 156 is movable in the main scanning direction of the sheet bundle Pb. Further, the staple binder 156 is rotatable in the forward and reverse directions about a stapler shaft 84 extending in thickness direction of the sheet bundle Pb. Since the other components of the staple binder 156 are similar to those of the staple binder 155 (see FIG. 9) of the post-processing apparatus 3 according to the present disclosure, a detailed description thereof is omitted.

As illustrated in FIG. 39, the crimper 32′ includes a guide rail 337 extending in the main scanning direction at a position downstream from the internal tray 22 in the conveyance direction. The crimper 32′ includes a crimper movement motor 238 as a drive source. The base 48 supporting the crimping frame 32c has a fastening portion 48b for fastening the timing belt 240c at the bottom of the base 48. The driving force of the crimper movement motor 238 is transmitted to the base 48 by the drive transmission assembly 240 that includes the pullies 240a and 240b, the timing belt 240c, and the fastening portion 48b. By so doing, the crimper 32′ is moved in the main scanning direction along the surface of the sheet bundle Pb placed on the internal tray 22, in other words, along the guide rail 337. The crimper rotation shaft 340 including a drive transmission gear 340a is fixed to a bottom face of the crimping frame 32c that holds the components of the crimper 32′.

The crimper rotation shaft 340 and the drive transmission gear 340a are held by a base 48 on which the crimping frame 32c is disposed, so as to be rotatable in the forward and reverse directions. The drive transmission gear 340a meshes with an output gear 239a of a crimper pivot motor 239. When the driving force of the crimper pivot motor 239 is transmitted to the crimper rotation shaft 340 via the output gear 239a and the drive transmission gear 340a, the crimper 32′ rotates in the forward and reverse directions on the base 48 about the crimper rotation shaft 340 extending in the thickness direction of the sheet P placed on the internal tray 22. The guide rail 337, the crimper movement motor 238, the crimper pivot motor 239, the crimper rotation shaft 340, and the drive transmission assembly 240 constitute at least part of an example of a driving mechanism of the crimper 32′.

The crimper 32′ is movable between a standby position HP2 illustrated in FIG. 38A and a position where the crimper 32′ faces the first binding position B1 illustrated in FIGS. 38B and 38C. The standby position HP2 is a position away in the main scanning direction from the sheet bundle Pb placed on the internal tray 22. The first binding position B1 is a position on the sheet bundle Pb placed on the internal tray 22. However, the specific position of the first binding position B1 is not limited to the example of FIGS. 38A, 38B, and 38C, and the first binding position B1 may be any one or more positions in the main scanning direction in a downstream end in the conveyance direction of the sheet P.

The posture of the crimper 32′ changes between the parallel binding posture illustrated in FIG. 38B and the oblique binding posture illustrated in FIG. 38C.

In other words, the crimper 32′ is rotatable in the forward and reverse directions about the crimper rotation shaft 340. The parallel binding posture is a posture of the crimper 32′ in which the longitudinal direction of the upper crimping teeth 32a and the lower crimping teeth 32b is along the main scanning direction. In other words, the parallel binding posture is a posture of the crimper 32′ in which the longitudinal direction of the “rectangular crimp binding trace” faces the main scanning direction. The oblique binding posture is a posture of the crimper 32′ in which the longitudinal direction of the upper crimping teeth 32a and the lower crimping teeth 32b is inclined with respect to the main scanning direction. In other words, the parallel binding posture is a posture of the crimper 32′ in which the longitudinal direction of the “rectangular crimp binding trace” is inclined with respect to the main scanning direction.

The rotational angle, which is an angle of the upper crimping teeth 32a and the lower crimping teeth 32b with respect to the main scanning direction, in the oblique binding posture is not limited to the angle illustrated in FIG. 38C. The rotational angle in the oblique binding posture may be any angle provided that the upper crimping teeth 32a and the lower crimping teeth 32b face the sheet bundle Pb placed on the internal tray 22.

The post-processing apparatus 3A includes the liquid applier 131 and a hole punch 132, which is an example of a processor. The liquid applier 131 and the hole punch 132 are disposed upstream from the internal tray 22 in the reverse conveyance direction. In addition, the liquid applier 131 and the hole punch 132 are disposed at different positions in the opposite conveyance direction to simultaneously face one sheet P that is conveyed by the conveyance roller pairs 10 to 19.

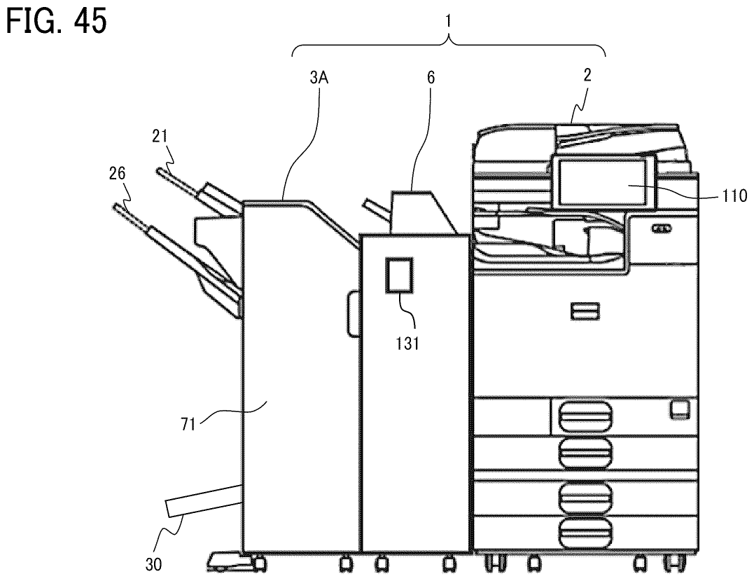

The liquid applier 131 and the hole punch 132 according to the present embodiment are disposed between the conveyance roller pairs 10 and 11. However, the arrangement of the liquid applier 131 is not limited to the example of FIG. 37. For example, in a case where an inserter 6 is disposed between the image forming apparatus 2 and the post-processing apparatus 3A as illustrated in FIG. 45, the liquid applier 131 may be disposed inside the inserter 6 located upstream from the post-processing apparatus 3A in a direction in which the sheet P is conveyed from the image forming apparatus 2 to the post-processing apparatus 3A. Examples of the inserter 6 include, but are not limited to, an apparatus that allows a pre-printed medium, which is to be conveyed to the post-processing apparatus 3A together with the sheet P conveyed from the image forming apparatus 2, to be fed as a cover sheet, an insertion sheet, or a partition sheet without passing through the image forming apparatus 2.

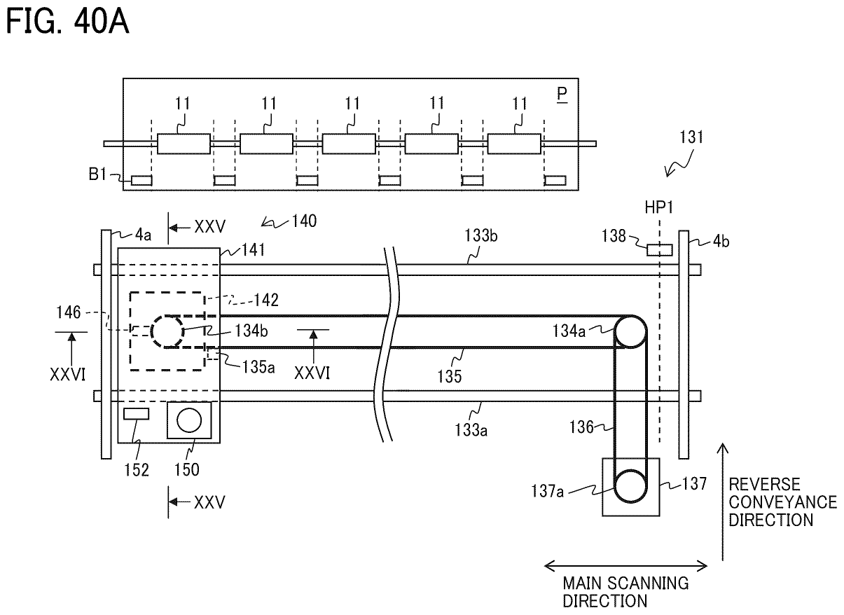

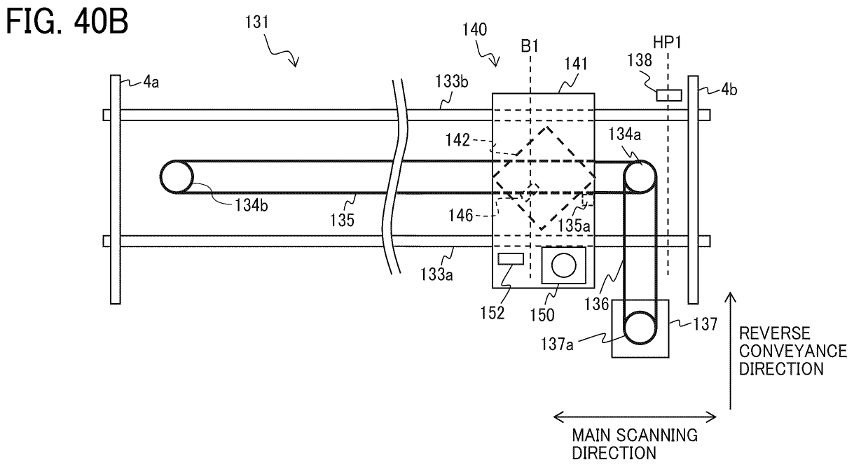

As illustrated in FIG. 40A, the conveyance roller pair 11 is located so as not to overlap, in the main scanning direction, the first liquid application position B1 on the sheet P to which the liquid is applied by a liquid application head 146 of the liquid applier 131. This arrangement is to prevent the amount of liquid at the first liquid application position B1 from decreasing due to multiple roller pairs pressing the first liquid application position B1 when the conveyance roller pair 11 conveys the sheet P. As a result, when the sheet P reaches the crimper 32′ disposed downstream from the liquid applier 131 in the opposite conveyance direction, the amount of liquid at the first liquid application position B1 is sufficient to maintain the binding strength. Accordingly, the binding strength of the sheet bundle Pb is prevented from decreasing due to a decrease in the amount of liquid at the first liquid application position B1 (corresponding to the first binding position B1) while the sheet Pis conveyed.

In addition, a plurality of paired rollers included in the conveyance roller pair 11 are located at positions at which the multiple roller pairs do not overlap with the first liquid application position B1 on the sheet P in the main scanning direction, which can thus prevent the conveying performance of the sheet P from being worse due to the adhesion of liquid to the roller pairs and further prevent a conveyance jam caused by the worsened conveying performance of the sheet P.

Although only the conveyance roller pair 11 has been described above, similarly, the roller pairs included in the conveyance roller pairs 14 and 15 are also preferably located at positions at which the roller pairs do not overlap with the first liquid application position B1 on the sheet P in the main scanning direction.

The liquid applier 131 applies liquid to the sheet P that is conveyed by the conveyance roller pairs 10 and 11. In the following description, the application of liquid may be referred to as “liquid application.” The hole punch 132 punches a hole in the sheet P that is conveyed by the conveyance roller pairs 10 and 11 such that the hole penetrates the sheet P in the thickness direction of the sheet P. The processor disposed near the liquid applier 131 is not limited to the hole punch 132. Alternatively, the processor may be an inclination corrector that corrects an inclination or skew of the sheet P that is conveyed by the conveyance roller pairs 10 and 11.

FIGS. 40A and 40B are diagrams illustrating the liquid applier 131 according to another embodiment of the present disclosure, viewed from the thickness direction of the sheet P.

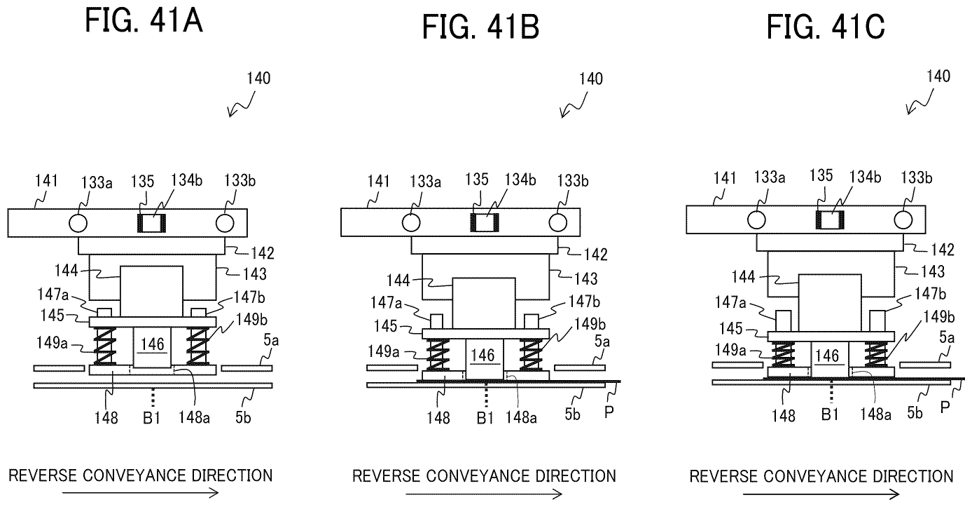

FIGS. 41A, 41B, and 41C are cross-sectional views of a liquid application unit 140 of the liquid applier 131, taken through XXV-XXV of FIG. 40A.

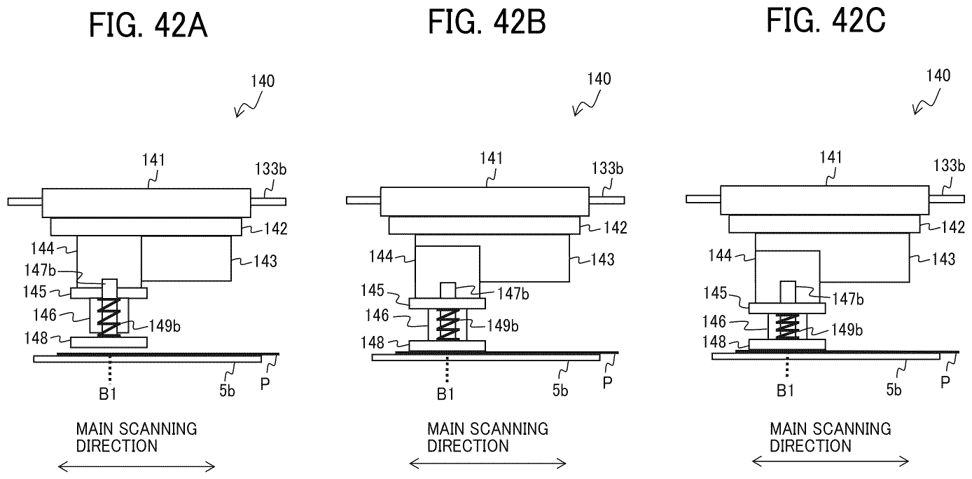

FIGS. 42A, 42B, and 42C are cross-sectional views of the liquid application unit 140 of the liquid applier 131, taken through XXVI-XXVI of FIG. 40A.

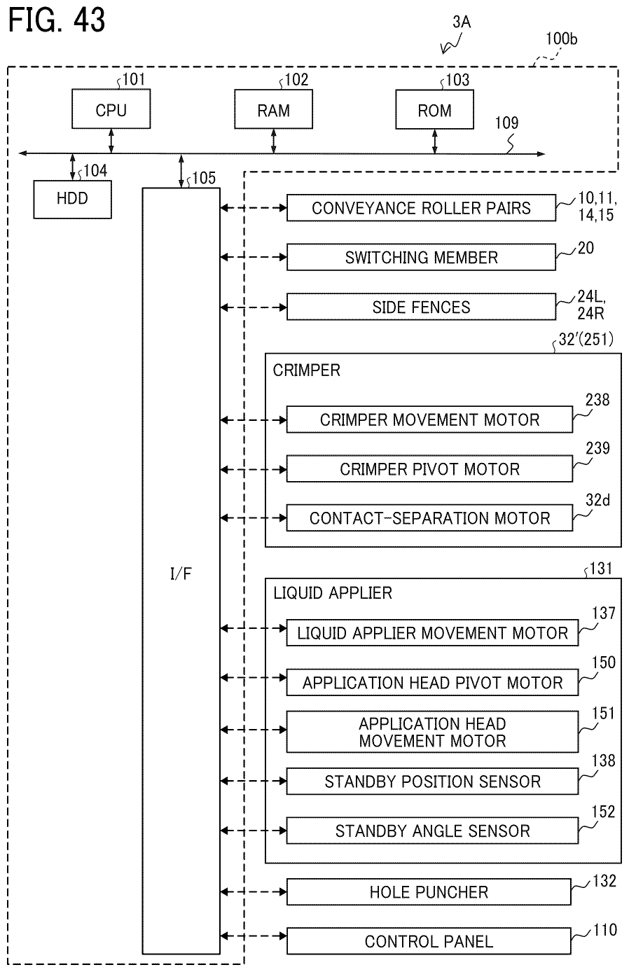

As illustrated in FIGS. 40A to 42C, the liquid applier 131 includes a pair of guide shafts 133a and 133b, a pair of pulleys 134a and 134b, endless annular belts 135 and 136, a liquid applier movement motor 137, a standby position sensor 138, which is also illustrated in FIG. 43, and the liquid application unit 140.

The guide shafts 133a and 133b, each extending in the main scanning direction, are spaced apart from each other in the opposite conveyance direction. The pair of guide shafts 133a and 133b are supported by a pair of side plates 4a and 4b of the post-processing apparatus 3A. The pair of guide shafts 133a and 133b support the liquid application unit 140 such that the liquid application unit 140 can move in the main scanning direction.

The pair of pulleys 134a and 134b is disposed between the pair of guide shafts 133a and 133b in the opposite conveyance direction. On the other hand, the pulleys 134a and 134b are apart from each other in the main scanning direction. The pair of pulleys 134a and 134b are supported by a frame of the post-processing apparatus 3A so as to be rotatable in the forward and reverse directions about the respective shafts extending in the thickness direction of the sheet P.

The endless annular belt 135 is looped around the pair of pulleys 134a and 134b. The endless annular belt 135 is coupled to the liquid application unit 140 by a coupling portion 135a. The endless annular belt 136 is entrained around the pulley 134a and a driving pulley 137a that is fixed to an output shaft of the liquid applier movement motor 137. The liquid applier movement motor 137 generates a driving force to move the liquid application unit 140 in the main scanning direction.

As the liquid applier movement motor 137 rotates, the endless annular belt 136 circulates around the pulley 134a and the driving pulley 137a to rotate the pulley 134a. As the pulley 134a rotates, the endless annular belt 135 circulates around the pair of pulleys 134a and 134b. As a result, the liquid application unit 140 moves in the main scanning direction along the pair of guide shafts 133a and 133b. The liquid application unit 140 reciprocates in the main scanning direction in response to the rotation direction of the liquid applier movement motor 137 being switched.

The standby position sensor 138 detects that the liquid application unit 140 has reached a standby position HP1 (see FIG. 40B) in the main scanning direction. The standby position sensor 138 then outputs a standby position signal indicating the detection result to the controller 100b, which will be described below with reference to FIG. 43. The standby position sensor 138 is, for example, an optical sensor including a light emitter and a light receiver. At the standby position HP1, the liquid application unit 140 blocks an optical path between the light emitter and the light receiver. The standby position sensor 138 outputs the standby position signal in response to the light output from the light emitter not being received by the light receiver. The specific configuration of the standby position sensor 138 is not limited to the configuration described above.

As illustrated in FIGS. 41A, 41B, and 41C, the conveyance passage inside the post-processing apparatus 3A is defined by an upper guide plate 5a and a lower guide plate 5b, which are apart from each other in the thickness direction of the sheet P. The liquid application unit 140 is located to face an opening of the upper guide plate 5a. In other words, the liquid application unit 140 is disposed facing the sheet P to be conveyed in the conveyance path through the opening of the upper guide plate 5a.

As illustrated in FIGS. 40A to 42C, the liquid application unit 140 includes a base 141, a rotary bracket 142, a liquid storage tank 143, a liquid application head mover 144, a holder 145, the liquid application head 146, columns 147a and 147b, a pressure plate 148, coil springs 149a and 149b, the application head pivot motor 150, the application head movement motor 151 (see FIG. 43), and a standby angle sensor 152 (see FIG. 43).

The base 141 is supported by the pair of guide shafts 133a and 133b so as to be slidable in the main scanning direction. The base 141 is coupled to the endless annular belt 135 by the coupling portion 135a. The base 141 supports the components of the liquid application unit 140 such as the rotary bracket 142, the liquid storage tank 143, the liquid application head mover 144, the holder 145, the liquid application head 146, the columns 147a and 147b, the pressure plate 148, the coil springs 149a and 149b, the application head pivot motor 150, the application head movement motor 151, and the standby angle sensor 152.

The rotary bracket 142 is attached to the lower face of the base 141 so as to be rotatable in the forward and reverse directions about an axis extending in the thickness direction of the sheet P. The rotary bracket 142 is rotated with respect to the base 141 by a driving force transmitted from the application head pivot motor 150. The rotary bracket 142 retains the liquid storage tank 143, the liquid application head mover 144, the holder 145, the liquid application head 146, the columns 147a and 147b, the pressure plate 148, and the coil springs 149a and 149b.

The standby angle sensor 152, which is also illustrated in FIG. 43, detects that the rotary bracket 142 has reached a standby angle. The standby angle sensor 152 then outputs a standby angle signal indicating the detection result to the controller 100b. The standby angle is, for example, an angle at the time of performing parallel binding. The standby angle sensor 152 is, for example, an optical sensor including a light emitter and a light receiver. The rotary bracket 142 at the standby angle blocks an optical path between the light emitter and the light receiver. The standby angle sensor 152 outputs the standby angle signal in response to the light output from the light emitter not being received by the light receiver. The specific configuration of the standby angle sensor 152 is not limited to the configuration described above.

FIG. 40A illustrates the rotary bracket 142 in a position for the parallel binding that is performed by the crimper 32′ disposed downstream from the liquid applier 131 in a direction in which the sheet P is conveyed.

FIG. 40B illustrates the rotary bracket 142 in a position for the oblique binding (i.e., corner binding) that is performed by the crimper 32′ disposed downstream from the liquid applier 131 in the direction in which the sheet P is conveyed.

The liquid storage tank 143 stores liquid L to be applied to the sheet P. The liquid application head mover 144 is attached by the liquid storage tank 143 so as to be movable (e.g., up and down) in the thickness direction of the sheet P. The liquid application head mover 144 moves in the thickness direction of the sheet P with respect to the liquid storage tank 143 by a driving force transmitted from the application head movement motor 151. The holder 145 is attached to a lower end of the liquid application head mover 144. The liquid application head 146 projects from the holder 145 toward the conveyance passage (downward in the present embodiment). The liquid L that is stored in the liquid storage tank 143 is supplied to the liquid application head 146. The liquid application head 146 is made of a material having a relatively high liquid absorption (e.g., sponge or fiber).

The columns 147a and 147b project downward from the holder 145 around the liquid application head 146. The columns 147a and 147b are movable relative to the holder 145 in the thickness direction. The columns 147a and 147b have respective lower ends holding the pressure plate 148. The pressure plate 148 has a through hole 148a at a position where the through hole 148a faces the liquid application head 146. The coil springs 149a and 149b are fitted around the columns 147a and 147b, respectively, between the holder 145 and the pressure plate 148. The coil springs 149a and 149b bias the columns 147a and 147b and the pressure plate 148 in a direction away from the holder 145.

As illustrated in FIG. 41A and FIG. 42A, at the stage before the sheet P is conveyed to the position where the sheet P faces the opening of the upper guide plate 5a, the pressure plate 148 is positioned at or above the opening. Subsequently, when the sheet P that is conveyed by the conveyance roller pairs 10 and 11 stops at a position where the first liquid application position B1 on the sheet P faces the opening, the application head movement motor 151 is rotated in a first direction. As a result, the liquid application head mover 144, the holder 145, the liquid application head 146, the columns 147a and 147b, the pressure plate 148, and the coil springs 149a and 149b are moved down together to allow the pressure plate 148 to contact the sheet P. The first liquid application position B1 is a position (i.e., the first binding position B1) to be crimped and bound by the crimper 32′ included in the edge binder 251.

As the application head movement motor 151 keeps rotating in the first direction after the pressure plate 148 contacts the sheet P, the coil springs 149a and 149b are compressed to further move down the liquid application head mover 144, the holder 145, the liquid application head 146, and the columns 147a and 147b. Then, as illustrated in FIG. 41B and FIG. 42B, a lower face of the liquid application head 146 contacts the sheet P through the through hole 148a. As a result, the liquid L contained in the liquid application head 146 is applied to the sheet P.

Further rotation of the application head movement motor 151 in the first direction further strongly presses the liquid application head 146 against the sheet P as illustrated in FIGS. 41C and 42C. Accordingly, the liquid application amount of liquid that is applied to the sheet P increases. In other words, in such an alternative embodiment of the present disclosure the liquid applier 131 changes the pressing force of the liquid application head 146 against the sheet P to adjust the liquid application amount of liquid that is applied to the sheet P.

On the other hand, the rotation of the application head movement motor 151 in the second direction opposite to the first direction moves up the liquid application head mover 144, the holder 145, the liquid application head 146, the columns 147a and 147b, the pressure plate 148, and the coil springs 149a and 149b together. As a result, as illustrated in FIG. 41A and FIG. 42A, the liquid application head 146 and the pressure plate 148 move away from the sheet P. In other words, the liquid applier 131 includes the liquid application head 146 that can be separated from the sheet P.

FIG. 43 is a diagram illustrating the hardware configuration of a control block of the post-processing apparatus 3A according to another embodiment of the present disclosure.

As illustrated in FIG. 43, the post-processing apparatus 3A includes a central processing unit (CPU) 101, a random access memory (RAM) 102, a read only memory (ROM) 103, a hard disk drive (HDD) 104, and an interface (I/F) 105. The CPU 101, the RAM 102, the ROM 103, the HDD 104, and the I/F 105 are connected to each other via a common bus 109.

The CPU 101 is an arithmetic unit and controls the overall operation of the post-processing apparatus 3A.

The RAM 102 is a volatile storage medium that allows high speed reading and writing of data, and is used as a working area when the CPU 101 processes information.

The ROM 103 is a read-only non-volatile storage medium that stores programs such as firmware.

The HDD 104 is a non-volatile storage medium that allows data to be read and written and has a relatively large storage capacity. The HDD 104 stores, e.g., an operating system (OS), various control programs, and application programs.

By an arithmetic function of the CPU 101, the post-processing apparatus 3A processes, for example, a control program stored in the ROM 103 and an information processing program (application program) loaded into the RAM 102 from a storage medium such as the HDD 104. Such processing configures a software controller including various functional modules of the post-processing apparatus 3A. The software controller thus configured cooperates with hardware resources of the post-processing apparatus 3A to construct functional blocks that implement functions of the post-processing apparatus 3A. In other words, the CPU 101, the RAM 102, the ROM 103, the HDD 104, and the I/F 105 constitute at least part of a controller 100b serving as a control device that controls the operation of the post-processing apparatus 3A.

The I/F 105 is an interface that connects the conveyance roller pairs 10, 11, 14, and 15, the switcher 20, the side fences 24L and 24R, the crimper movement motor 238, the crimper pivot motor 239, a contact-separation motor 32d, a liquid applier movement motor 137, an application head pivot motor 150, an application head movement motor 151, a standby position sensor 138, a standby angle sensor 152, a hole punch 132, and a control panel 110 to the common bus 109.

The controller 100b controls, via the I/F 105, the operations of the conveyance roller pairs 10, 11, 14, and 15, the switcher 20, the side fences 24L and 24R, the crimper movement motor 238, the crimper pivot motor 239, the contact-separation motor 32d, the liquid applier movement motor 137, the application head pivot motor 150, the application head movement motor 151, and the hole punch 132. The controller 100b acquires detection results from the standby position sensor 138 and the standby angle sensor 152 through the I/F 105.

Although FIG. 43 illustrates the components of the liquid applier 131 and the edge binder 251 including the crimper 32′ that executes the edge binding, the components of the saddle binder 28 that executes the saddle binding are controlled by the controller 100b like the components of the liquid applier 131 and the edge binder 251 (the crimper 32′) that executes the edge binding.

As illustrated in FIG. 45, the image forming apparatus 2 includes the control panel 110. The control panel 110 includes an operation device that receives instructions input by an operator and a display serving as a notification unit that notifies the operator (user) of information. The operation device includes, for example, physical input buttons and a touch panel overlaid on a display. The control panel 110 acquires information from the user through the operation unit and provides the information to the user through the display. The notifier is not limited to the display and may be a light-emitting diode (LED) lamp or a speaker. The post-processing apparatus 3A may include a control panel 110 similar to the above-described control panel 110 of the image forming apparatus 2.

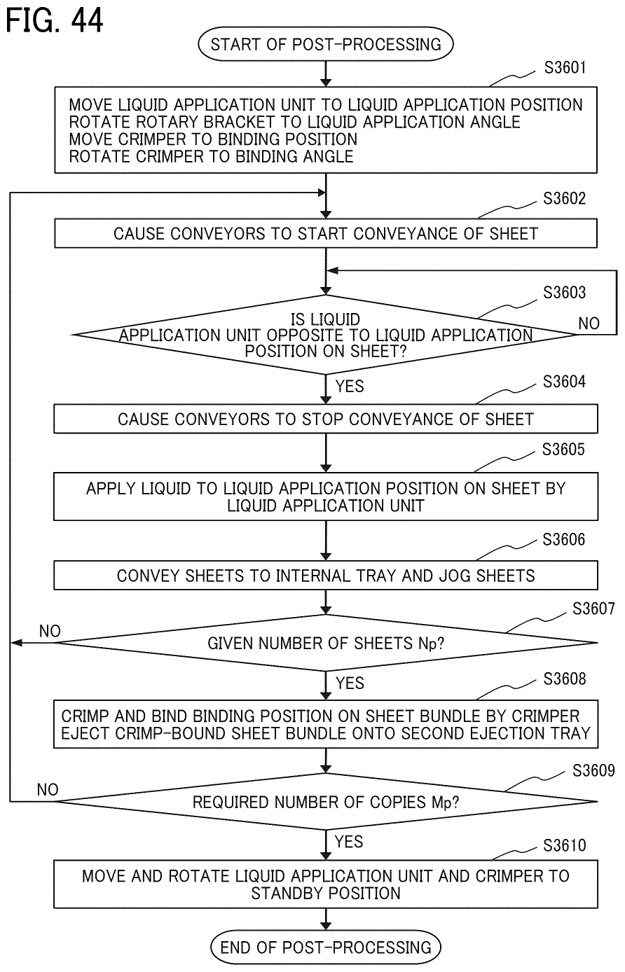

FIG. 44 is a flowchart of post-processing performed by the post-processing apparatus 3A according to another embodiment of the present disclosure.

Specifically, FIG. 44 is a flowchart of a process in executing the single stapling binding illustrated in FIGS. 38A, 38B, and 38C.

For example, the controller 100b executes the post-processing illustrated in FIG. 44 in response to acquisition of an instruction (denoted below as “post-processing command”) of executing the post-processing from the image forming apparatus 2. The post-processing command includes, for example, the number of sheets P of the sheet bundle Pb (denoted below as “given number of sheets Np”), the number of sheet bundles Pb to be subjected to binding process (denoted below as “requested number of copies Mp”), the first binding position B1 (corresponding to the first liquid application position B1), the angle of the first binding position B1 (corresponding to the angle of the first liquid application position B1), the type of binding process (for example, parallel binding process or oblique binding process), and a process that is executed in parallel with the liquid application process (punching a hole in the present embodiment). At the start of the post-processing, the liquid application unit 140 is at the standby position HP1 (see FIGS. 40A and 40B), and the rotary bracket 142 is held at the standby angle (corresponding to “parallel binding posture”).

First, the controller 100b drives the liquid applier movement motor 137 to move the liquid application unit 140 (corresponding to a liquid applier) in the main scanning direction, thus causing the liquid application head 146 to move from the standby position HP1 to the position where the liquid application head 146 can face the first liquid application position B1 (see FIG. 40B, the position corresponding to the first binding position B1 illustrated in FIG. 38B and FIG. 38C). (no translation) If the type of the binding process instructed by the post-processing command is “oblique binding process,” in step S3601, the controller 100b drives the application head pivot motor 150 to rotate the rotary bracket 142. Thus, the liquid application head 146 is rotated from the standby angle to the liquid application angle corresponding to the “oblique binding posture.” It can be ascertained, based on pulse signals output from rotary encoders of the liquid applier movement motor 137 and the application head pivot motor 150, that the liquid application head 146 has reached the position where the liquid application head 146 can face the first liquid application position B1 and the liquid application angle.

If the type of the binding process instructed by the post-processing command is “parallel binding process”, the controller 100b omits the above-described operation of rotating the rotary bracket 142. In other words, the liquid application unit 140 moves in the main scanning direction while holding the rotary bracket 142 at the standby angle.

Further, in step S3601, the controller 100b drives the crimper movement motor 238 to move the crimper 32′ from the standby position HP2 to the position where the crimper 32′ can face the first binding position B1 as illustrated in FIGS. 38A and 38B. Alternatively, if the type of the binding process instructed by the post-processing command is “oblique binding process,” in step S3601, the controller 100b drives the crimper pivot motor 239 to rotate the crimper 32′ from the standby angle to the crimping angle corresponding to the “oblique binding posture.” It is ascertained based on a pulse signal output from a rotary encoder of the crimper movement motor 238 that the crimper 32′ has reached the position where the crimper 32′ can face the first binding position B1. Similarly, it is ascertained based on a pulse signal output from a rotary encoder of the crimper pivot motor 239 that the crimper 32′ has reached the crimping angle. If the type of the binding process instructed by the post-processing command is “parallel binding process,” the controller 100b omits the above-described operation of rotating the crimper 32′. In other words, the crimper 32′ moves in the main scanning direction while maintaining the standby angle.

In step S3602, the controller 100b drives the conveyance roller pairs 10 and 11 to start conveying the sheet P on which an image is formed by the image forming apparatus 2. In step S3603, the controller 100b determines whether the first liquid application position B1 on the sheet P has faced the liquid application unit 140 (more specifically, the liquid application head 146). When the controller 100b determines that the first liquid application position B1 on the sheet P has not faced the liquid application unit 140 (NO in S3603), the controller 100b continues causing the conveyance roller pairs 10 and 11 to convey the sheet P until the first liquid application position B1 on the sheet P faces the liquid application unit 140 (YES in S3603). When the controller 100b determines that the first liquid application position B1 on the sheet P has faced the liquid application head 146 (YES in step S3603), the controller 100b causes the conveyance roller pairs 10 and 11 to stop conveying the sheet Pin step S3604. It can be ascertained, based on a pulse signal output from a rotary encoder of a motor that drives the conveyance roller pairs 10 and 11, that the first liquid application position B1 on the sheet P has faced the liquid application head 146.

In step S3605, the controller 100b causes the liquid application unit 140 to execute the process of applying liquid to the first liquid application position B1 on the sheet P. More specifically, the controller 100b rotates the application head movement motor 151 in the first direction to bring the liquid application head 146 into contact with the first liquid application position B1 on the sheet P. The controller 100b changes the pressing force of the liquid application head 146, in other words, the amount of rotation or rotation speed of the application head movement motor 151, depending on the amount of liquid to be applied to the sheet P.

The amount of liquid that is applied to the sheet P may be the same for all the sheets P of the sheet bundle Pb or may be different for each sheet P. For example, the controller 100b may decrease the amount of liquid applied to a sheet P conveyed later. The amount of rotations of the application head movement motor 151 may be ascertained based on a pulse signal outputted from a rotary encoder of the application head movement motor 151.

In step S3606, the controller 100b drives the conveyance roller pairs 10, 11, 14, and 15 to place a sheet P on the internal tray 22. In step S3606, the controller 100b also causes the side fences 24L and 24R to reciprocate in the main scanning direction to align the position of the sheet P or the sheet bundle Pb placed on the internal tray 22 in the main scanning direction. In short, the controller 100b performs so-called jogging.

In step S3607, the controller 100b determines whether the number of sheets P placed on the internal tray 22 has reached the given number of sheets Np indicated by the post-processing command. When the controller 100b determines that the number of sheets P placed on the internal tray 22 has not reached the given number of sheets Np (NO in step S3607), the controller 100b executes the operations of steps S3602 to S3607 again until the number of sheets P placed on the internal tray 22 reaches the given number of sheets Np (YES in step S3607).

In contrast, when the controller 100b determines that the number of sheets P that are placed on the internal tray 22 has reached the given number of sheets Np (YES in step S3607), the controller 100b causes the crimper 32′ to crimp the binding position B1 (corresponding to the first liquid application position B1 of the sheet P) on the sheet bundle Pb including the sheet P to which the liquid has been applied by the liquid application unit 140 in step S3608. In step S3608, the controller 100b also rotates the conveyance roller pair 15 to eject the crimped sheet bundle Pb to the second ejection tray 26.

In step S3609, the controller 100b determines whether the number of sheet bundles Pb thus ejected to the second ejection tray 26 has reached the requested number of copies Mp indicated by the post-processing command. When the controller 100b determines that the number of the sheet bundles Pb ejected to the second ejection tray has not reached the requested number of copies Mp (NO in step S3609), the controller 100b repeats the processing of steps S3602 to S3609 until the number of the sheet bundles Pb ejected to the second ejection tray reaches the requested number of copies Mp (YES in step S3609).

When the controller 100b determines that the number of sheet bundles Pb ejected to the second ejection tray 26 reaches the requested number of copies Mp (YES in step S3609), the controller 100b drives the liquid applier movement motor 137 to move the liquid application unit 140 to the standby position HP1 (see FIGS. 40A and 40B) and drives the crimper movement motor 238 to move the crimper 32′ to the standby position HP2 (see FIGS. 38A, 38B and 38C) in step S3610. When the posture that is instructed by the post-processing command is the “oblique binding posture,” the controller 100b drives the application head pivot motor 150 and the crimper pivot motor 239 to rotate the liquid application unit 140 and crimper 32′ and the parallel binding posture (corresponding to the standby angle) into the parallel binding posture (step S3610). By contrast, when the posture that is instructed by the post-processing command is the “parallel binding posture,” the controller 100b skips the aforementioned operation of rotating the liquid application unit 140 and the crimper 32′ to the parallel binding posture (standby angle). In steps S3601 and S3610, the execution order of the movement in the main scanning direction and the rotation in the forward and reverse directions of the liquid application unit 140 and the crimper 32′ is not limited to the aforementioned order and may be reversed.

The embodiments of the present disclosure are applied to the edge binder 25 that executes the edge binding as described above. However, the embodiments of the present disclosure may be applied to the saddle binder 28 that executes the saddle binding.

The configuration in which the controller 100b of the post-processing apparatus 3A according to another embodiment illustrated in FIG. 37 is provided separately from the controller 100a of the image forming apparatus 2 similarly with FIG. 1 has been described, but it is not limited to such a configuration. For example, as illustrated in FIG. 35A, the controller 100b of the post-processing apparatus 3A may be disposed in the image forming apparatus 2. Further, as in the configuration of FIG. 35B, the controller 100b of the post-processing apparatus 3A may be integrated with the controller 100a of the image forming apparatus 2.

Similarly with FIG. 36A, the controller 100b of the post-processing apparatus 3A may be divided into a controller 100b1 (e.g., a driver system (such as a motor)) and a controller 100b2 (a detector system (such as a sensor)) according to the function, and the controller 100b2 of the post-processing apparatus 3A may be disposed in the image forming apparatus 2. For example, of the controller 100b1 and the controller 100b2 divided from the controller 100b, only the controller 100b2 of the post-processing apparatus 3A may be disposed in the image forming apparatus 2. Further, as in the configuration of FIG. 36B, the controller 100b2 of the post-processing apparatus 3A disposed in the image forming apparatus 2 may be integrated with the controller 100a of the image forming apparatus 2.

As described above, the control method by the controller 100b described above is implemented by cooperation between hardware resources of a computer and a program as computer software. In other words, the control method may be a method executed by a computer causing an arithmetic device, a storage device, an input device, an output device, and a control device to operate in cooperation with each other based on a program. In addition, the program may be written in, for example, a storage device or a storage medium and distributed, or may be distributed through, for example, an electric communication line.

The present disclosure is not limited to the above-described embodiments, and numerous additional modifications and variations are possible in light of the teachings. The technical contents included in the technical ideas described in the appended claims are included within the scope of the present disclosure. The above-described embodiments represent examples, and various modifications can be achieved by those skilled in the art from the disclosed contents. Such modifications are also included in the technical scope of the appended claims.

### Aspects of the Present Disclosure

Aspects of the present disclosure are, for example, as follows.

### Aspect 1

In Aspect 1, a medium processing apparatus includes a liquid applier, a medium processing device, a liquid storage, and a liquid detector. The liquid applier applies liquid to a medium. The medium processing device performs a process on a media bundle including the medium on which the liquid is applied by the liquid applier. The liquid storage stores the liquid used for liquid application by the liquid applier. The liquid detector detects a liquid level of the liquid storage by intermittent application control in which a voltage application and a voltage non-application to a pair of electrodes are repeated at a regular basis. The intermittent application control on the liquid detector is performed at an application period equal to or less than a given ratio.

### Aspect 2

In Aspect 2, in the medium processing apparatus according to Aspect 1, the intermittent application control after the liquid is replenished to the liquid storage starts from the voltage application.

### Aspect 3

In Aspect 3, in the medium processing apparatus according to Aspect 1 or 2, the ratio of the application period is determined based on a material of the pair of electrodes.

### Aspect 4

In Aspect 4, in the medium processing apparatus according to any one of Aspects 1 to 3, the ratio of the application period is determined based on a liquid property of the liquid.

### Aspect 5

In Aspect 5, in the medium processing apparatus according to any one of Aspects 1 to 4, the ratio of the application period is determined based on environmental information.

### Aspect 6

In Aspect 6, in the medium processing apparatus according to any one of Aspects 1 to 5, the ratio of the application period is equal to or less than 10% to a total period of the application time and the non-application time.

### Aspect 7

In Aspect 7, in the medium processing apparatus according to any one of Aspects 1 to 6, the liquid storage is multiple liquid storages, the liquid detector is disposed in each of the multiple liquid storages, and the intermittent application control is performed to the liquid detector in each of the multiple liquid storages.

### Aspect 8

In Aspect 8, an image forming apparatus includes an image forming device to form an image on a medium, and the medium processing apparatus according to any one of Aspects 1 to 7.

### Aspect 9

In Aspect 9, an image forming system includes an image forming apparatus to form an image on a medium, and the medium processing apparatus according to any one of Aspects 1 to 7.

### Aspect 10

In Aspect 10, a medium processing apparatus includes a liquid applier, a medium processing device, a liquid storage, a liquid detector, and circuitry. The liquid applier applies liquid to a medium. The medium processing device processes a media bundle including the medium on which the liquid is applied by the liquid applier. The liquid storage stores the liquid to be supplied to the liquid applier. The liquid detector includes a pair of electrodes to detect the liquid in the liquid storage. The circuitry is to control the medium processing apparatus to process the media bundle, repeat application and non-application of a direct current voltage to the pair of electrodes of the liquid detector alternately at a regular interval to perform an intermittent application, to detect the liquid in the liquid storage by the liquid detector. The circuitry is further to perform the application of the direct current voltage to the liquid detector for a first period in the intermittent application, perform the non-application of the direct current voltage to the liquid detector for a second period in the intermittent application, and control a ratio of the first period to a sum of the first period and the second period to be equal to or less than a given ratio.

### Aspect 11

In Aspect 11, in the medium processing apparatus according to Aspect 10, the circuitry is further to start the application of the direct current voltage to the liquid detector, immediately after the liquid is replenished to the liquid storage, in the intermittent application.

### Aspect 12

In Aspect 12, in the medium processing apparatus according to Aspect 10 or 11, the circuitry is further configured to determine the given ratio based on a material of the pair of electrodes.

### Aspect 13

In Aspect 13, in the medium processing apparatus according to any one of Aspects 10 to 12, the circuitry is further to determine the given ratio based on a liquid property of the liquid.

### Aspect 14

In Aspect 14, in the medium processing apparatus according to any one of Aspects 10 to 13, the circuitry is further to determine the given ratio based on information of environment surrounding the medium processing apparatus.

### Aspect 15

In Aspect 15, in the medium processing apparatus according to any one of Aspects 10 to 14, the circuitry is further to set the given ratio to 10%.

### Aspect 16

In Aspect 16, the medium processing apparatus according to any one of Aspects 10 to 15 further includes multiple liquid storages including the liquid storage, and multiple liquid detectors including the liquid detector. The multiple liquid detectors are respectively disposed in the multiple liquid storages. The circuitry is further to perform the intermittent application to each of the multiple liquid detectors.

### Aspect 17

In Aspect 17, an image forming apparatus includes an image forming device to form an image on a medium, and the medium processing apparatus according to any one of Aspects 10 to 16 to process the media bundle including the medium on which the image is formed by the image forming apparatus.

### Aspect 18

In Aspect 18, an image forming system includes an image forming apparatus to form an image on a medium, and the medium processing apparatus according to any one of Aspects 10 to 16 to process the media bundle including the medium on which the image is formed by the image forming apparatus.

The present disclosure is not limited to specific embodiments described above, and numerous additional modifications and variations are possible in light of the teachings within the technical scope of the appended claims. It is therefore to be understood that, the disclosure of this patent specification may be practiced otherwise by those skilled in the art than as specifically described herein, and such, modifications, alternatives are within the technical scope of the appended claims. Such embodiments and variations thereof are included in the scope and gist of the embodiments of the present disclosure and are included in the embodiments described in claims and the equivalent scope thereof.

The effects described in the embodiments of this disclosure are listed as the examples of preferable effects derived from this disclosure, and therefore are not intended to limit to the embodiments of this disclosure.

The embodiments described above are presented as an example to implement this disclosure. The embodiments described above are not intended to limit the scope of the invention. These novel embodiments can be implemented in various other forms, and various omissions, replacements, or changes can be made without departing from the gist of the invention. These embodiments and their variations are included in the scope and gist of this disclosure and are included in the scope of the invention recited in the claims and its equivalent.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

What is claimed is:

1. A medium processing apparatus comprising:
a liquid applier to apply liquid to a medium;
a medium processing device to process a media bundle including the medium on which the liquid is applied by the liquid applier;
a liquid storage to store the liquid to be supplied to the liquid applier;
a liquid detector including a pair of electrodes to detect the liquid in the liquid storage; and
circuitry configured to:
control the medium processing apparatus to process the media bundle;
repeat:
application; and
non-application of,
a direct current voltage to the pair of electrodes of the liquid detector alternately at a regular interval to perform an intermittent application,
to detect the liquid in the liquid storage by the liquid detector,
wherein the circuitry is further configured to:
perform the application of the direct current voltage to the liquid detector for a first period in the intermittent application;
perform the non-application of the direct current voltage to the liquid detector for a second period in the intermittent application; and
control a ratio of the first period to a sum of the first period and the second period to be equal to or less than a given ratio.

2. The medium processing apparatus according to claim 1,
wherein the circuitry is further configured to start the application of the direct current voltage to the liquid detector, immediately after the liquid is replenished to the liquid storage, in the intermittent application.

3. The medium processing apparatus according to claim 1,
wherein the circuitry is further configured to determine the given ratio based on a material of the pair of electrodes.

4. The medium processing apparatus according to claim 1,
wherein the circuitry is further configured to determine the given ratio based on a liquid property of the liquid.

5. The medium processing apparatus according to claim 1,
wherein the circuitry is further configured to determine the given ratio based on information of environment surrounding the medium processing apparatus.

6. The medium processing apparatus according to claim 1,
wherein the circuitry is further configured to set the given ratio to 10%.

7. The medium processing apparatus according to claim 1, further comprising:
multiple liquid storages including the liquid storage; and
multiple liquid detectors including the liquid detector,
wherein the multiple liquid detectors are respectively disposed in the multiple liquid storages, and
the circuitry is further configured to perform the intermittent application to each of the multiple liquid detectors.

8. An image forming apparatus comprising:
an image forming device to form an image on a medium; and
the medium processing apparatus according to claim 1 to process the media bundle including the medium on which the image is formed by the image forming apparatus.

9. An image forming system comprising:
an image forming apparatus to form an image on a medium; and
the medium processing apparatus according to claim 1 to process the media bundle including the medium on which the image is formed by the image forming apparatus.
